(19) United States
(12) Patent Application Publication
(10) Pub. No.: US 2025/0136769 A1
(43) Pub. Date: May 1, 2025

(54) ENTANGLED POLYMER NETWORKS

(71) Applicant: President and Fellows of Harvard College, Cambridge, MA (US)

(72) Inventors: Xianyang BAO, Cambridge, MA (US); Zhigang SUO, Cambridge, MA (US); Meixuanzi SHI, Cambridge, MA (US); Junsoo KIM, Cambridge, MA (US); Guodong NIAN, Hangzhou (CN); Guogao ZHANG, Cambridge, MA (US)

(73) Assignee: President and Fellows of Harvard College, Cambridge, MA (US)

(21) Appl. No.: 18/693,804

(22) PCT Filed: Sep. 22, 2022
(86) PCT No.: PCT/US2022/076834

§ 371 Date: Mar. 20, 2024

Related U.S. Application Data
(60) Provisional application No. 63/247,587, filed on Sep. 23, 2021.

(51) Int. Cl. C08J 3/24; C08F 299/00; C08J 3/075; C08L 33/26

(52) U.S. Cl. CPC C08J 3/246; C08F 299/00; C08J 3/075; C08L 33/26; C08J 2301/02; C08J 2371/02

(57) ABSTRACT

In one aspect, an entangled polymer composition includes an entangled polymer network including a plurality of entangled polymers; and a plurality of crosslinks crosslinking the polymers at a density of no more than one crosslink per 1,000 monomer units of the polymer; wherein the polymer composition has a toughness of at least about 100 Jm⁻² and a stiffness of at least about 50 kPa.

### RELATED APPLICATIONS

The present application claims priority to and the benefit of the earlier filing date of U.S. Patent Application No. 63/247,587, filed on Sep. 23, 2021, and entitled “Entangled Polymer Networks,” the content of which is hereby incorporated by reference herein in its entirety.

### STATEMENT REGARDING FEDERALLY SPONSORED RESEARCH OR DEVELOPMENT

This invention was made with government support under 2011754 awarded by the National Science Foundation. The U.S. Government has certain rights in the invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The instant application relates to polymers and polymer compositions. In particular, the instant application relates to highly entangled polymers and polymer compositions.

### BACKGROUND

Some polymers rely on crosslinks to increase stiffness. However, dense crosslinks embrittle polymers, resulting in a stiffness-toughness conflict. In addition, in some polymers, toughness is improved by incorporation of sacrificial bonds, leading to a positive correlation between hysteresis and toughness. There is a need for polymer materials that can achieve high stiffness and toughness while also exhibiting low hysteresis.

### SUMMARY

In one aspect, an entangled polymer composition includes an entangled polymer network including a plurality of entangled polymers; and a plurality of crosslinks crosslinking the polymers at a density of no more than one crosslink per 1,000 monomer units of the polymer;—wherein the polymer composition has a toughness of at least about 100 Jm⁻² and a stiffness of at least about 50 kPa

In some embodiments, the density of the crosslinks crosslinking the polymers is no more than one crosslink per 3,000, 4,000, 5,000 or 8,000 monomer units of the polymer.

In some embodiments, the density of the crosslinks crosslinking the polymers is no more than one crosslink per 10,000 monomer units of the polymer.

In some embodiments, the polymer composition includes about 50, 100, 150, 200, 300, 400, or 500 entanglements per crosslink.

In some embodiments, wherein the polymer composition is an elastomer, and the elastomer has a toughness of at least about 500 Jm⁻² and a stiffness of at least about 400 kPa.

In some embodiments, the polymer composition has a stiffness of at least about 100 kPa.

In some embodiments, the polymer wherein the product of the stiffness and the toughness is at least about 104 kPa m⁻².

In some embodiments, the polymer composition further includes a solvent and the entangled polymer network is swollen with the solvent.

In some embodiments, the solvent is water and the polymer composition is a hydrogel, and the hydrogel has a toughness of at least about 100 Jm⁻² and a stiffness of at least about 50 kPa.

In some embodiments, the solvent is an organic solvent, and the polymer composition is an organogel.

In some embodiments, the polymer composition has a ratio of dissipated energy to applied work that is less than about 10%.

In some embodiments, the polymer composition has a ratio of dissipated energy to applied work that is less than about 5%

In some embodiments, the polymer composition has a nominal tensile strength of at least about 100, 200, 300, or 500 kPa.

In some embodiments, the polymer composition has a strength of at least about 2.5, 2.75, 3.0, 3.25, or 3.5 MPa.

In some embodiments, the polymer composition has a coefficient of friction of less than about 0.05, 0.04, 0.03, 0.02, 0.01, 0.005, or 0.001.

In some embodiments, the polymer composition has a fatigue threshold of at least about 150, 160, 170, 180, 190, 200, 210, 220, 230, 240, 250, 300, or 350 Jm⁻².

In some embodiments, the polymer composition has a wear rate of less than about 1, 0.5, 0.3, 0.25, 0.2, 0.15, or 0.1 mg/cycle.

In some embodiments, the polymer includes poly(ethyl acrylate), polyacrylic acid, poly(acrylamide), polyethylene glycol, polyvinylpyrrolidone, polyvinyl alcohol, poly(2-hydroxyethyl methacrylate), poly(methacrylic acid), poly(N-isopropyl acrylamide), polyacrylic acid, poly(methyl methacrylate), polymethacrylate, poly(ethyl methacrylate), poly(propyl acrylate), poly(propyl methacrylate), poly(butyl acrylate), poly(acrylic acid), poly(N-isopropyl acrylamide), poly(butyl methacrylate), polyethylene, polypropylene, poly(vinyl acetate), polyacrylonitrile, polybutadiene, polyisobutylene, polyisoprene, polychloroprene, polynorbornene, polytetrafluoroethylene, ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), poly(isobutylene-co-isoprene), poly(perfluoromethylvinylether), poly(styrene-co-butadiene), polyurethane, polysulfide, polysiloxane, natural rubbers, silicone rubbers, nitrile rubbers, cellulose, alginate, chitosan, hyaluronic acid, collagen, gelatin, or a combination thereof.

In some embodiments, the crosslinks are formed using a crosslinker selected from a group consisting of N,N′-methylenebisacrylamide, Tricyclo[5.2.1.0^{2,6}]decanedimethanol diacrylate, benzophenone, glycidyl methacrylate, poly(ethylene glycol) diacrylate, Ethylene glycol diacrylate, 1,4-Butanediol diacrylate, Poly(propylene glycol) diacrylate, Di(ethylene glycol) diacrylate, Bisphenol A ethoxylate diacrylate, 1,3-Butanediol diacrylate, 1,6-Hexanediol diacrylate, Tri (ethyleneglycol) diacrylate, Neopentyl glycol diacrylate, Tetra(ethylene glycol) diacrylate, benzophenone, glycidyl methacrylate, adipic acid dihydrazide, butanediol-diglycidyl ether, citric acid, glutaraldehyde, divinyl sulfone, sulfur, and a combination thereof.

In one aspect, a method of forming an entangled polymer composition includes a) providing a mixture including a plurality of monomers; a plurality of crosslinkers, wherein there are no more than one crosslinker per 1,000 monomers; and a solvent, wherein the molar ratio of solvent to monomer is less than 12; b) polymerizing the monomers to form polymers and entangling the polymers to form an entangled polymer network; and c) forming crosslinks by crosslinking the polymers.

In some embodiments, the density of the crosslinks crosslinking the polymers is no more than one crosslink per 3,000, 4,000, 5,000 or 8,000 monomer units of the polymer.

In some embodiments, the density of the crosslinks crosslinking the polymers is no more than one crosslink per 10,000 monomer units of the polymer.

In some embodiments, the entangled polymer composition includes about 50, 100, 150, 200, 300, 400, or 500 entanglements per crosslink.

In some embodiments, the entangled polymer composition a toughness of at least about 100 Jm⁻² a stiffness of at least about 50 kPa.

In some embodiments, the polymer composition is an elastomer, and the elastomer has a toughness of at least about 500 Jm⁻² and a stiffness of at least about 400.

In some embodiments, the method further includes swelling the entangled polymer network with a solvent after step c).

In some embodiments, the solvent is water and the polymer composition is a hydrogel, and the hydrogel has a toughness of at least about 100 Jm⁻² and a stiffness of at least about 50 kPa.

In some embodiments, the solvent is an organic solvent, and the polymer composition is an organogel.

In some embodiments, the monomers include ethyl acrylate, acrylamide, acrylic acid, 2-Hydroxyethyl methacrylate, ethylene glycol, methacrylic acid, N-isopropyl

Acrylamide, Methyl methacrylate, methacrylate, ethyl acrylate, ethyl methacrylate, propyl acrylate, propyl methacrylate, butyl acrylate, acrylic acid, methacrylic acid, butyl methacrylate, ethylene, propylene, vinyl acetate, acrylonitrile, butadiene, Isobutylene, isoprene, chloroprene, norbornene, tetrafluoroethylene, or a combination thereof.

In some embodiments, the polymers include natural rubber, silicon rubber, poly(ethyl acrylate), poly(acrylamide), polyacrylic acid, poly(2-hydroxyethyl methacrylate), poly(methacrylic acid), poly(N-isopropyl acrylamide), poly(methyl methacrylate), polymethacrylate, poly(ethyl methacrylate), poly(propyl acrylate), poly(propyl methacrylate), poly(butyl acrylate), poly(butyl methacrylate), polyethylene, polypropylene, poly(vinyl acetate), polyacrylonitrile, polybutadiene, polyisobutylene, polyisoprene, polychloroprene, polynorbornene, polytetrafluoroethylene, ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), poly(isobutylene-co-isoprene), poly(perfluoromethylvinylether), poly(styrene-co-butadiene), polyurethane, polysulfide, polysiloxane, natural rubbers, silicone rubbers, nitrile rubbers, polyethylene glycol, polyvinylpyrrolidone, polyvinyl alcohol, or a combination thereof.

In some embodiments, the crosslinks are formed using a crosslinker selected from a group consisting of N,N′-methylenebisacrylamide, Tricyclo[5.2.1.0^{2,6}]decanedimethanol diacrylate, benzophenone, poly(ethylene glycol) diacrylate, Ethylene glycol diacrylate, 1,4-Butanediol diacrylate, Poly(propylene glycol) diacrylate, Di(ethylene glycol) diacrylate, Bisphenol A ethoxylate diacrylate, 1,3-Butanediol diacrylate, 1,6-Hexanediol diacrylate, Tri (ethyleneglycol) diacrylate, Neopentyl glycol diacrylate, Tetra(ethylene glycol) diacrylate, glycidyl methacrylate, adipic acid dihydrazide, butanediol-diglycidyl ether, citric acid, glutaraldehyde, divinyl sulfone, sulfur, and a combination thereof.

In some embodiments, the molar ratio of solvent to monomer is between about 2 and 12.

In some embodiments, the molar ratio of solvent to monomer is 0.

In some embodiments, the mixture further includes an initiator.

In some embodiments, the initiator includes 2-Hydroxy-4′-(2-hydroxyethoxy)-2-methylpropiophenone, 2-Hydroxy-2-methylpropiophenone, glycidyl methacrylate, 2-oxoglutaric acid, benzophenone, or a combination thereof.

In some embodiments, the molar ratio of initiator to crosslinkers is less than about 1.0.

In some embodiments, the initiator has a molar ratio of initiator to monomer of less than about 10⁻⁵.

In some embodiments, forming crosslinks includes crosslinking the polymers at a density of no more than one crosslink per 1,000 monomers.

In one aspect, a method of forming an entangled polymer composition includes a) providing a mixture including a plurality of polymer chains; a plurality of crosslinkers, wherein there are no more than one crosslinker per 1,000 monomers in the polymer chains; and a solvent; b) kneading the mixture of precursors at a temperature of at least about 40° C. to form an entangled polymer network; and c) crosslinking the polymer chains to form crosslinks.

In some embodiments, the density of the crosslinks crosslinking the polymers is no more than one crosslink per 3,000, 4,000, 5,000 or 8,000 monomer units of the polymer.

In some embodiments, the density of the crosslinks crosslinking the polymers is no more than one crosslink per 10,000 monomer units of the polymer.

In some embodiments, the entangled polymer composition includes about 50, 100, 150, 200, 300, 400, or 500 entanglements per crosslink.

In some embodiments, the entangled polymer composition a toughness of at least about 100 Jm⁻².

In some embodiments, the polymer composition is an elastomer, and the elastomer has a toughness of at least about 500 Jm⁻² and a stiffness of at least about 400.

In some embodiments, the method further includes swelling the entangled polymer network with a solvent after step c).

In some embodiments, the solvent is water and the polymer composition is a hydrogel, and the hydrogel has a toughness of at least about 100 Jm⁻² and a stiffness of at least about 50 kPa.

In some embodiments, the solvent is an organic solvent, and the polymer composition is an organogel.

In some embodiments, the method further includes annealing the entangled polymer network at a temperature of at least about 40° C. after step b).

In some embodiments, kneading the mixture precursors occurs at a temperature of at least about 50, 60, 70 or 80° C.

In some embodiments, the polymers include polyethylene glycol, polyvinylpyrrolidone, polyvinyl alcohol, poly(2-hydroxyethyl methacrylate), silicone rubbers, nitrile rubbers, poly(methyl methacrylate), polymethacrylate, poly(ethyl acrylate), poly(ethyl methacrylate), poly(acrylamide), polyacrylic acid, poly(methacrylic acid), poly(N-isopropyl acrylamide), poly(propyl acrylate), poly(propyl methacrylate), poly(butyl acrylate), poly(butyl methacrylate), ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), polyacrylonitrile, polyisobutylene, poly(isobutylene-co-isoprene), poly(tetrafluoro ethylene), poly(tetrafluoroethylene), poly(perfluoromethylvinylether), poly(styrene-co-butadiene), polyurethane, polyisoprene, polychloroprene, polybutadiene, polysulfide, polynorbornene, polysiloxane, polyethylene, polypropylene, poly(vinyl acetate), polyacrylonitrile, cellulose, alginate, chitosan, hyaluronic acid, collagen, gelatin, starch, chitin, agarose, dextran, konjac glucomannan, pullulan, guar gum, polynucleotide, polyisoprene, polyamide, or a combination thereof.

In some embodiments, the crosslinks are formed using a crosslinker selected from a group consisting of benzophenone, glycidyl methacrylate, glyoxal, oxidized dextrin, epichlorohydrin, adipic acid dihydrazide, endogen polyamine spermidine, ethylene glycol dimethacrylate, butanediol-diglycidyl ether, citric acid, glutaraldehyde, divinyl sulfone, and sulfur, and a combination thereof.

In some embodiments, the polymer chains have an average molecular weight of at least about 5×10⁵ g/mol.

In some embodiments, forming crosslinks includes crosslinking the polymer chains at a density of no more than one crosslink per 1,000 monomers in the polymer chains.

In some embodiments, the solvent is less than about 40% of the mixture by mass.

Any one of the embodiments disclosed herein may be properly combined with any other embodiment disclosed herein. The combination of any one of the embodiments disclosed herein with any other embodiments disclosed herein is expressly contemplated.

### BRIEF DESCRIPTION OF THE DRAWINGS

The objects and advantages will be apparent upon consideration of the following detailed description, taken in conjunction with the accompanying drawings, in which like reference characters refer to like parts throughout, and in which:

FIG. 1A shows a schematic of an entangled polymer network, according to certain embodiments.

FIG. 1B shows a schematic of a stretched entangled polymer network, according to certain embodiments.

FIG. 1C shows a schematic of a broken polymer chain in a stretched entangled network, according to certain embodiments.

FIG. 1D shows a schematic of a crosslink-dominant polymer network, according to certain embodiments.

FIG. 1E shows a schematic of a stretched crosslink-dominant polymer network, according to certain embodiments.

FIG. 1F shows a photograph of an entangled polymer network, according to certain embodiments.

FIG. 1G shows a photograph of a crosslink-dominant polymer network, according to certain embodiments.

FIG. 2A shows the polymer content of hydrogels as a function of crosslink fraction, according to certain embodiments.

FIG. 2B shows the stiffness of hydrogels as a function of crosslink fraction, according to certain embodiments.

FIG. 2C shows a stress-stretch curve of entangled hydrogels with negligible hysteresis, according to certain embodiments.

FIG. 2D shows a stress-stretch curve of entangled hydrogels stretched at different rates, according to certain embodiments.

FIG. 2E shows the toughness (I) of hydrogels as a function of crosslink fraction, according to certain embodiments.

FIG. 2F shows the stiffness-toughness plane for polymer compositions, including highly entangled hydrogels and crosslink-dominant hydrogels, according to certain embodiments.

FIG. 2G shows the stress-stretch curves of highly entangled hydrogels, hard crosslink-dominant hydrogels, and soft crosslink-dominant hydrogels under uniaxial tension, according to certain embodiments.

FIG. 2H shows the fatigue crack extension per cycle for entangled hydrogels measured at various amplitudes of energy release rate, according to certain embodiments.

FIG. 3A shows the stiffness of elastomers as a function of crosslink fraction, according to certain embodiments.

FIG. 3B shows the toughness (Γ) of elastomers as a function of crosslink fraction, according to certain embodiments.

FIG. 3C shows a stress-stretch curve of entangled elastomers with negligible hysteresis, according to certain embodiments.

FIG. 3D shows the stress-stretch curves of a highly entangled elastomer under uniaxial tension, according to certain embodiments.

FIG. 3E shows the fatigue crack extension per cycle for entangled elastomers measured at various amplitudes of energy release rate, according to certain embodiments.

FIG. 3F shows the fatigue threshold of a highly entangled elastomer and other elastomers (neoprene, polydimethylsiloxane, phosphonitrilic fluoroelastomer, and polyurethane), according to certain embodiments.

FIG. 4A shows the friction coefficients of a highly entangled polymer composition, a crosslink-dominant hydrogel, and Teflon, according to certain embodiments.

FIG. 4B shows a photograph of a crosslink-dominant hydrogel after 3 hours of testing with a rheometer, according to certain embodiments.

FIG. 4C shows a photograph of a highly entangled hydrogel after 6 hours of testing with a rheometer, according to certain embodiments.

FIG. 4D shows the wear rates of highly entangled hydrogels and other materials (silicones, neoprenes, natural rubber, styrene-butadiene rubber, and Teflon), according to certain embodiments.

FIG. 5A shows polymer content as a function of solvent fraction for hydrogels formed using various initiator: crosslinker ratios, according to certain embodiments.

FIG. 5B shows the stiffness as a function of solvent fraction for hydrogels formed using various initiator: crosslinker ratios, according to certain embodiments.

FIG. 5C shows toughness as a function of solvent fraction for hydrogels formed using various initiator: crosslinker ratios, according to certain embodiments.

FIG. 5D shows polymer content as a function of crosslink fraction for hydrogels formed using various initiator fractions, according to certain embodiments.

FIG. 5E shows the stiffness as a function of crosslink fraction for hydrogels formed using various initiator fractions, according to certain embodiments.

FIG. 5F shows toughness as a function of crosslink fraction for hydrogels formed using various initiator fractions, according to certain embodiments.

FIG. 6 shows the swelling ratio of an entangled hydrogel over time, according to certain embodiments.

FIG. 7 shows the swelling ratio of hydrogels as a function of crosslink faction for different solvent ratios, according to certain embodiments.

FIG. 8A shows a schematic of a mixture of long polymer chains and a small amount of water that forms a dough, according to certain embodiments.

FIG. 8B shows a schematic of an entangled hydrogel formed from long polymer chains after curing and swelling to equilibrium, according to certain embodiments.

FIG. 8C shows a schematic of a stretched entangled hydrogel formed from long polymer chains, according to certain embodiments.

FIG. 9A shows a schematic of a mixture of short polymer chains and a large amount of water to form a solution, according to certain embodiments.

FIG. 9B shows a schematic of a crosslink-dominant hydrogel formed from short polymer chains after curing and swelling to equilibrium, according to certain embodiments.

FIG. 9C shows a schematic of a stretched crosslink-dominant hydrogel formed from short polymer chains, according to certain embodiments.

FIG. 10 shows a schematic of a cycle of kneading in a process for making an entangled hydrogel using a polymer dough, according to certain embodiments.

FIG. 11A shows a photograph of a dough after one cycle of kneading (N=1) at an elevated temperature, according to certain embodiments.

FIG. 11B shows a photograph of a dough after two cycles of kneading (N=2) at an elevated temperature, according to certain embodiments.

FIG. 11C shows a photograph of a dough after three cycles of kneading (N=3) at an elevated temperature, according to certain embodiments.

FIG. 11D shows a photograph of a dough after four cycles of kneading (N=4) at an elevated temperature, according to certain embodiments.

FIG. 11E shows a photograph of a dough after five cycles of kneading (N=5) at an elevated temperature, according to certain embodiments.

FIG. 11F shows a photograph of a dough after seven cycles of kneading (N=7) at an elevated temperature, according to certain embodiments.

FIG. 11G shows a photograph of a dough after annealing and crosslinking, according to certain embodiments.

FIG. 11H shows a photograph of a dough after being swollen to equilibrium to form an entangled hydrogel, according to certain embodiments.

FIG. 11I shows a photograph of the resulting entangled hydrogel from FIG. 11H being stretched, according to certain embodiments.

FIG. 12A shows the final polymer fraction of hydrogels made from doughs as a function of initiator fraction at different initial polymer fractions, according to certain embodiments.

FIG. 12B shows the elastic modulus of hydrogels made from doughs as a function of initiator fraction at different initial polymer fractions, according to certain embodiments.

FIG. 12C shows the toughness of hydrogels made from doughs as a function of initiator fraction at different initial polymer fractions, according to certain embodiments.

FIG. 12D shows the final polymer fraction of hydrogels made from doughs as a function of initiator fraction at different molecular weights, according to certain embodiments.

FIG. 12E shows the elastic modulus of hydrogels made from doughs as a function of initiator fraction at different molecular weights, according to certain embodiments.

FIG. 12F shows the toughness of hydrogels made from doughs as a function of initiator fraction at different molecular weights, according to certain embodiments.

FIG. 13A shows a method of forming a dough by adding water to a powder of long-chain PEG, then heating the mixture to form an inhomogeneous dough, according to certain embodiments.

FIG. 13B shows a method of forming a dough by adding a mixture of small water droplets and humid air to a powder of long-chain PEG then heating the mixture to form an inhomogeneous dough, according to certain embodiments.

FIG. 13C shows a method of forming a dough by adding water to a powder of long-chain PEG, then kneading and heating the mixture to form an inhomogeneous dough, according to certain embodiments.

FIG. 14A shows a schematic of grippers aligned with a hydrogel sample for mechanical testing, according to certain embodiments.

FIG. 14B shows a schematic of grippers glued to a hydrogel sample, according to certain embodiments.

FIG. 14C shows a sample for monotonic stretching to measure stiffness, stress-stretch curve, and elastic energy density function, according to certain embodiments.

FIG. 14D shows a sample for stretching to measure hysteresis and rate sensitivity, according to certain embodiments.

FIG. 14E shows a sample with a notch for monotonic stretching to measure toughness, according to certain embodiments.

FIG. 14F shows a sample with a notch for cyclic loading to measure the fatigue threshold, according to certain embodiments.

FIG. 14G shows a dumbbell-shaped sample for monotonic stretching to measure the stress-stretch curve under uniaxial tension and to measure strength, according to certain embodiments.

FIG. 14H shows an applied loading curve for monotonic stretching to measure stiffness, stress-stretch curve, and elastic energy density function, according to certain embodiments.

FIG. 14I shows an applied loading curve for stretching to measure hysteresis and rate sensitivity, according to certain embodiments.

FIG. 14J shows an applied loading curve for monotonic stretching to measure toughness, according to certain embodiments.

FIG. 14K shows an applied loading curve for cyclic loading to measure the fatigue threshold, according to certain embodiments.

FIG. 14L shows an applied loading curve for monotonic stretching to measure the stress-stretch curve under uniaxial tension and to measure strength, according to certain embodiments.

FIG. 14M shows a schematic of a setup for fatigue testing of hydrogels, according to certain embodiments.

FIG. 15A shows a schematic of a setup for wear rate measurement of a hydrogel, according to certain embodiments.

FIG. 15B shows the surfaces of various materials after 100 cycles of wear testing, according to certain embodiments.

FIG. 16A shows the stress-stretch curve of a hydrogel with W=2.0 and C=0, according to certain embodiments.

FIG. 16B shows the stress-stretch curve of a hydrogel with W=2.0 and C=1×10⁻⁵, according to certain embodiments.

FIG. 17 shows the storage modulus and loss modulus of a highly entangled hydrogel as a function of frequency (W=2.0 and C=1×10⁻⁵), according to certain embodiments.

FIG. 18A shows the load over time for an entangled hydrogel and a double-network hydrogel after being plucked, according to certain embodiments.

FIG. 18B shows the displacement of a metal ball after being dropped onto an entangled hydrogel and double-network hydrogel, according to certain embodiments.

FIG. 19 shows the stiffness-toughness plane for hydrogels prepared with precursors having various amounts of water (W) and crosslinker (C), according to certain embodiments.

FIG. 20A shows a photograph of a swollen polyacrylic acid hydrogel, according to certain embodiments.

FIG. 20B shows the stress-stretch curve of a polyacrylic acid hydrogel under uniaxial tension, according to certain embodiments.

FIG. 21A shows the application of a stress of 360 kPa applied to an entangled elastomer for 48 hours and relaxed for 24 hours, according to certain embodiments.

FIG. 21B shows the stretch of the entangled elastomer as a function of time, according to certain embodiments.

FIG. 21C shows the residual stretch of an entangled elastomer for different I/C at C=10⁻⁵, according to certain embodiments.

FIG. 21D shows the residual stretch of an entangled elastomer for various C at I/C=0.1, according to certain embodiments.

FIG. 22A shows the stress-stretch curve of an entangled elastomer under cyclic uniaxial tension with low hysteresis, according to certain embodiments.

FIG. 22B shows the stress-stretch of an entangled elastomer swollen with organic solvent under cyclic uniaxial tension with low hysteresis, according to certain embodiments.

FIG. 23A shows a photograph of an entangled elastomer before 200,000 cycle at energy release rate G=200 J/m², according to certain embodiments.

FIG. 23B shows a photograph an entangled elastomer after 200,000 cycle at energy release rate G=200 J/m², according to certain embodiments.

FIG. 24 shows a photograph of an inhomogeneous dough formed after mixing PEG with a small amount of water, according to certain embodiments.

FIG. 25A shows a schematic of a reaction for creating radicals for crosslinking PEG using benzophenone, according to certain embodiments.

FIG. 25B shows a schematic of a reaction of two radicals encountering to crosslink PEG, according to certain embodiments.

FIG. 26A shows a photograph of a mixture of short-chain PEG and a large amount of water, according to certain embodiments.

FIG. 26B shows a photograph of cross-linked short-chain PEG, according to certain embodiments.

FIG. 26C shows a photograph of cross-linked short-chain PEG hydrogel swollen with water, according to certain embodiments.

FIG. 27A shows a short-chain PEG hydrogel after puncturing with a glass rod (top view), according to certain embodiments.

FIG. 27B shows a long-chain PEG hydrogel after puncturing with a glass rod (top view), according to certain embodiments.

FIG. 27C shows a short-chain PEG hydrogel displaced by a glass rod (side view), according to certain embodiments.

FIG. 27D shows a long-chain PEG hydrogel displaced by a glass rod (side view), according to certain embodiments.

FIG. 27E shows the stress-stretch curves of a short-chain hydrogel and a long-chain hydrogel, according to certain embodiments.

FIG. 27F shows the polymer fraction of a short-chain hydrogel and a long-chain hydrogel, according to certain embodiments.

FIG. 27G shows the stiffness of a short-chain hydrogel and a long-chain hydrogel, according to certain embodiments.

FIG. 27H shows the toughness of a short-chain hydrogel and a long-chain hydrogel, according to certain embodiments.

FIG. 27I shows the extensibility of a short-chain hydrogel and a long-chain hydrogel, according to certain embodiments.

FIG. 27J shows the work of fracture of a short-chain hydrogel and a long-chain hydrogel, according to certain embodiments.

FIG. 27K shows the strength of a short-chain hydrogel and a long-chain hydrogel, according to certain embodiments.

FIG. 28A shows the stretch-stress curve of an entangled PEG hydrogel with negligible hysteresis, according to certain embodiments.

FIG. 28B shows the stress-stretch curves of a highly entangled PEG hydrogel under different rates of stretch, according to certain embodiments.

FIG. 28C shows the stress-stretch curve of a cross-linked dough after homogenization, according to certain embodiments.

FIG. 28D shows the stress-strain curve of entangled PEG hydrogels compressed to rupture, according to certain embodiments.

FIG. 29 shows the toughness-hysteresis plane of entangled PEG hydrogels and other hydrogels, according to certain embodiments.

FIG. 30 shows the compressive stress-strain curve of an entangled PEG hydrogel and a short-chain PEG hydrogel, according to certain embodiments.

FIG. 31A shows the final polymer fraction of a PEG hydrogel as a function of initial polymer fraction, according to certain embodiments.

FIG. 31B shows the elastic modulus of a PEG hydrogel as a function of initial polymer fraction, according to certain embodiments.

FIG. 31C shows the toughness of a PEG hydrogel as a function of initial polymer fraction, according to certain embodiments.

FIG. 32A shows a powder of ultra-high molecular weight PEG, according to certain embodiments.

FIG. 32B shows a powder of ultra-high molecular weight PEG powder after being kept at 80° C. overnight, according to certain embodiments.

FIG. 33A shows the final polymer fraction as a function of annealing time at different annealing temperatures, according to certain embodiments.

FIG. 33B shows the elastic modulus as a function of annealing time at different annealing temperatures, according to certain embodiments.

FIG. 33C shows the toughness as a function of annealing time at different annealing temperatures, according to certain embodiments

FIG. 34 shows homogenized dough cooled or heated at 2° C., 23° C., and 80° C. after 0 hr, 0.5 hr, 1.0 hr, and 6.0 hr, according to certain embodiments.

FIG. 35A shows a schematic of a set-up for measuring the friction coefficient of a hydrogel using a rheometer, according to certain embodiments.

FIG. 35B shows the friction coefficient of a highly entangled PEG hydrogel and a short-chain PEG hydrogel, according to certain embodiments.

FIG. 36A shows a schematic of the chemical reaction grafting glycidyl methacrylate (GMA) on 2-hydroxyethyl cellulose to obtain photocrosslinkable cellulose, according to certain embodiments.

FIG. 36B shows a cross-linked GMA-grafted cellulose after application of UV light, according to certain embodiments.

FIG. 37A shows a photograph of a transparent entangled cellulose hydrogel, according to certain embodiments.

FIG. 37B shows a photograph of an entangled cellulose hydrogel that has been knotted, according to certain embodiments.

FIG. 37C shows a photograph of an entangled cellulose hydrogel that has been twisted, according to certain embodiments.

FIG. 37D shows the stress-stretch curve of an entangled cellulose hydrogel stretched to fracture, according to certain embodiments.

FIG. 37E shows the stress-stretch curve of an entangled cellulose hydrogel with negligible hysteresis, according to certain embodiments.

FIG. 37F shows the stress-stretch curves of entangled cellulose hydrogels at different stretch rates, according to certain embodiments.

### DETAILED DESCRIPTION

### I. Entangled Polymer Compositions

In one aspect, a polymer composition is disclosed, including an entangled polymer network including a plurality of entangled polymers; and a plurality of crosslinks crosslinking the polymers at a density of no more than one crosslink per 1,000 monomer units of the polymer; where the polymer composition has a toughness of at least about 100 Jm⁻² and a stiffness of at least about 50 kPa. In some embodiments, the polymer composition includes an entangled polymer network in which entanglements outnumber crosslinks, which resolves the stiffness-toughness conflict and results in materials with both high stiffness and high toughness. In some embodiments, the polymer composition has a toughness of at least about 200, 300, 400, 500, 600, 700, 800, 900, 1000, 1200, or 1500 Jm⁻², or the toughness is in any range bounded by any two values disclosed herein. In some embodiments, the polymer composition has a stiffness of at least about 100, 200, 300, 400, 500, 600, 700, 800, 900, 1000, 1200 or 1500 kPa, or the stiffness is in any range bounded by any two values disclosed herein. In some embodiments, the polymer composition has the combination of the toughness of any value or in any range as disclosed herein and the stiffness of any value or in any range as disclosed herein. In some embodiments, the resulting material also has negligible hysteresis.

In one embodiment, a polymer composition is disclosed, including an entangled polymer network swollen with a solvent, including a plurality of entangled polymers; and a plurality of crosslinks crosslinking the polymers at a density of no more than one crosslink per 1,000 monomer units of the polymer; where the polymer composition has a toughness of at least about 100 Jm⁻² and a stiffness of at least about 50 kPa. In some embodiments, the solvent is water and the polymer composition is a hydrogel. In some embodiments, the solvent is an organic solvent and the polymer composition is an organogel.

Crosslinks are generally formed by bonds (e.g., physical or chemical bonds) linking polymer chains. In contrast, entanglements form when polymer chains become tangled with each other. These entangled points act as physical crosslinks, stiffening the polymer network like crosslinks. However, entanglements can slip, whereas crosslinks cannot. When the polymer network is stretched, therefore, entanglements slip and deconcentrate tension at short chains, whereas crosslinks cannot avoid stress concentration at short chains. Additionally, entanglements do not result in the formation of bonds (e.g., physical or chemical bonds) linking polymer chains. Instead, the two or more entangled polymer chains interweave together such that the polymer chains cannot be separately from one another without breaking the polymer chains. In some embodiments, the entanglements disentangle under stress when the polymer chains are not crosslinked at all, but do not disentangle when the polymer chains are sparsely crosslinked.

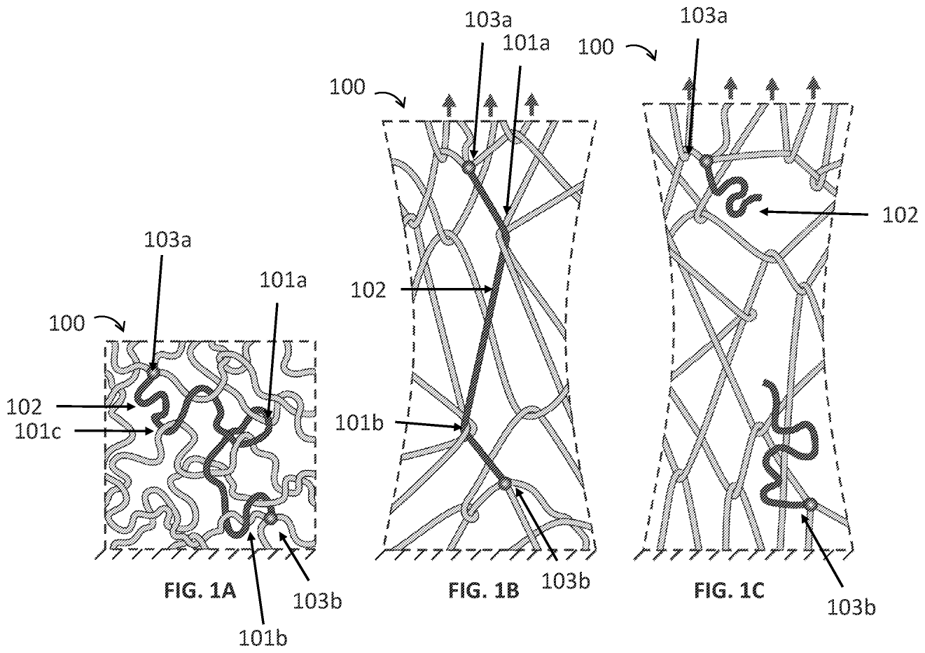

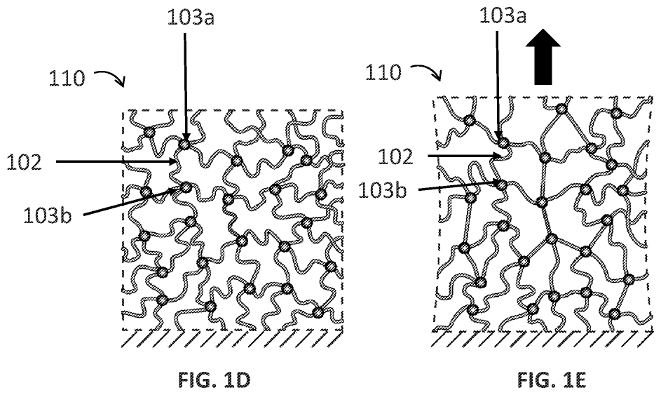

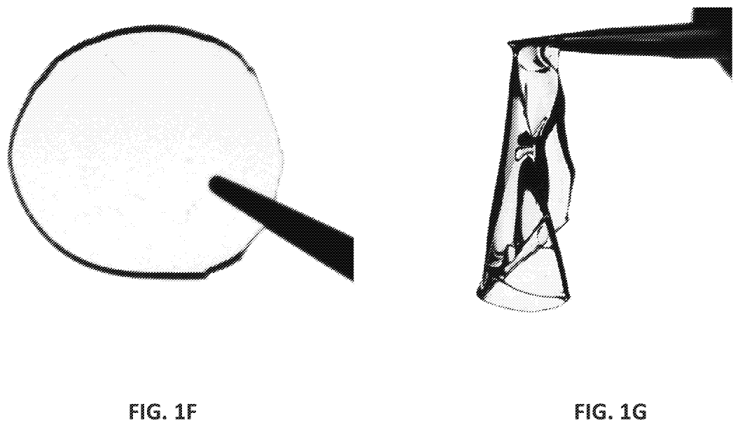

FIGS. 1A-1C show an exemplary entangled polymer network 100 in which the number of entanglements (e.g., 101a, 101b, 101c) of polymer chains 102 greatly outnumber the number of crosslinks (e.g., 103a, 103b). FIG. 1A shows an exemplary entangled polymer network where a polymer chain 102 has a large number of entanglements (e.g., 101a, 101b, 101c) along its length and a crosslink at each end (e.g., 103a, 103b). In such a network, entanglements form a fabric-like topology. In some embodiments, dense entanglements enable transmission of tension in a polymer chain along its length and to many other chains. These entanglements stiffen the polymer but, unlike crosslinks, entanglements do not embrittle the polymer. As shown in FIG. 1B, when an entangled polymer network is stretched, tension is transmitted along the chain 102 and to other chains via entanglements (101a, 101b, 101c) in the entangled polymer network 100 before the chain 102 breaks. When the chain 102 breaks, for example at a covalent bond, as shown in FIG. 1C, the entangled polymer network 100 dissipates elastic energy in many other chains, over long lengths. For example, a broken bond in chain 102 relaxes the broken chain 102 and partly relaxes the remaining entangled and crosslinked chains.

In some embodiments, the entangled polymer compositions described herein have the surprising property that they have high stiffness and toughness while having low crosslinking density. Many polymer materials rely on crosslinks to resist stretching and impart stiffness. However, when crosslinks are dense, the amount of deformation is limited, leading to low toughness. In contrast, in the entangled polymer compositions described herein, entanglements resist stretching, leading to high stiffness, and allow transmission of stress along polymer chains, leading to high toughness. In some embodiments, the density of the plurality of crosslinks crosslinking the polymer chains is no more than one crosslink per 1,000 monomer units of the polymer. Applicants have surprisingly found that when the density of the crosslinks is no more than one crosslink per 1,000 monomer units of the polymer, the resulting polymer compositions exhibited high toughness (at least about 100 Jm-2) and high stiffness (at least about 50 kPa). In some embodiments, the density of the plurality of crosslinks crosslinking the polymer chains is no more than one crosslink per about 2,000, 300, 4000, 5000, 6000, 7000, 8000, 9000, 10000, 15000 monomer units of the polymer, or the density is in any range bounded by any two values disclosed here. In some embodiments, the polymer composition has a toughness of at least about 200, 300, 400, 500, 600, 700, 800, 900, 1000, 1200, or 1500 Jm⁻², or the toughness is in any range bounded by any two values disclosed herein. In some embodiments, the polymer composition has a stiffness of at least about 100, 200, 300, 400, 500, 600, 700, 800, 900, 1000, 1200 or 1500 kPa, or the stiffness is in any range bounded by any two values disclosed herein. In some specific embodiments, the polymer composition has a toughness of at least about 200, 300, 400, 500, 600, 700, 800, 900, 1000, 1200, or 1500 Jm⁻², and a stiffness of at least about 100, 200, 300, 400, 500, 600, 700, 800, 900, 1000, 1200 or 1500 kPa.

In some specific embodiments, the polymer composition has a toughness of at least about 200 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 300 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 400 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 500 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 600 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 700 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 800 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 900 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 1000 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 1200 Jm⁻² and a stiffness of at least about 50, 100, 200, 300, 400, 500, 600, 700, 800, 900, 1000, 1200 or 1500 kPa. In some specific embodiments, the polymer composition has a toughness of at least about 1500 Jm⁻² and a stiffness of at least about 50, 100, 200, 300, 400, 500, 600, 700, 800, 900, 1000, 1200 or 1500 kPa.

In some specific embodiments, the polymer composition has a toughness of at least about 200, 300, 400, 500, 600, 700, 800, 900, 1000, 1200, or 1500 Jm⁻², and a stiffness of at least about 100 kPa. In some specific embodiments, the polymer composition has a toughness of at least about 200, 300, 400, 500, 600, 700, 800, 900, 1000, 1200, or 1500 Jm⁻², and a stiffness of at least about 200 kPa. In some specific embodiments, the polymer composition has a toughness of at least about 200, 300, 400, 500, 600, 700, 800, 900, 1000, 1200, or 1500 Jm⁻², and a stiffness of at least about 300 kPa. In some specific embodiments, the polymer composition has a toughness of at least about 200, 300, 400, 500, 600, 700, 800, 900, 1000, 1200, or 1500 Jm⁻², and a stiffness of at least about 400 kPa. In some specific embodiments, the polymer composition has a toughness of at least about 200, 300, 400, 500, 600, 700, 800, 900, 1000, 1200, or 1500 Jm⁻², and a stiffness of at least about 500 kPa. In some specific embodiments, the polymer composition has a toughness of at least about 200, 300, 400, 500, 600, 700, 800, 900, 1000, 1200, or 1500 Jm⁻², and a stiffness of at least about 600 kPa. In some specific embodiments, the polymer composition has a toughness of at least about 200, 300, 400, 500, 600, 700, 800, 900, 1000, 1200, or 1500 Jm⁻², and a stiffness of at least about 700 kPa. In some specific embodiments, the polymer composition has a toughness of at least about 200, 300, 400, 500, 600, 700, 800, 900, 1000, 1200, or 1500 Jm⁻², and a stiffness of at least about 800 kPa. In some specific embodiments, the polymer composition has a toughness of at least about 200, 300, 400, 500, 600, 700, 800, 900, 1000, 1200, or 1500 Jm⁻², and a stiffness of at least about 900 kPa. In some specific embodiments, the polymer composition has a toughness of at least about 200, 300, 400, 500, 600, 700, 800, 900, 1000, 1200, or 1500 Jm⁻², and a stiffness of at least about 1000 kPa. In some specific embodiments, the polymer composition has a toughness of at least about 200, 300, 400, 500, 600, 700, 800, 900, 1000, 1200, or 1500 Jm⁻², and a stiffness of at least about 1200 kPa. In some specific embodiments, the polymer composition has a toughness of at least about 200, 300, 400, 500, 600, 700, 800, 900, 1000, 1200, or 1500 Jm⁻², and a stiffness of at least about 1500 kPa.

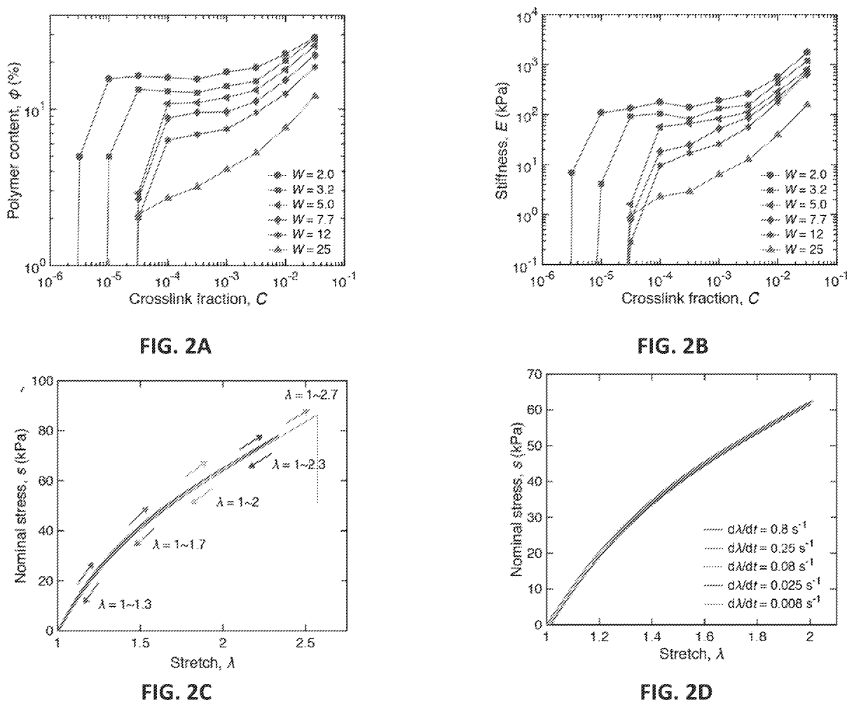

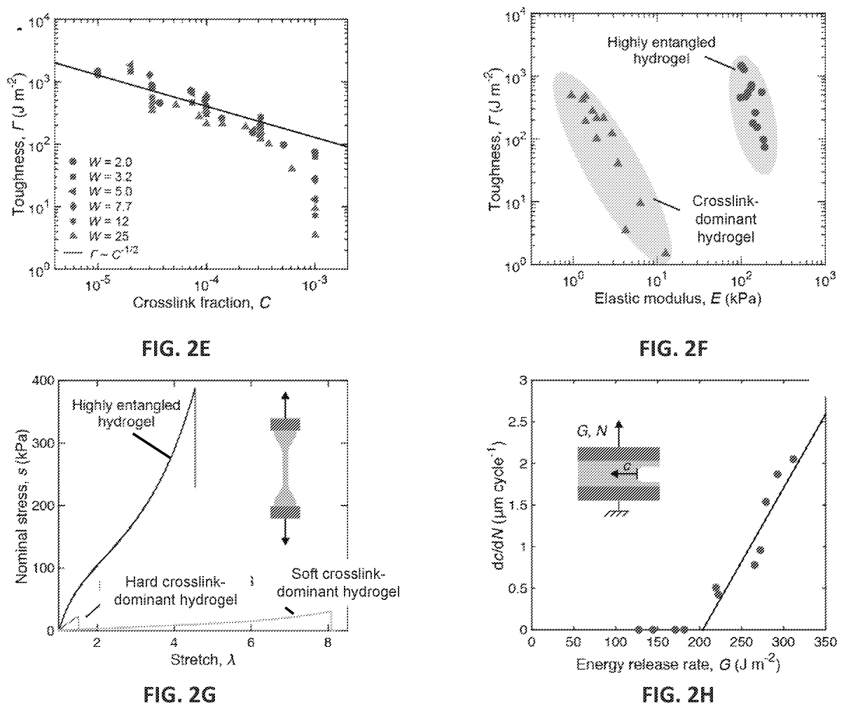

In contrast, in polymer networks that rely on crosslinks rather than entanglements, herein referred to as “crosslink-dominant polymer networks” 110, shown in FIGS. 1D-2E, crosslinks (103a, 103b) connect the polymer chains 102, so that the polymer recovers its shape when the force is removed. In such a network, crosslinks form a net-like topology. When a crosslink dominant polymer is swollen with a solvent to form a gel, the crosslinks prevent the polymer chains from dissolving. Dense crosslinks stiffen polymers and gels but also embrittle them. For example, as shown in FIG. 1E, the individual polymer chains can only stretch a limited amount before individual polymer chains break. Thus, in contrast to the entangled polymer compositions described here, the crosslink-dominant polymer compositions cannot achieve both high stiffness and toughness.

In some embodiments, the polymer compositions disclosed here (also referred to as “entangled polymer compositions”) can be formed using a small amount of solvent and a small amount of crosslinkers. In some embodiments, the entangled polymer compositions can be formed either by synthesis from monomers combined with a small amount of solvent. In other embodiments, the entangled polymer compositions can be formed by forming a dough from long-chained polymers combined with a small amount of solvent. Applicants have surprisingly found that using a small amount of solvent leads to crowding and entanglement of polymer chains. Polymers and hydrogels are often formed using a large amount of solvent, for example, with solvent-to-monomer molar ratios W of greater than about 25.0. In some embodiments, the entangled polymer compositions as described herein, on the other hand, are formed using lower solvent-to-monomer ratios W, for example, less than about 12.0, to form a large number of entanglements. In some embodiments, entangled hydrogel compositions are formed using solvent-to-monomer ratios W of about 2.0-12.0. In some embodiments, entangled hydrogel compositions are formed using solvent-to-monomer ratios W of about 0.0, 1.0, 2.0, 3.0, 4.0, 5.0, 6.0, 7.0, 8.0, 9.0, 10.0, 11.0, or 12.0, or the solvent-to-monomer ratio is in any range bounded by any two values disclosed herein. In some embodiments, the entangled polymer compositions are also formed using a small number of crosslinkers, for example, fewer than one crosslink for 100,0000 monomer units, fewer than one crosslink for 10,000 monomer units, or fewer than one crosslink for 1,000 monomer units. In some embodiments, the entangled polymer composition are formed using fewer than one crosslink per 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, or, 1,000 monomer units, or the number of the monomer units is in any range bounded by any two values disclosed herein. As a result, the number of entanglements greatly outnumber the number of crosslinks. In contrast, crosslink-dominant polymers often have a greater amount of crosslinks, e.g., one crosslink per 100 monomers.

In some embodiments, compared to crosslink-dominant polymer networks, the entangled polymer compositions described herein have high toughness and high stiffness. In other embodiments, the entangled polymer compositions described herein have high strength and negligible hysteresis. As shown in FIGS. 1F-1G, a highly entangled hydrogel (FIG. 1F) with a water-to-monomer ratio (W) of 2.0 is turgid when swollen, while a cross-linked hydrogel (FIG. 1G) with the same number crosslinks (C=3.2×10⁻⁵) but a higher water content (W=25.0) is flaccid. In some embodiments, highly entangled polymer compositions also have the benefits of being synthesized by a single step, being homogeneous above the scale of the mesh size, and being optically transparent.

### A. Properties of Entangled Polymer Compositions

While a crosslink-dominant polymer has a net-like topology, as seen in FIGS. 1D-1E, in some embodiments, a highly entangled polymer composition has a fabric-like topology, as shown in FIGS. 1A-1C. In a crosslink-dominant polymer, crosslinks prevail over entanglements. In some embodiments, in a highly entangled polymer composition described herein, crosslinks are outnumbered enormously by entanglements. The different topologies result in different properties. When a short polymer chain in a crosslink-dominant polymer is stretched, as shown in FIG. 1E, tension is distributed over a chain's short length before it breaks and to a few other chains through two crosslinks so that when a single covalent bond breaks, the energy stored in these few short chains dissipates, resulting in a low toughness. In contrast, in some embodiments, when an entangled polymer composition is stretched, as shown in FIG. 1B, tension is distributed along a long polymer chain's length and to many chains through entanglements, as well as to a few other chains through two crosslinks. When a single covalent bond breaks, as shown in FIG. 1C, the energy stored in many long chains dissipates, leading to a high toughness. In some embodiments, the combination of sparse crosslinks and dense entanglements enables the polymer composition, e.g., hydrogel, to de-concentrate stress. This de-concentration of stress amplifies toughness. In some embodiments, the highly entangled polymer compositions can be used for load-bearing materials: they resolve the stiffness-toughness conflict, and simultaneously achieve high toughness and low hysteresis. In some embodiments, the entangled polymer compositions are strong, fatigue-resistant, and transparent. In some embodiments, upon swelling, these polymers form entangled gels with low friction and high wear resistance. Potential applications of highly entangled polymer compositions disclosed herein include swell-tolerant gels, fatigue-resistant adhesives, low-friction coatings, and transparent ionic conductors.

In some embodiments, the entangled polymer composition is a hydrogel. In some embodiments, when polymers are swollen with a solvent, e.g., water, they form gels. When synthesized in the presence of a large amount of solvent, some polymers gel through physical bonds, and others gel by chemical crosslinks. These two classes of hydrogels are exemplified by PVA and PEG. PVA hydrogels form crystalline domains through hydrogen bonds, and these physical hydrogels resist excessive swell, and exhibit high stiffness, strength, toughness, and fatigue resistance. However, during deformation, the hydrogen bonds break and reform, so that PVA hydrogels exhibit pronounced inelasticity. In contrast, dry PEG crystallizes, but dissolves in water, so to resist excessive swell in water, PEG hydrogels generally rely on dense chemical crosslinks, which leads to brittleness. In some embodiments, the entangled hydrogels can resist excessive swell and achieve high stiffness, strength, and toughness while exhibiting low hysteresis by relying on entanglements rather than crosslinks to resist swelling.

In some embodiments, the entangled polymer composition includes a plurality of entangled polymers which cannot be easily disentangled. In other embodiments, the sparse crosslinks prevent the polymer chains from disentangling. In some embodiments, polymer chains are long, leading to high toughness. Non-limiting examples of long polymer chains include polymers having a molecular weight greater than about 5×10⁵ g/mol or greater than about 10⁶ g/mol. In some embodiments, in the entangled polymer composition described herein, the entanglements cannot disentangle without chain scission, and entanglements help to further stiffen the polymer. Therefore, in some embodiments, the stiffening effect of entanglements is more pronounced when the crosslink density is low. In some embodiments, the polymer chains in the entangled polymer composition can slip with low friction, and thus the polymer composition can be loaded cyclically with low hysteresis.

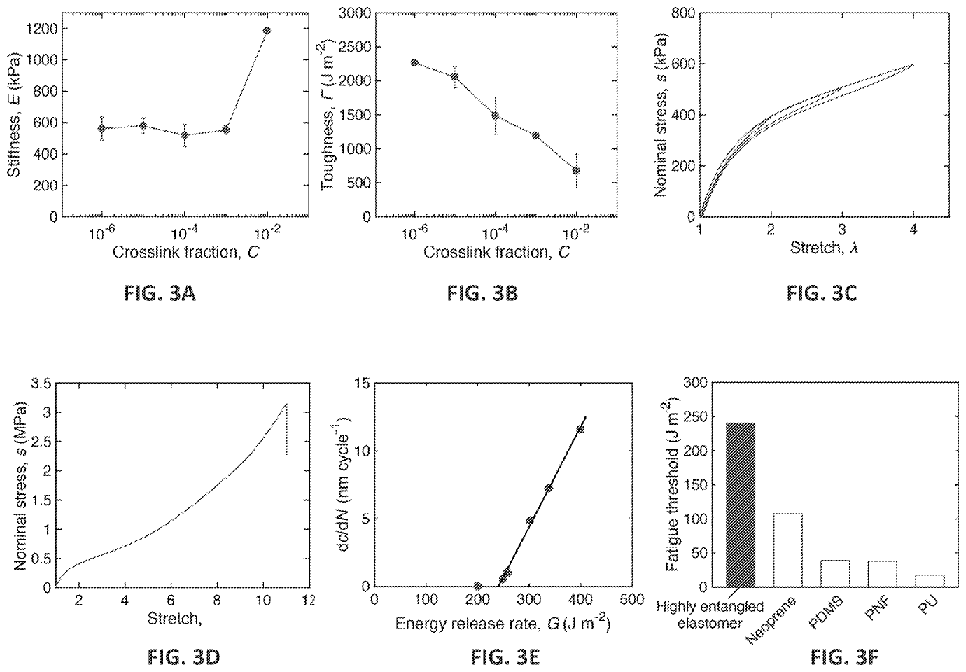

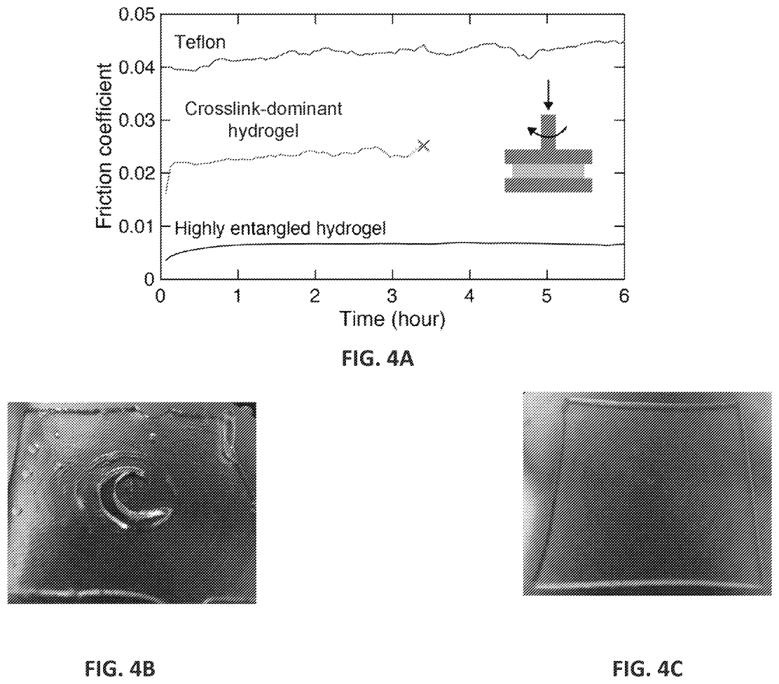

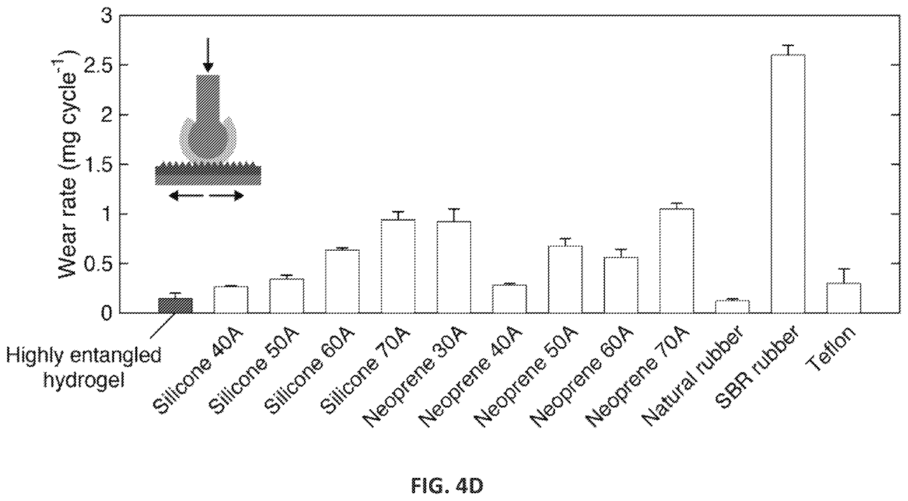

In some embodiments, the entangled polymer compositions have high stiffness and toughness. In some embodiments, the entangled polymer compositions also have negligible hysteresis. In some embodiments, the entangled polymer compositions also have high fatigue resistance under cyclic loading. In some embodiments, the entangled polymer composition is an elastomer. In other embodiments, the entangled polymer composition is submerged in a solvent and swollen to form a gel. In some embodiments, the entangled polymer composition is a gel with low hysteresis, low friction, and/or high wear resistance. In some embodiments, the solvent is water and the gel is a hydrogel. In some embodiments, the entangled polymer composition is transparent. FIGS. 2A-2H and FIGS. 4A-4D show properties of exemplary entangled hydrogels, while FIGS. 3A-3F show properties of exemplary entangled elastomers.

The polymer content of the entangled polymer composition is relatively insensitive to crosslink fraction within a critical range of crosslink fraction C. As used herein, “crosslink fraction” C refers to the molar ratio of crosslinker to monomer, “solvent fraction” W refers to the molar ratio of solvent to monomer, and “initiator fraction” I refers to the molar ratio of initiator to monomer. FIG. 2A shows the polymer content φ of an exemplary entangled hydrogel as a function of crosslink fraction C. For a hydrogel made of precursor of solvent fraction W=2.0, in the absence of crosslinks, C=0, chains dissolve in water, so that polymer content φ is vanishingly small. If C is nonzero but low, the hydrogel does not dissolve, but is inelastic and squishy. At a critical value, e.g., C˜ 1.0×10⁻⁵ for the hydrogel shown in FIG. 2A, φ rises steeply. For the entangled polymer compositions described herein, since crosslinking is accompanied by dense entanglements, the critical C is low compared to values commonly used in making hydrogels (e.g., 1.0×10⁻²-1.0×10⁻³). As C increases beyond the critical value, the φ plateaus and is maintained by entanglements. The plateau lasts until C˜10⁻³, beyond which φ increases gradually with I, indicating that crosslinks are dense enough to prevail over entanglements. The plateau narrows as solvent fraction W increases and disappears when W exceeds about 5. For the same value of C, a precursor of a smaller W leads to a hydrogel of higher φ. The lower the value of W, the denser entanglements, and the lower critical C. In a polymer network, the entropy of mixing drives swelling, but the entropy of elasticity drives de-swelling. In an entangled hydrogel, entanglements function as additional crosslinks and drive de-swelling.

In some embodiments, in entangled polymer compositions, entanglements contribute to high stiffness. FIG. 2B shows the stiffness E of an exemplary entangled hydrogel as a function of crosslink fraction C. Similar to polymer content, stiffness shows a plateau above a certain crosslink fraction C. This plateau indicates that the existence of entanglements can provide an estimate the density of entanglements. For example, in the exemplary hydrogel in FIG. 2B, the stiffness of the hydrogel of C=1.0×10⁻⁵ is similar to that of C=1.0×10⁻³. Assuming that all crosslinkers in a precursor are incorporated into the polymer, each crosslinker is an end of four chains, and each chain has two ends, so that the average number of monomers per chain is (2C)⁻¹. For the hydrogel of C=1.0×10⁻⁵, on average each chain has 1/(2C)=10⁵/2 monomers, but the measured stiffness indicates that the entanglements effectively shorten each chain to 10³/2 monomers. That is, in some embodiments, each chain has entanglements equivalent to 10² crosslinks. A similar stiffness plateau is seen in FIG. 3A, which shows the stiffness E of an exemplary entangled elastomer as a function of crosslink fraction C. As shown in FIG. 3A, as C increases beyond the critical value, stiffness of the entangled elastomer first plateaus and then increases again after C˜10⁻³, confirming that the elastomer is highly entangled.

In some embodiments, the polymer composition has a stiffness of at least about 50, 100, 200, 300, 400, 500, 600, 700, 800, 900, 1000, 1200 or 1500 kPa, or the stiffness is in any range bounded by any two values disclosed herein. In some embodiments, the stiffness of an entangled polymer composition is between about 50 kPa and about 800 kPa. In some embodiments, the stiffness of an entangled polymer composition is at least about 50 kPa. In some embodiments, the stiffness of an entangled polymer composition is at least about 100 kPa. In some embodiments, the stiffness of an entangled polymer composition is at least about 400 kPa. In some embodiments, the stiffness is 50-100 kPa, 100-200 kPa, 200-300 kPa, 300-400 kPa, 400-500 kPa, or 500-600 kPa, 600-700 kPa, 700-800 kPa, 800-900 kPa, 900-1000 kPa, 1000-1200 kPa, or 1200-1500 kPa. In some embodiments, the entangled polymer composition is an entangled hydrogel, and the stiffness of an entangled hydrogel is between about 50 kPa and about 300 kPa. In some embodiments, an entangled hydrogel has a stiffness of at least about 50, 100, 150, 200, 250, or 300 kPa, or the stiffness is in any range bounded by any two values disclosed herein. In some embodiments, the entangled polymer composition is an entangled elastomer, and the stiffness of an entangled elastomer is about 400-700 kPa. In some embodiments, an entangled elastomer has a stiffness of at least about 400, 450, 500, 550, 600, 650, or 700 kPa, or the stiffness is in any range bounded by any two values disclosed herein.

In some embodiments, the entangled polymer composition shows a high degree of elasticity. In some embodiments, the high elasticity results from several factors. First, even though the crosslinks are sparse, the dense entanglements aid in maintaining the network configuration when the polymer is stretched. Second, polymer chains are long (e.g. having a molecular weight greater than 5×10⁵ g/mol or greater than 106 g/mol) and do not break before the sample fractures. Third, if the entangled polymer composition is a gel, the solvent typically has a low viscosity, so that the fully swollen gel has low interchain friction, further increasing elasticity. FIG. 2C shows the stress-stretch curves for an exemplary entangled hydrogel stretched to different lengths 2, while FIG. 2D shows the stress-stretch curve of an exemplary entangled hydrogel loaded at different stretch rates. As shown in FIG. 2C, hysteresis of an entangled hydrogel is negligible under cyclic stretch to various amplitudes and a fixed rate. The ratio of the dissipated energy (i.e., area between the load and unload curves) to the applied work (i.e., the area under the load curve) is less than 1%. Furthermore, as shown in FIG. 2D, the stress-stretch curves and elastic response are insensitive to the stretch rate over two orders of magnitude. High elasticity is also seen in entangled elastomers, as shown in FIG. 3C, which shows the stress-stretch curve of an exemplary entangled elastomer with negligible hysteresis.

In some embodiments, the stress-stretch curves of entangled polymer compositions exhibit negligible hysteresis. In some embodiments, the hysteresis is the ratio of the dissipated energy (i.e., area between the load and unload curves) to the applied work (i.e., the area under the load curve). In some embodiments, a negligible hysteresis is a hysteresis of less than about 5%. In some embodiments, the hysteresis is less than about 1%, 2%, 3%, 4%, 5%, 6%, 7%, 8%, 9%, 10%, or the hysteresis is in any range bounded by any two values disclosed herein. In some embodiments, the hysteresis is less than about 5%. In some embodiments, the hysteresis is less than about 1%.

In some embodiments, the entangled polymer composition shows a high toughness. In some embodiments, the entangled polymer composition forms a fabric-like topology: the dense entanglements weave and the sparse crosslinks knot. Without being bound to any particular theory, it is believed that when such a polymer composition is stretched, tension is distributed along the long length of a chain and to many other entangled chains before the chain breaks, as well as to a few other chains through two crosslinks. Thus, when a single covalent bond breaks, the energy stored in many long chains dissipates, leading to a high toughness of the entangled polymer composition described herein. In some embodiments, the combination of sparse crosslinks and dense entanglements enables the entangled polymer composition described herein (e.g., the entangled hydrogel) to de-concentrate stress and amplify toughness. In some embodiments, due to the fabric-like topology, entangled polymer compositions have both high toughness and high elasticity (negligible hysteresis), which is rare in polymers. In some embodiments, for polymers made from precursors of low C and I, crosslinks are sparse, and entanglements are dense, and toughness scales as Γ˜C^{-1/2}, consistent with the prediction of the Lake-Thomas model. This confirms that entanglements do not hinder the transmission of tension along the length of the long polymer chains. FIG. 2E shows the toughness Γ of an exemplary entangled hydrogel as a function of crosslink fraction C. The entangled hydrogel has a high toughness (e.g., a toughness of 1,460 J/m²) and does not exhibit hysteresis. At small values of W, φ ranges from 8% to 16%. This modest change in φ is consistent with the observed weak dependence of toughness on W. For hydrogels made from precursors of high C and W, however, the crosslinks are dense, and the entanglements are sparse, and toughness falls substantially below the relation Γ˜C^{-1/2}. The toughness observed here, 1-10 J/m², is consistent with values reported in the literature for crosslink-dominant polyacrylamide hydrogels. FIG. 3B similarly shows high toughness in entangled elastomers with low crosslink fraction, e.g., with a toughness of 2,200 J/m² at C=10⁻⁶.

In some embodiments, the polymer composition has a toughness of at least about 200, 300, 400, 500, 600, 700, 800, 900, 1000, 1200, or 1500 Jm⁻², or the toughness is in any range bounded by any two values disclosed herein. In some embodiments, the toughness of an entangled polymer composition is between about 100 Jm⁻² to about 2500 Jm⁻². In some embodiments, the toughness of an entangled polymer composition is at least about 100 Jm⁻². In some embodiments, the toughness of an entangled polymer composition is at least about 500 Jm⁻². In some embodiments, the toughness is between about 100-200 Jm⁻², 200-300 Jm⁻², 300-400 Jm⁻², 400-500 Jm⁻², 500-600 Jm⁻², 600-700 Jm⁻², 600-700 Jm⁻², 700-800 Jm⁻², 800-900 Jm⁻², 900-1000 Jm⁻², 1000-1100 Jm⁻², 1200-1300 Jm⁻², 1300-1400 Jm⁻², 1400-1500 Jm⁻², 1500-1600 Jm⁻², 1600-1700 Jm⁻², 1700-1800 Jm⁻², 1800-1900 Jm⁻², or 1900-2000 Jm⁻², or 2000-2500 Jm⁻². In some embodiments, the entangled polymer composition is an entangled hydrogel, and the toughness of an entangled hydrogel is between about 100 Jm⁻² and about 2000 Jm⁻². In some embodiments, the entangled polymer composition is an entangled hydrogel which has a toughness of at least about 100, 200, 300, 400, 500, 600, 700, 800, 900, 1000, 1200, 1500, or 2000 Jm⁻², or the toughness is in any range bounded by any two values disclosed herein. In some embodiments, the entangled polymer composition is an entangled elastomer which has a toughness between about 500 Jm⁻² to about 2500 Jm⁻². In some embodiments, the entangled elastomer has a toughness of at least about 500, 600, 700, 800, 900, 1000, 1200, 1500, or 2000 Jm⁻², the toughness is in any range bounded by any two values disclosed herein.

As discussed above, in some embodiments, the entangled polymer compositions have both high stiffness and high toughness. In some embodiments, the entangled polymer compositions do not suffer from the stiffness-toughness conflict that exists in polymers that rely on crosslinks rather than entanglements, here called “crosslink-dominant polymers” to distinguish from the entangled polymer compositions described herein (entanglement-dominant polymers) which have a higher density of entanglements than crosslinks and rely primarily on entanglement rather than crosslinks. FIG. 2F shows the stiffness-toughness plane for polymers, including highly entangled hydrogels and crosslink-dominant hydrogels. Stiffness scales with the crosslink density as E˜C, and toughness scales with the crosslink density as Γ˜C^{-1/2}, so that crosslinks stiffen the polymers but embrittle them, and this also occurs in crosslink-dominant hydrogels. As shown in FIG. 2F, crosslink-dominant hydrogels (triangles) can have high toughness or high stiffness, but not both. For example, as shown in FIG. 2F, the toughness increases by 1000 times (103 Jm⁻² to 1 Jm⁻²) when the stiffness decreases by 10 times (rom 1 kPa to 10 kPa) in the case of crosslink-dominant hydrogels. However, in the highly entangled hydrogels (W=2.0), entanglements stiffen polymers and do not embrittle them. As a result, FIG. 2F shows that entangled hydrogels can have both high stiffness and high toughness. The combined stiffness and toughness can be expressed as the product of stiffness and toughness. As shown in FIG. 2F hydrogels have a stiffness-toughness product on the order of about 10² to 10³ J kPa m⁻², whereas the highly entangled hydrogels have a stiffness-toughness product on the order of about 10⁻⁴ to 10⁵ J kPa m⁻², and highly entangled elastomers are on the order of about 10⁵ to 10⁶ J kPa m⁻².

In some embodiments, the entangled polymer composition has high toughness while also exhibiting negligible hysteresis. In many polymers, hysteresis and toughness are positively correlated. These properties measure energy dissipation in two ways. Hysteresis measures energy dissipated in loading and unloading a sample without crack propagation. Toughness measures energy dissipated in crack propagation. Indeed, such hysteresis-toughness correlation has been commonly stated as a design principle in developing tough polymers. In some embodiments, highly entangled polymer compositions are exceptional in that they break the hysteresis-toughness correlation and simultaneously achieve both low hysteresis and high toughness. In some embodiments, highly entangled hydrogels achieve high toughness not by sacrificial bonds, but by having long chains and entanglements that can distribute tension. In a polymer with sacrificial bonds, upon loading, the sacrificial bonds break and do not heal within a short time, resulting in irreversible deformation. Consequently, the polymer degrades and has a different stress-stretch curve upon reloading. If the polymer is submerged in water, to form a gel, the degraded gel swells more and becomes even weaker. These shortcomings do not appear in a highly entangled polymer compositions or hydrogels as described herein. In some embodiments, entangled polymer compositions can be loaded and unloaded repeatedly while deforming reversibly.

In some embodiments, entanglements contribute to the strength of entangled polymer compositions for several reasons. First, entanglements readily slip and enable tension to transmit in polymer chains along their lengths. Second, entanglements transmit tension between polymer chains, and a highly entangled polymer composition has many more entanglements than a crosslink-dominant polymer. When a crosslink-dominant polymer is stretched, chains break at different times due to statistical distribution, lowering the strength. In contrast, in an entangled polymer composition, the strength is increased when entanglements distribute tension both along a polymer chain and between polymer chains. Third, in gels swollen with solvent, entanglements constrain the swelling. FIG. 2G shows the stress-stretch curve for an entangled hydrogel, a hard crosslink-dominant hydrogel, and a soft crosslink-dominant hydrogel loaded in tension to rupture. As shown in FIG. 2G, the strength is 390 kPa for a highly entangled hydrogel (W=2.0 and C=1.0×10⁻⁵), 23 kPa for a hard crosslink-dominant hydrogel (W=25 and C=1.0×10⁻²), and 31 kPa for a soft crosslink-dominant hydrogel (W=25 and C=3.2×10⁻⁴). For the hydrogels shown in FIG. 2G φ=16% (entangled hydrogel), 7.6% (hard crosslink-dominant hydrogel), and 3.2% (soft crosslink-dominant hydrogel), so that the highly entangled hydrogel has more polymers to carry the load than the two crosslink-dominant hydrogels. A similarly high strength is observed in entangled elastomers, as shown in FIG. 3D, which shows a highly entangled elastomer with a nominal strength of 3.2 MPa, corresponding to a true strength of 35 MPa, which is one order of magnitude higher than those of common unfilled acrylic elastomers.

In some embodiments, the strength of the polymer composition is characterized by the nominal tensile strength. The nominal tensile strength is measured in tension and is the force at failure divided by the original cross-sectional area of the sample. In some embodiments, the polymer composition has a nominal tensile strength of at least about 100, 150, 200, 250, 300, 350, 400, 450, 500, 600, 700, 800, 900, 1000, 1500, 2000, 2500, 3000, or 3500 kPa, or the nominal tensile strength is in any range bounded by any two values disclosed herein. In some embodiments, the nominal tensile strength of an entangled polymer composition is at least about 100 kPa. In some embodiments, the nominal tensile strength of an entangled polymer composition is at least about 2 MPa. In some embodiments the nominal tensile strength of an entangled polymer composition is between about 100 kPa and 3.5 MPa. In some embodiments, the nominal tensile strength of an entangled polymer composition is 100-150 kPa, 150-200 kPa, 250-300 kPa, 300-350 kPa, 350-400 kPa, 400-450 kPa, 450-500 kPa, 500-600 kPa, 600-700 kPa, 700-800 kPa, 800-900 kPa, 900-1000 kPa, 1-1.5 MPa, 1.5-2 MPa, 2-2.5 MPa, 2.5-3.0 MPa, or 3.0-3.5 MPa. In some embodiments, the entangled polymer composition is an entangled hydrogel which has a nominal tensile strength between about 300-500 kPa. In some embodiments, the entangled hydrogel has a nominal tensile strength between about 300, 350, 400, 450, or 500 kPa or the nominal tensile strength is in any range bounded by any two values disclosed herein. In some embodiments, the nominal tensile strength of the entangled elastomer is between about 2.5-3.5 MPa. In some embodiments, the entangled polymer composition is an entangled elastomer which has a nominal tensile strength between about 2.5, 2.75, 3.0, 3.25, or 3.5 MPa, or the nominal tensile strength is in any range bounded by any two values disclosed herein.

In some embodiments, entanglements also improve the fatigue threshold of entangled polymer compositions subject to cyclical load. Performance of many polymers are limited, not by toughness under monotonic load, but by fatigue under cyclical load. For example, pure natural rubber has toughness ˜10⁻⁴ J/m², but fatigue threshold ˜50 J/m². The toughness of natural rubber comes mainly from a dissipation process in the bulk (i.e., strain-induced crystallization), and the fatigue threshold comes from breaking chains across the crack plane. FIG. 2H shows the crack extension per cycle in an exemplary highly entangled hydrogel at various amplitudes of energy release rate. A linear regression of data estimates the fatigue threshold ˜200 J/m². This value is about four times that of natural rubber and about 20 times that of a crosslink-dominant hydrogel. In some embodiments, highly entangled polymer compositions have high fatigue threshold because of the combination of high toughness and high elasticity. For example, increasing toughness by incorporating entanglements distributes tension along the polymer chains in an inelastic, recoverable process, resulting in low hysteresis. In contrast, materials that improve toughness by inelastic means have high hysteresis and therefore do not have a high fatigue threshold. FIG. 3E similarly shows the crack extension per cycle in a highly entangled elastomer at various amplitudes of energy release rate, demonstrating a high fatigue threshold (e.g., ˜240 J/m²) for an exemplary entangled elastomer. As shown in FIG. 3F, this fatigue threshold is much higher than other elastomers with similar stiffness, including neoprene, polydimethylsiloxane, phosphonitrilic fluoroelastomer, and polyurethane.

In some embodiments, the polymer composition has a fatigue threshold of at least about 150, 160, 170, 180, 190, 200, 210, 220, 230, 240, 250, 300, or 350 Jm⁻², or the fatigue threshold is in any range bounded by any two values disclosed herein. In some embodiments, the fatigue threshold of an entangled polymer composition is at least about 150 Jm⁻². In some embodiments, the fatigue threshold of an entangled polymer composition is at least about 200 Jm⁻². In some embodiments, the entangled polymer composition is an entangled hydrogel which has a fatigue threshold of at least about 200 Jm⁻². In some embodiments, the entangled polymer composition is an entangled elastomer which has a fatigue threshold of at least about 240 Jm⁻².

In some embodiments, the entangled polymer composition is an entangled gel infused with a solvent which is slippery and wear resistant. In some embodiment, the gel is infused with water and is a hydrogel. In some embodiments, the gel is infused with an organic solvent and is an organogel. In some embodiments, when a gel slides on a substrate, each polymer chain at the surface of the gel is anchored to the polymer network on one end, and mobile on the other end, provided that the polymer chain negligibly adsorbs to the substrate. These dangling and hydrophilic polymer chains stabilize a solvent-rich layer, which lubricates the surfaces. The friction decreases as the thickness of the solvent-rich layer increases, and the thickness scales with the size of the dangling chains. Highly entangled gels have much longer polymer chains than the crosslink-dominant gels, resulting in a lower friction coefficient. FIG. 4A shows the friction coefficient of an exemplary entangled hydrogel, a crosslink-dominant hydrogel, and Teflon. As shown in FIG. 4A, the friction of the crosslink-dominant hydrogel and six times lower than that of Teflon. Low friction, together with high toughness and fatigue threshold, leads to a low wear rate. As shown in FIGS. 4B-4C, the crosslink-dominant hydrogel (FIG. 4B) ruptures after three hours of slide in a rheometer, but the highly entangled hydrogel (FIG. 4C) remains intact after six hours of sliding. FIG. 4D shows that the highly entangled hydrogel has a lower wear rate than Teflon and other materials, including silicone, neoprene, natural rubber, and styrene butadiene rubber.

In some embodiments, the polymer composition has a coefficient of friction of less than about 0.05, 0.04, 0.03, 0.02, 0.01, 0.005, or 0.001, or the coefficient of friction is in any range bounded by any two values disclosed herein. In some embodiments, the coefficient of friction of the entangled polymer composition is less than about 0.05. In some embodiments the coefficient of friction of the entangled polymer composition is less than about 0.04. In some embodiments, the coefficient of friction of the entangled polymer composition is less than about 0.03. In some embodiments, the coefficient of friction of the entangled polymer composition is less than about 0.02. In some embodiments the coefficient of friction of the entangled polymer composition is less than about 0.01. In some embodiments, the coefficient of friction of the entangled polymer composition is less than about 0.005. In some embodiments, the coefficient of friction of the entangled polymer composition is less than about 0.001. In some embodiments, the coefficient of friction of the entangled polymer composition is less than about 0.006-0.007.

In some embodiments, the wear rate of the entangled polymer composition is less than about 1, 0.5, 0.3, 0.25, 0.2, 0.15, or 0.1 mg/cycle, or the wear rate is in any range bounded by any two values disclosed herein. In some embodiments, the wear rate of the entangled polymer composition is less than about 0.1-0.2 mg/cycle.

### B. Polymer Materials

In some embodiments, entangled polymer compositions include long chained polymers. By including long chained polymers, entangled polymer compositions can transmit tension along the lengths of those polymer chains, contributing to high toughness and low hysteresis. In some embodiments, the molecular weight of the polymer chains in the entangled polymer composition is at least about 5×10⁵ g/mol or at least about 10⁶ g/mol, or any range bounded by any two values disclosed herein.

Non-limiting exemplary polymers include natural rubber, silicon rubber, poly(ethyl acrylate), poly(acrylamide), polyacrylic acid, polyethylene glycol, polyvinylpyrrolidone, polyvinyl alcohol, poly(2-hydroxyethyl methacrylate), poly(methacrylic acid), poly(N-isopropyl acrylamide), poly(methyl methacrylate), polymethacrylate, poly(ethyl methacrylate), poly(propyl acrylate), poly(propyl methacrylate), poly(butyl acrylate), poly(methacrylic acid), poly(butyl methacrylate), polyethylene, polypropylene, poly(vinyl acetate), polyacrylonitrile, polybutadiene, polyisobutylene, polyisoprene, polychloroprene, polynorbornene, polytetrafluoroethylene, ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), poly(isobutylene-co-isoprene), poly(perfluoromethylvinylether), poly(styrene-co-butadiene), polyurethane, polysulfide, polysiloxane, and any combinations or copolymers thereof. Non-limiting exemplary polymers include cellulose, alginate, chitosan, hyaluronic acid, collagen, gelatin, starch, chitin, agarose, dextran, konjac glucomannan, pullulan, guar gum, polynucleotide, polyisoprene, polyamide, and a combination thereof.

In some embodiments, the entangled polymer composition is swollen with a solvent to form a gel. If the solvent is water, an entangled hydrogel is formed. If the solvent is an organic solvent, an entangled organogel is formed. Non-limiting exemplary organic solvents include ethylene glycol, glycerol, ethyl alcohol, isopropyl alcohol, tetrahydrofuran, silicone oils, dimethyl sulfoxide, dimethylformamide, and a combination thereof.

In some embodiments, the entangled polymer composition is an entangled hydrogel. Exemplary hydrogels include poly(acrylamide), poly acrylic acid, polyethylene glycol, cellulose, alginate, chitosan, hyaluronic acid, collagen, gelatin, starch, chitin, agarose, dextran, konjac glucomannan, and a combination thereof. In some embodiments, the hydrogel is a polyelectrolyte. Non-limiting exemplary polyelectrolytes include poly acrylic acid, polygalacturonic acid, alginic acid, carboxymethyl cellulose, poly(2-Acrylamido-2-methyl-1-propanesulfonic acid), poly(sodium p-styrenesulphonate), and poly(3-(methacryloylamino) propyl-trimethylammonium chloride), poly(methyl chloride quarternized N, N-dimethylamino ethylacrylate), and a combination thereof.

In some embodiments, the entangled polymer composition is an elastomer. Non-limiting exemplary elastomers include natural rubber, silicon rubber, poly(ethyl acrylate), poly(acrylamide), polyacrylic acid, poly(methyl methacrylate), polymethacrylate, poly(ethyl methacrylate), poly(propyl acrylate), poly(propyl methacrylate), poly(butyl acrylate), poly(acrylic acid), poly(methacrylic acid), poly(butyl methacrylate), polyethylene, polypropylene, poly(vinyl acetate), polyacrylonitrile, polybutadiene, polyisobutylene, polyisoprene, polychloroprene, polynorbornene, polytetrafluoroethylene, ethylene acrylate copolymers, ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), poly(isobutylene-co-isoprene), poly(perfluoromethylvinylether), poly(styrene-co-butadiene), polyurethane, polysulfide, polysiloxane, and any combinations or copolymers thereof.

In some embodiments, the entangled polymer composition is an organogel. In some embodiments, an organogel is an elastomer swollen with an organic solvent. Non-limiting exemplary organogels include poly(ethyl acrylate) swollen with dimethylformamide. In some embodiments the organogel is an elastomer selected from natural rubber, silicon rubber, poly(ethyl acrylate), poly(methyl methacrylate), polymethacrylate, poly(ethyl methacrylate), poly(propyl acrylate), poly(propyl methacrylate), poly(butyl acrylate), poly(acrylic acid), poly(methacrylic acid), poly(butyl methacrylate), polyethylene, polypropylene, poly(vinyl acetate), polyacrylonitrile, polybutadiene, polyisobutylene, polyisoprene, polychloroprene, polynorbornene, polytetrafluoroethylene, and any combinations or copolymers thereof, and the organic solvent is selected from ethylene glycol, glycerol, ethyl alcohol, isopropyl alcohol, tetrahydrofuran, silicone oils, dimethyl sulfoxide, dimethylformamide, and a combination thereof.

### C. Crosslinks

In some embodiments, the entangled polymer composition includes a small number of crosslinks. In some embodiments, the number of entanglements greatly outnumbers the number of crosslinks. For example, entangled polymer compositions can have about 100 entanglements between each crosslink. In some embodiments, entangled polymer compositions have about 50-100 entanglements per crosslink, 100-200 entanglements per crosslink, or 200-300 entanglements per crosslink. The number of crosslinks in entangled polymer compositions can also be expressed in terms of the density of crosslinks per monomer unit. In some embodiments, the density of crosslinks is no more than one crosslink per 1,000 monomer units of the polymer. In some embodiments, the density of crosslinks is no more than one crosslink per 10,000 monomer units of the polymer. In some embodiments, the density of crosslinks is no more than one crosslink per 100,000 monomer units of the polymer. In some embodiments, the entangled polymer composition are formed using fewer than one crosslink for 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, or 1,000 monomer units, or the number of monomer units is any range bounded by any two values disclosed herein. Alternatively, the number of crosslinks can expressed in terms of the crosslink fraction C, the crosslinker-to-monomer molar ratio. In some embodiments, the crosslink fraction is less than about 10⁻³, less than about 10⁻⁴, less than about 10⁻⁵, or less than about 10⁻⁶, or in any range bounded by any two values disclosed herein. In some embodiments, the entangled polymer composition is a hydrogel, and the crosslink fraction is less than about 10⁻³, less than about 10⁻⁴, or less than about 10⁻⁵ or in any range bounded by any two values disclosed herein. In some embodiments, the entangled polymer composition is an elastomer, and the crosslink fraction is less than about 10⁻³, less than about 10⁻⁴, less than about 10⁻⁵, less than about 10⁻⁶, or in any range bounded by any two values disclosed herein.

Non-limiting exemplary crosslinkers include poly(ethylene glycol) diacrylate, Tricyclo[5.2.1.0^{2,6}]decanedimethanol diacrylate, Ethylene glycol diacrylate, 1,4-Butanediol diacrylate, Poly(propylene glycol) diacrylate, Di(ethylene glycol) diacrylate, Bisphenol A ethoxylate diacrylate, 1,3-Butanediol diacrylate, 1,6-Hexanediol diacrylate, Tri (ethyleneglycol) diacrylate, Neopentyl glycol diacrylate, Tetra(ethylene glycol) diacrylate, benzophenone, glycidyl methacrylate, adipic acid dihydrazide, butanediol-diglycidyl ether, citric acid, glutaraldehyde, divinyl sulfone, sulfur, and a combination thereof. In some embodiments, crosslinks can be formed by application of heat, UV (ultraviolet) light, visible light, gamma rays, catalysts, and a combination thereof.

### II. Methods of Forming Entangled Polymer Compositions

A. Forming Entangled Polymer Compositions from Monomers

In another aspect, a method of forming an entangled polymer composition is disclosed, including a) providing a mixture including a plurality of monomers; a plurality of crosslinkers, wherein there are no more than one crosslinker per 1,000 monomers; and a solvent, wherein the molar ratio of solvent to monomer is less than 12; b) polymerizing the monomers to form polymers and entangling the polymers to form an entangled polymer network; and c) forming crosslinks by crosslinking the polymers. In some embodiments, the entangled polymer composition is synthesized from monomers. In these embodiments, entangled polymer composition is formed using monomers and low levels of other precursors including solvent, crosslinkers, and initiators. In some embodiments, the solvent is water. In some embodiments, the solvent is an organic solvent, e.g., ethylene glycol, glycerol, ethyl alcohol, isopropyl alcohol, tetrahydrofuran, silicone oils, dimethyl sulfoxide, dimethylformamide, and a combination thereof. In some embodiments, crowding monomers in a small amount of solvent results in crowded polymers which form dense entanglements. In these embodiments, monomers are mixed with a small amount of solvent and crosslinkers. The monomers are polymerized to form an entangled polymer network. In some embodiments, the precursors include an initiator to initiate polymerization. Crosslinks are formed in the polymer network, for example, by applying heat or UV light. In some embodiments, crosslinkers are formed at a density of no more than one crosslink per 1,000 monomers, no more than one crosslink per 10,000 monomers, or no more than one crosslink per 100,000 monomers. In some embodiments, the ratio of solvent to monomers is between about 0.0 and 12.0, for example about 0.0, 1.0, 2.0, 3.0, 3.2, 4.0, 5.0, 6.0, 7.0, 7.7, 8.0, 9.0, 10.0, 11.0 or 12.

In one embodiment, a method of forming an entangled polymer composition is disclosed, including a) providing a mixture including a plurality of monomers; a plurality of crosslinkers, wherein there are no more than one crosslinker per 1,000 monomers; and a solvent, wherein the molar ratio of solvent to monomer is less than 12; b) polymerizing the monomers to form polymers and entangling the polymers to form an entangled polymer network; c) forming crosslinks by crosslinking the polymer and; d) swelling the entangled polymer network with a solvent after forming crosslinks. In some embodiments, the solvent is water and the polymer composition is a hydrogel. In some embodiments, the solvent is an organic solvent and the polymer composition is an organogel.

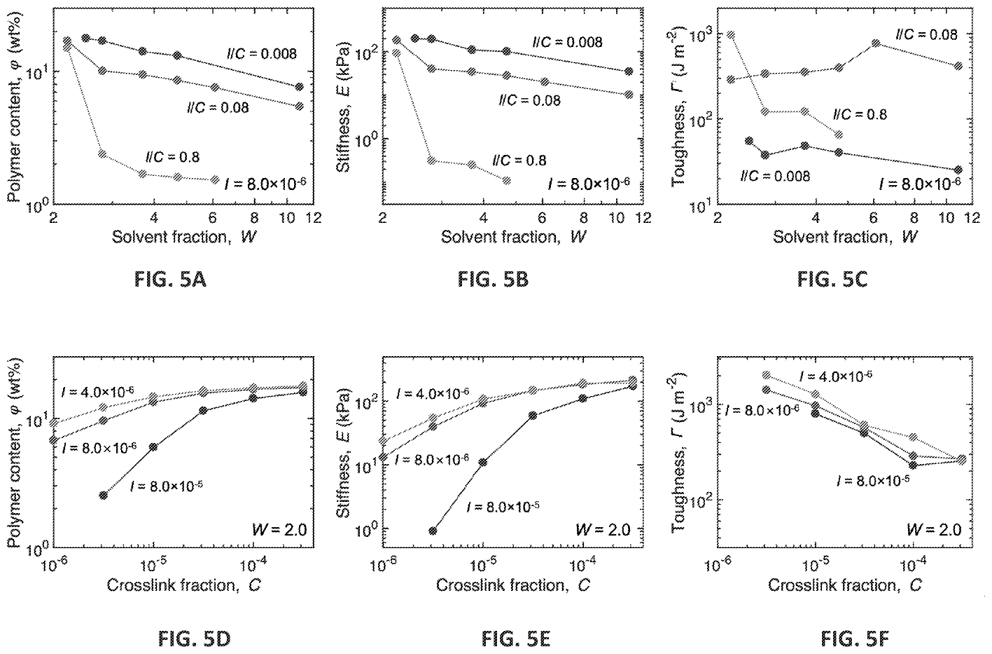

The properties of entangled polymer compositions can be tuned based on synthesis parameters. In the precursor, let W be the solvent-to-monomer molar ratio, C be the crosslinker-to-monomer molar ratio, and/be the initiator-to-monomer molar ratio. FIGS. 5A-5F show how polymer content φ, stiffness E, and toughness Γ of an exemplary entangled hydrogel vary depending on the solvent fraction W, crosslink fraction C, and initiator fraction I. In the embodiments shown in FIGS. 5A-5F, each hydrogel is submerged in water to swell to equilibrium before measurement.

In FIGS. 5A-5C, I is fixed at 8.0×10⁻⁶ and C is fixed at 1.0×10⁻⁵, 1.0×10⁻⁴, and 1.0×10⁻³, which gives I/C=0.8, 0.08, and 0.008. When I/C is high (I/C=0.8), many polymer chains are initiated, which forms a hydrogel of many dangling chains, and causes low values of φ, E, and Γ with enormous swelling. For example, hydrogels made with precursors of the low values of I/C of 0.08 and 0.008 show almost the same trends as those made with precursors of I/C=0.4 (shown in FIGS. 2A-2H). In some embodiments, to obtain a well-formed hydrogel, I/C is fixed at 0.4, so that the initiating points that generate dangling chains are fewer than crosslinks.

In FIGS. 5D-5F, solvent fraction W is fixed at 2.0 and polymer content, stiffness and toughness are measured as a function of crosslink fraction C. At any initiator fraction I, polymer content φ and stiffness E drop when I/C is higher than ˜0.5, leading to inelastic solids with enormous swelling. Toughness is less sensitive to initiator fraction I, but high I/C lowers the minimum C required to obtain a well-formed network, suggesting that the toughness is limited by I. For example, the maximum toughness is ˜2,000 J/m² at I=4.0×10⁻⁶ but is ˜800 J/m² at I=8.0×10⁻⁵.

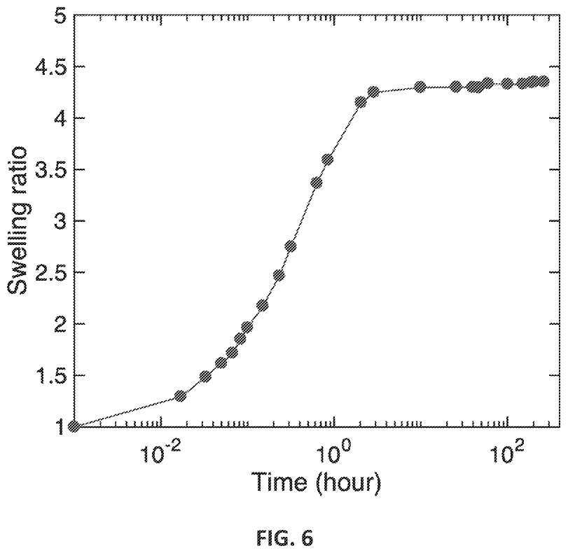

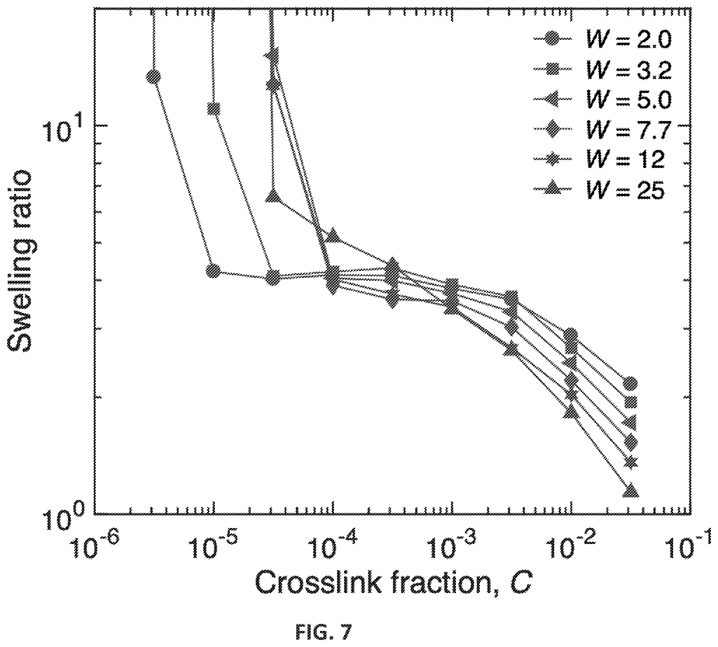

In some embodiments, the polymer network is swollen with a solvent after synthesis until reaching equilibrium. For example, FIG. 6 shows the swelling ratio over time of a hydrogel submerged in water until the hydrogel reaches equilibrium. FIG. 7 shows the effect of solvent fraction W and crosslink fraction C on the swelling ratio of a hydrogel. For example, at W=2.0, the hydrogel is not well-formed and swells enormously when C=3.2×10⁻⁶. The swelling ratio reduces greatly at a critical value C=1.0×10⁻⁵, and when C exceeds this critical value, the swelling ratio plateaus. The swelling ratio reduces further when C >1.0×10⁻³. As W increases, the plateau narrows and disappears when W˜5. The plateau reflects the effect of entanglements. At the plateau, the swelling ratio is insensitive to both C and W. At a high value of C, say C=1.0×10⁻², the effect of entanglements on swelling is negligible, so that the swelling ratio increases as W decreases.

In some embodiments, elastomers can be formed using a monomer without solvent at low C and I. In some embodiments, monomers for entangled elastomers are selected based on the following considerations: i) the monomer is a liquid of low viscosity (e.g., 0.1 mP s˜100 mP s), (ii) the resulting polymer is rubbery (e.g., T_{g}<temperature), and (iii) the resulting polymer has low entanglement molecular weight (e.g., less than 103 g/mol) as measured by a rheometer. Non-limiting exemplary suitable monomers for entangled elastomers include ethyl acrylate, methyl methacrylate, methacrylate, ethyl acrylate, ethyl methacrylate, propyl acrylate, propyl methacrylate, butyl acrylate, acrylic acid, methacrylic acid, butyl methacrylate, ethylene, propylene, vinyl acetate, acrylonitrile, butadiene, Isobutylene, isoprene, chloroprene, norbornene, tetrafluoroethylene, and combinations thereof.

In some embodiments, the solvent fraction W is between about 0.0 and 12.0, for example, about 0.0, 1.0, 2.0, 3.0, 3.2, 4.0, 5.0, 6.0, 7.0, 7.7, 8.0, 9.0, 10.0, 11.0 or 12, or the solvent ratio is in aby range bounded by any two values disclosed herein. In some embodiments, the solvent fraction W is equal to the lowest solubility of the monomer in the solvent. In some embodiments, the solvent fraction W s greater than about the lowest solubility of monomer in the solvent. In some embodiments, the solubility of the solvent is determined at 30° C.

As used herein, “initiator fraction” I refers to the molar ratio of initiator to monomer. In some embodiments, the initiator fraction I is 4.0×10⁻⁶, 8.0×10⁻⁶, or 8.0×10⁻⁵, or in any range bounded by any two values disclosed herein. In some embodiments, the initiator fraction is less than about 10⁻⁵.

As used herein, “crosslink fraction” C refers to the molar ratio of crosslinker to monomer. In some embodiments, the crosslink fraction C is about 3.2×10⁻⁶, 1.0×10⁻⁵, 1.0×10⁻⁴, or 1.0×10⁻³, or in any range bounded by any two values disclosed herein. In some embodiments, the crosslink fraction is less than about 10⁻³, less than about 10⁻⁴, less than about 10⁻⁵, or less than about 10⁻⁶, or in any range bounded by any two values disclosed herein.

In some embodiments the initiator to crosslinker ratio is 0.008, 0.08, 0.4, 0.5 or 0.8, 1.0 or in any range bounded by any two values disclosed herein. In some embodiments, the initiator to crosslinker ratio is less than 0.5. In some embodiments, the initiator to crosslinker ratio is less than 0.8. In some embodiments, the initiator to crosslinker ratio is less than 1.0.

In some embodiments, an entangled hydrogel is formed with W is about 2, C is about 1.2×10⁻⁵, I is about 4.8×10⁻⁶. In some embodiments, an entangled hydrogel is formed with W is about 0, C is about 1×10⁻⁶, I is about 1×10⁻⁶.

Non-limiting exemplary monomers include ethyl acrylate, acrylamide, acrylic acid, 2-Hydroxyethyl methacrylate, ethylene glycol, methacrylic acid, N-isopropyl Acrylamide, methyl methacrylate, methacrylate, ethyl acrylate, ethyl methacrylate, propyl acrylate, propyl methacrylate, butyl acrylate, acrylic acid, methacrylic acid, butyl methacrylate, ethylene, propylene, vinyl acetate, acrylonitrile, butadiene, Isobutylene, isoprene, chloroprene, norbornene, tetrafluoroethylene, and a combination thereof.

Non-limiting exemplary initiators include 2-Hydroxy-4′-(2-hydroxyethoxy)-2-methylpropiophenone, 2-Hydroxy-2-methylpropiophenone, glycidyl methacrylate, 2-oxoglutaric acid, benzophenone, and a combination thereof.

Non-limiting exemplary crosslinkers include is poly(ethylene glycol) diacrylate, Tricyclo[5.2.1.0^{2,6}]decanedimethanol diacrylate, Ethylene glycol diacrylate, 1,4-Butanediol diacrylate, Poly(propylene glycol) diacrylate, Di(ethylene glycol) diacrylate, Bisphenol A ethoxylate diacrylate, 1,3-Butanediol diacrylate, 1,6-Hexanediol diacrylate, Tri (ethyleneglycol) diacrylate, Neopentyl glycol diacrylate, Tetra(ethylene glycol) diacrylate, benzophenone, glycidyl methacrylate, adipic acid dihydrazide, butanediol-diglycidyl ether, citric acid, glutaraldehyde, divinyl sulfone, sulfur, and a combination thereof. In some embodiments, the crosslinks are formed by application of heat, ultraviolet light, visible light, gamma rays, catalysts, and a combination thereof.

In some embodiments, the concentration of the oxygen dissolved in the precursor is as low as possible. For example, oxygen level in the curing environment should be as low as possible.

B. Forming Entangled Polymer Compositions from Preformed Polymers

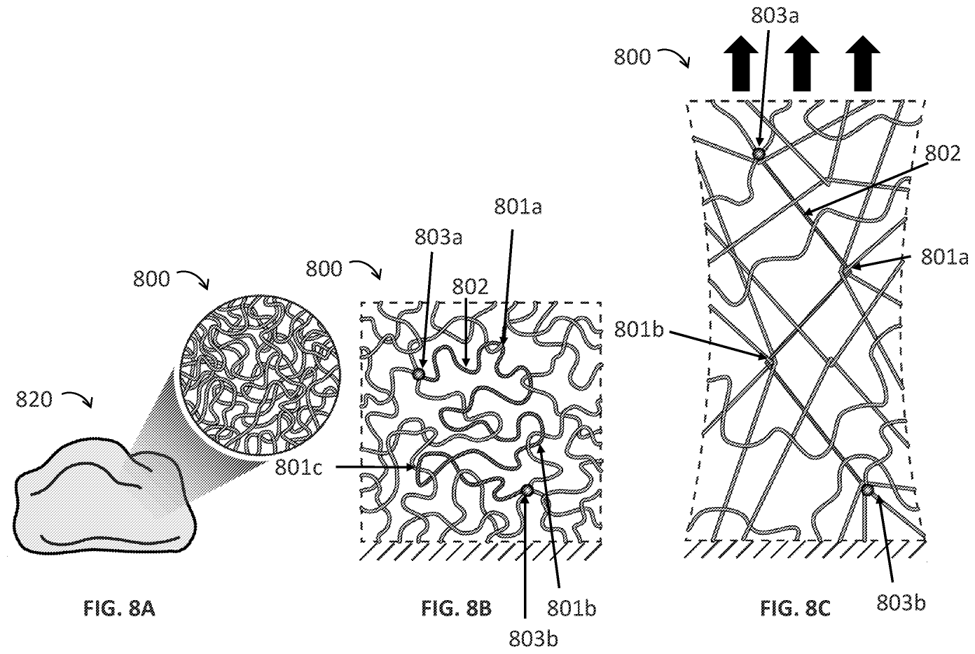

In yet another aspect, a method of forming an entangled polymer composition is disclosed, including a) providing a mixture including a plurality of polymer chains; a plurality of crosslinkers, wherein there are no more than one crosslinker per 1,000 monomers in the polymer chains; and a solvent; b) kneading the mixture of precursors at a temperature of at least about 40° C. to form an entangled polymer network; and c) crosslinking the polymer chains to form crosslinks. In some embodiments, the method described herein can be described with reference to FIGS. 8A-8B. As shown in FIGS. 8A-8B, entangled polymer compositions 800 can be formed from a mixture such as a dough. A dough is formed by mixing long polymer chains with a solvent and, optionally, an initiator. In some embodiments, the dough is homogenized by kneading and annealing, optionally at elevated temperatures, during which the crowded polymers densely entangle. The polymers are then crosslinked. In some embodiments, the resulting entangled polymer composition has exceptionally dense entanglements and sparse crosslinks, and is highly elastic, stiff, strong, and tough. In some embodiments, the dough is swollen with a solvent to equilibrium, resulting in a swell-resistant gel with low friction.

In one embodiment, a method of forming an entangled polymer composition is disclosed, including a) providing a mixture including a plurality of polymer chains; a plurality of crosslinkers, wherein there are no more than one crosslinker per 1,000 monomers in the polymer chains; and a solvent; b) kneading the mixture of precursors at a temperature of at least about 40° C. to form an entangled polymer network; c) crosslinking the polymer chains to form crosslinks; In some embodiments, the solvent is water and the polymer composition is a hydrogel; and d) swelling the entangled polymer network with a solvent after forming crosslinks. In some embodiments, the solvent is an organic solvent and the polymer composition is an organogel.

In some embodiments, the dough is homogenized by kneading and annealing, such that the polymer chains do not degrade or break, but densely entangle. In some embodiments, kneading, annealing, or both occur at elevated temperatures. The polymer chains are then sparsely crosslinked. In some embodiments, the dough is swollen into a gel. In the entangled polymer composition formed from dough, the dense entanglements weave and the sparse crosslinks knot. Together, dense crosslinks and sparse crosslinks maintain the fabric-like topology in the polymer. When the entangled polymer composition is stretched, before a chain breaks, the tension transmits in the chain along its long length, and to many entangled chains and a few crosslinked chains. This de-concentration of tension strengthens and toughens the entangled polymer composition. In some embodiments, the entangled polymer composition shows high elasticity and high toughness simultaneously, because toughness does not come from sacrificial bonds but from having long chains. In some embodiments, the entangled polymer composition is further swelled by water to form an entangled hydrogel formed by this method is swell-resistant and has low friction. The method of forming entangled polymer compositions from doughs is generally applicable to synthetic and natural polymers, and is compatible with industrial processing technologies, opening doors to the development of sustainable, high-performance entangled polymer compositions and hydrogels.

Forming entangled polymer compositions from existing polymer chains by forming a dough has two benefits. First, some synthetic polymers require specialized polymerization conditions to achieve high molecular weight and low polydispersity. Such non-limiting exemplary synthetic polymers include poly(ethylene glycol), poly(vinyl pyrrolidone), poly(vinyl alcohol), silicone rubbers, nitrile rubbers, poly(methyl methacrylate), polymethacrylate, poly(ethyl acrylate), poly(ethyl methacrylate), poly(propyl acrylate), poly(propyl methacrylate), poly(butyl acrylate), poly(acrylic acid), poly(methacrylic acid), poly(butyl methacrylate), ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), polyacrylonitrile, polyisobutylene, poly(isobutylene-co-isoprene), poly(tetrafluoro ethylene), poly(tetrafluoroethylene), poly(perfluoromethylvinylether), poly(styrene-co-butadiene), polyurethane, polyisoprene, polychloroprene, polybutadiene, polysulfide, polynorbornene, polysiloxane, polyethylene, polypropylene, and combinations thereof. Second, many sustainable polymers are derived from natural polymers. Such non-limiting exemplary natural polymers include cellulose, alginate, chitosan, hyaluronic acid, collagen, gelatin, starch, chitin, agarose, dextran, konjac glucomannan, pullulan, guar gum, polynucleotide, polyisoprene, polyamide, and combinations thereof. As such, the method disclosed herein can efficiently utilize preformed or presynthesized polymer material.

As shown in an exemplary embodiment in FIGS. 8A-8C, when an entangled polymer network 800 is formed from a dough 820 as described above, the resulting polymer has long polymer chains 802, and the entanglements (e.g., 801a, 801b, 801c) of polymer chains 802 greatly outnumber crosslinks 803a, 803b and the entangled polymer composition has a fabric-like topology. FIG. 8B shows an exemplary entangled polymer network where a long polymer chain 802 has a large number of entanglements (801a, 801b, 801c) along its length and a crosslink (803a, 803b) at each end. In some embodiments, dense entanglements enable transmission of tension in a polymer chain along its length and to many other chains. These entanglements stiffen the polymer but, unlike crosslinks, entanglements do not embrittle the polymer. As shown in FIG. 8C, when an entangled polymer network formed by a dough is stretched, tension is transmitted along the chain 802 and other chains in the entangled polymer network 800 before the chain 802 breaks. When the chain 802 breaks, for example at a covalent bond, the entangled polymer network 800 dissipates elastic energy in many other chains, over long lengths. For example, a broken bond relaxes the broken chain 802 and partly relaxes the remaining entangled and crosslinked chains.

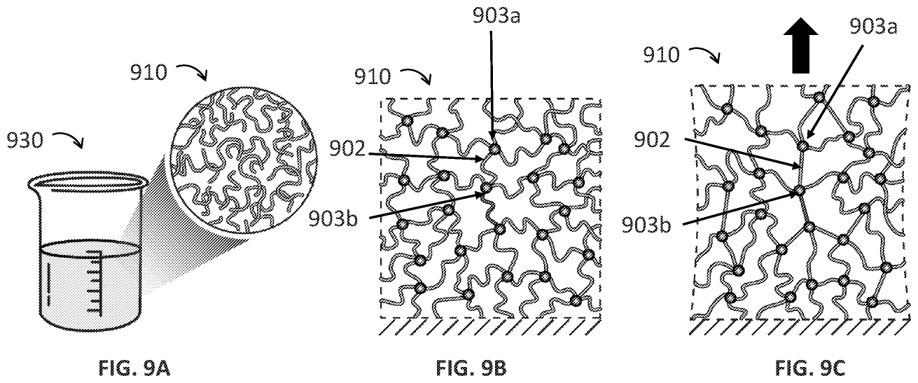

In contrast, when a polymer is formed using short-chain polymers, as shown in FIGS. 9A-9C, a crosslink-dominant polymer 910 with net-like topology is formed. As shown in FIG. 9A, short polymer chains 902 are combined with a large amount of solvent to form a solution 930. The solution is crosslinked to form a crosslink-dominant polymer with short polymer chains 902 connected by crosslinks (903a, 903b), as shown in FIG. 9B. As, shown in FIG. 9C, when this short-chain crosslink-dominant polymer is stretched, tension is distributed over a chain's short length and to a few other chains through two crosslinks before the chain breaks. When a single covalent bond breaks, the energy stored in these few short chains dissipates, resulting in a low toughness.

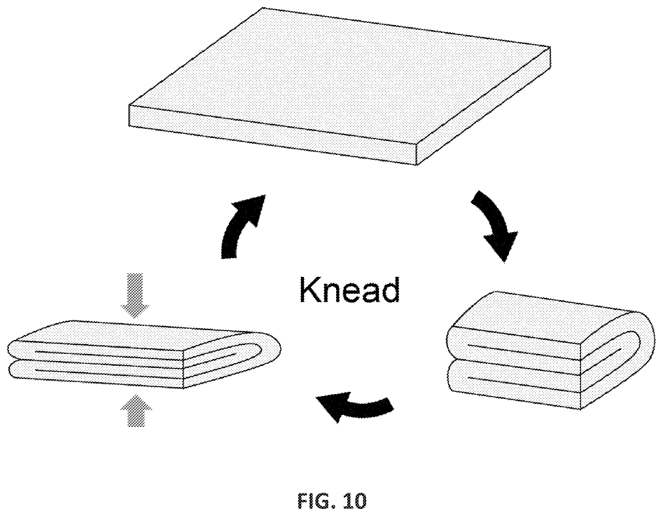

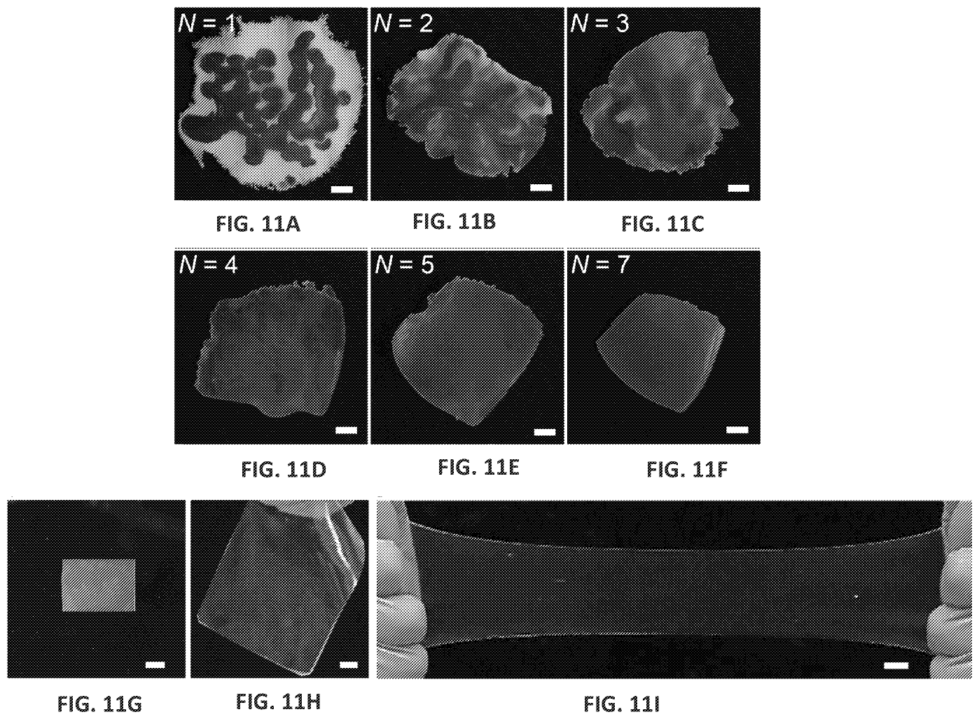

In some embodiments, to form an entangled polymer composition from a dough, long polymer chains with high molecular weight are mixed with a solvent and crosslinker. In some embodiments, resulting mixture is an inhomogeneous and opaque dough. In some embodiments, the dough is homogenized by kneading, as shown in FIG. 10, a process which includes folding the dough twice. FIGS. 11A-11F show an exemplary dough after 1, 2, 3, 4, 5, and 7 cycles of kneading (N=1, 2, 3, 4, 5, 7). In other embodiments, 6, 8, 9, 10, 15, or 20 cycles of kneading are used. In this example, the dough is homogeneous after about 7 cycles of kneading. In some embodiments, the dough is then annealed at an elevated temperature to relax polymer chains. In some embodiment, to homogenize a dough without degradation and scission, kneading operates in a window of temperature, time, and rate of deformation, and annealing operates in a window of temperature and time. Mixing the powder with a small amount of water lowers viscosity and eases homogenization. FIG. 11G shows the dough after crosslinking, and FIG. 11H shows the gel after swelling in a solvent until equilibrium to form a gel. As shown in FIG. 11I, the resulting dough is transparent, elastic, stretchable, and tough.

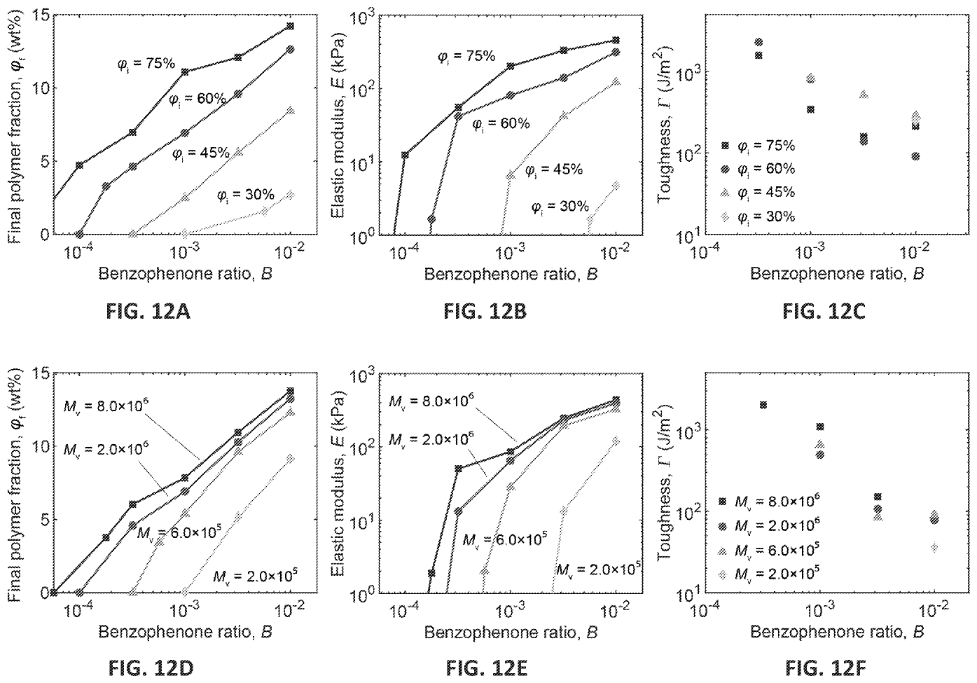

In some embodiments, the properties of entangled polymer compositions made from doughs depend on various synthesis parameters, including the initial polymer fraction φᵢ (the mass ratio of polymer to the dough), the crosslink fraction B (the molar ratio of crosslinker to monomer unit of the polymer), and molecular weight of the polymer Mᵥ. In the examples shown in FIGS. 12A-12F, each dough is homogenized and crosslinked, and then submerged in a solvent to form an equilibrium gel. When B, φᵢ and Mᵥ are low, the dough dissolves in solvent. When B, φᵢ, and Mᵥ exceed critical conditions, the dough gels and swells to equilibrium. In either case, of is the final mass fraction of polymer in the equilibrated sample. FIG. 12A shows final polymer fraction of for samples made of an exemplary entangled hydrogel (PEG) of molecular weight Mᵥ=8×10⁶ and various values of B and φᵢ. At fixed values of φᵢ and Mᵥ, a critical value of B exists, below which the dough dissolves, so that φ_{f} is low, set by the mass ratio of the polymers and solvent in the container. The critical B decreases as φᵢ increases. Above the critical value of B, the dough swells to an equilibrium hydrogel. At any B, the higher polymer fraction in the dough, φᵢ, the higher polymer fraction in the equilibrium hydrogel, of. These observations confirm the molecular interpretation that the entanglements and the crosslinks together maintain the topology of the polymers in a hydrogel. In some embodiments, the higher the initial polymer fraction φᵢ, the more crowded the polymers in a dough, and the denser the entanglements.

This molecular interpretation is corroborated by elastic modulus E of the equilibrium hydrogels plotted as a function of B and φᵢ at Mᵥ=8×10⁶, shown in FIG. 12B. At B=1×10⁻³, the hydrogel made of a dough of φᵢ=75% has a modulus E about 31 times higher than the hydrogel made of a dough of φᵢ=45%, and the hydrogel made of a dough of φᵢ=30% has negligible modulus. FIG. 12C shows toughness Γ of equilibrium hydrogel as a function of B and φᵢ at Mᵥ=8×10⁶. As B decreases, the crosslink density decreases, and the toughness increases. This trend is consistent with the prediction of the Lake-Thomas model. When φᵢ=60%, the critical value of B is 3.2×10⁻⁴, and a low crosslink density gives a high toughness of 2,200 J/m². When φᵢ=30%, the critical value of Bis 1×10⁻², and a high crosslink density gives a toughness of only 250 J/m². Without water, the long-chain polymers have high viscosity even at elevated temperatures, so that kneading cannot homogenize the dough, but will break the chains.

FIGS. 12D-12F show exemplary equilibrium hydrogels made from doughs of PEG chains of various molecular weights, crosslinked using various amounts of crosslinker. All these doughs are prepared at the same initial polymer fraction in the dough, φᵢ=65%. As shown in FIG. 12D, at fixed values of φᵢ and Mᵥ, a critical value of B exists, below which the dough dissolves in water, so that φ_{f} is low. The critical B decreases as Mᵥ increases. Also, at any B, a higher Mᵥ gives a higher φ_{f}. These observations indicate that, in some embodiments, a dough made of polymers of a higher molecular weight has denser entanglements. This molecular interpretation is corroborated in elastic modulus, as shown in FIG. 12E. For example, at B=3.2×10⁻⁴, the moduli of the hydrogels made from polymers of Mᵥ>6×10⁵ are on the order of 10 kPa, whereas the moduli of the hydrogels made from polymers of Mᵥ<2×10⁵ are vanishingly low. FIG. 12F shows toughness of equilibrium hydrogels. The toughness is not sensitive to Mᵥ, but the high value of Mᵥ enables polymers to have low values of B and high toughness. This observation is consistent with the Lake-Thomas prediction that the toughness depends on the polymer chain length between crosslinks.

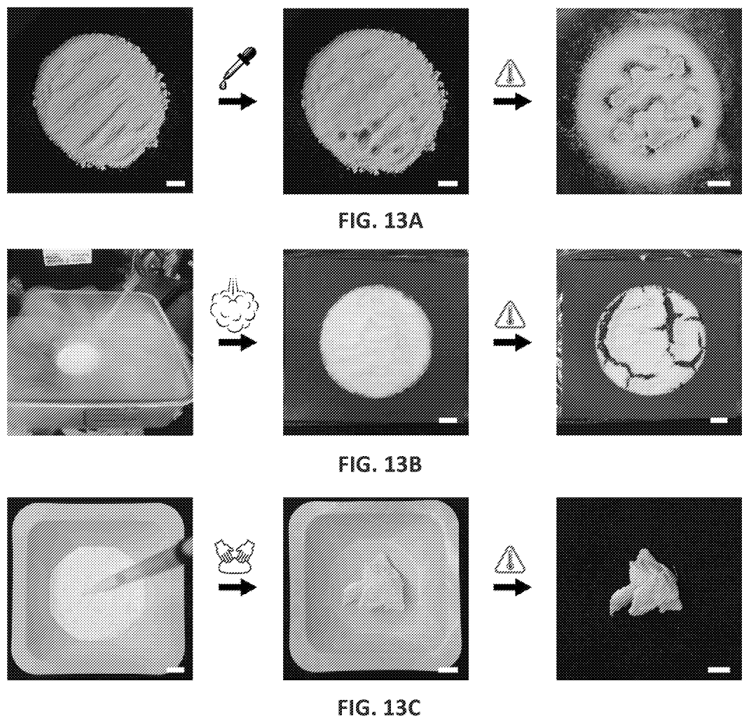

FIGS. 13A-13C show three exemplary methods for forming a dough using a small amount of water. In the first method, shown in FIG. 13A, a drop of water is added to a powder of long chain polymers and the mixture is heated, resulting in an inhomogeneous mixture. In the second method, shown in FIG. 13B, a humidifier is used to apply a mixture of small droplet of water (liquid state of water) and humid air (gas state of water) to dispense water more evenly and the mixture is heated, which results in an inhomogeneous mixture. In the third method, shown in FIG. 13C, the water is added as in the first method, the mixture is kneaded to form a dough, and the mixture is heated, resulting in an inhomogeneous mixture.

In some embodiments, the polymers used to form an entangled polymer composition from a dough are synthetic polymers. Non-limiting exemplary synthetic polymers include poly(ethylene glycol), poly(vinyl pyrrolidone), poly(vinyl alcohol), poly(2-hydroxyethyl methacrylate), poly(N-isopropyl acrylamide), silicone rubbers, nitrile rubbers, poly(methyl methacrylate), polymethacrylate, poly(ethyl acrylate), poly(acrylamide), poly(ethyl methacrylate), poly(propyl acrylate), poly(propyl methacrylate), poly(butyl acrylate), poly(acrylic acid), poly(methacrylic acid), poly(butyl methacrylate), ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), polyacrylonitrile, polyisobutylene, poly(isobutylene-co-isoprene), poly(tetrafluoro ethylene), poly(tetrafluoroethylene), poly(perfluoromethylvinylether), poly(styrene-co-butadiene), polyurethane, polyisoprene, polychloroprene, polybutadiene, polysulfide, polynorbornene, polysiloxane, polyethylene, polypropylene, poly(vinyl acetate), and a combination thereof. In some embodiments, the polymers used to form an entangled polymer composition from a dough are natural polymers. Non-limiting exemplary natural polymers include cellulose, alginate, chitosan, hyaluronic acid, collagen, gelatin, starch, chitin, agarose, dextran, konjac glucomannan, pullulan, guar gum, polynucleotide, polyisoprene, polyamide, and a combination thereof.

In some embodiments, the polymers used to form an entangled polymer composition from a dough have a molecular weight of at least about 5×10⁵, 10⁶, 5×10⁶ g/mol, or any range bounded by any two values disclosed herein.

Non-limiting exemplary crosslinkers include benzophenone, glycidyl methacrylate, glyoxal, oxidized dextrin, epichlorohydrin, adipic acid dihydrazide, endogen polyamine spermidine, ethylene glycol dimethacrylate, butanediol-diglycidyl ether, citric acid, glutaraldehyde, divinyl sulfone, sulfur, and any combination thereof. Crosslinks can be formed by application of heat, UV light, visible light, gamma rays, catalysts, and any combination thereof.

In some embodiments, the mixture (e.g., a dough) is formed using polymer chains and a small amount of solvent. In some embodiments, using a small amount of solvent leads to crowding and entanglement of the polymer chains. In some embodiments, the initial polymer fraction φᵢ in the mixture is at least about 45%, 50%, 55%, 60%, 65%, 70%, 75%, 80%, 85%, 90%, 95%, 96%, 97%, 98%, or 99% by mass, or any range bounded by any two values disclosed herein. In some embodiments, the initial polymer fraction in the mixture is at least about 45% by mass. In some embodiments, the initial polymer fraction in the mixture is least about 60% by mass. In some embodiments, the initial polymer fraction in the mixture is between about 60% and about 75% by mass. In some embodiments, the solvent fraction in the mixture is less than about 55%, 50%, 45%, 40%, 35%, 30%, 25%, 20%, 15%, 10%, or 5%, 4%, 3%, 2%, or 1% by mass. In some embodiments, the solvent fraction in the mixture is less than about 55% by mass. In some embodiments, the solvent fraction in the mixture is less than about 40% by mass. In some embodiments, the solvent fraction in the mixture is between about 25% and about 40% by mass.

In some embodiments, the dough used to form entangled polymer compositions includes long chained polymers. By including long chained polymers, entangled polymer compositions can transmit tension along the lengths of those polymer chains, contributing to high toughness and low hysteresis. In some embodiments, the molecular weight of the polymer chains in the dough is at least about 5×10⁵ g/mol, at least about 106 g/mol, or at least about 5×10⁶ g/mol, or any range bounded by any two values disclosed herein.

In some embodiments the dough is kneaded for between about 3 and 10 cycles, for example 3, 4, 5, 6, 7, 8, 9,10, 15, or 20 cycles, or in any range bounded by any two values disclosed herein. In some embodiments, the dough is kneaded at an elevated temperature. In some embodiments, the dough is kneaded at a temperature of at least about 40° C. In some embodiments, the dough is kneaded at a temperature of at least about 60° C. In some embodiments, the dough is kneaded at a temperature of at least about 40° C., 50° C., 60° C., 70° C., 80° C., 90° C., 100° C., 110° C., 120° C. or at any range bounded by any two values disclosed herein. In some embodiments, the kneading temperature is increased if the kneading time is short. In some embodiments, the dough is kneaded at a stretch rate of less than about 1×10⁻² s⁻¹.

In some embodiments, the dough is annealed at an elevated temperature after crosslinking. In some embodiments, the dough is annealed at a temperature of at least about 50° C., 60° C., 65° C., 70° C., 75° C., 80° C., 85° C., 90° C., or 95° C., 100° C., 110° C., 120° C. or at any range bounded by any two values disclosed herein. In some embodiments, the dough is annealed at between about 65° C. and about 95° C., for example 65° C., 80° C., or 95° C. In some embodiments, the dough is annealed at 65-70° C., 70-75° C., 75-80° C., 80-85° C., 85-90° C., or 90-95° C., or at any range bounded by any two values disclosed herein. In some embodiments, the dough is annealed for at least about 3, 6, 9, 12, or 15 hours, or for any range bounded by any two values disclosed herein. In some embodiments, the dough is annealed for between about 3 hours and about 15 hours, for example, 3-6 hours, 6-9 hours, 9-12 hours, or 12-15 hours. In some embodiments, the annealing time depends on the annealing temperature. In some embodiments, the annealing time and temperature are limited to avoid degradation of the polymer.

In some embodiments, the dough becomes annealed during the kneading process. In these embodiments, dough need not be annealed for a specific time or at a specific temperature after kneading.

In some embodiments, the dough is swollen with a solvent after crosslinking to form a gel. Non-limiting exemplary solvents include water, ethylene glycol, glycerol, ethyl alcohol, isopropyl alcohol, tetrahydrofuran, silicone oils, dimethyl sulfoxide, dimethylformamide, and combinations thereof.

### Examples

Certain embodiments will now be described in the following non-limiting examples.

### I. Entangled Hydrogels

### A. Synthesis of Entangled Hydrogels Using Monomers

Acrylamide (AAm, A8887), N,N′-methylenebisacrylamide (MBAA, M7279), and 2-Hydroxy-4′-(2-hydroxyethoxy)-2-methylpropiophenone (Irgacure 2959, 410896) were used as a monomer, crosslinker, and photo-initiator. They were purchased from Sigma Aldrich and used as received. Deionized water was used as a solvent and purchased from Poland Spring. 30 g of acrylamide and 15 mL of water were mixed to make a monomer solution. 0.1 M of crosslinker solution was prepared with water. 0.1 M of initiator solution was prepared with ethanol. The solutions of monomer, crosslinker, and initiator were mixed with additional water in a conical tube to make a precursor of specific values of W, C, and I. For high C, the crosslinker and the initiator were mixed without diluting. The mixture was vortexed for 5 seconds. To remove dissolved gas, the precursor was sonicated under 30° C. for 3 minutes. Molds were made of polytetrafluoroethylene (PTFE) sheets (8569K47), acrylic sheets (8560k355), and glass plates (8476K15) as a spacer, substrate, and cover, respectively. Molds were cut by using a laser cutter (Helix 75W, Epilog Laser). All engineering materials were purchased from McMaster-Carr. The spacer was put on the substrate without adhesives. The precursor was poured onto the mold and sealed with the cover. The substrate and the cover were tightly fixed by binder clips. UV light (8 ea, Sankyo Denki, F8T5BL) was irradiated for 3 hours with an intensity of 1.5 mW/cm². After curing, the sample was weighed and submerged in water for more than 1 day to swell to equilibrium. The fully swollen sample was weighed again to measure the swelling ratio, R. The thickness of the fully swollen sample was calculated by multiplying R^{1/3} to the as-synthesized thickness. The polymer content φ was calculated by R⁻¹(1+WM_{Water}M_{AAm}⁻¹)⁻¹, where M is the molecular weight. For the samples shown in FIGS. 1F, 1G, the fully swollen samples were cut into a circle with a diameter of 30 mm.

### B. Mechanical Testing of Entangled Hydrogels

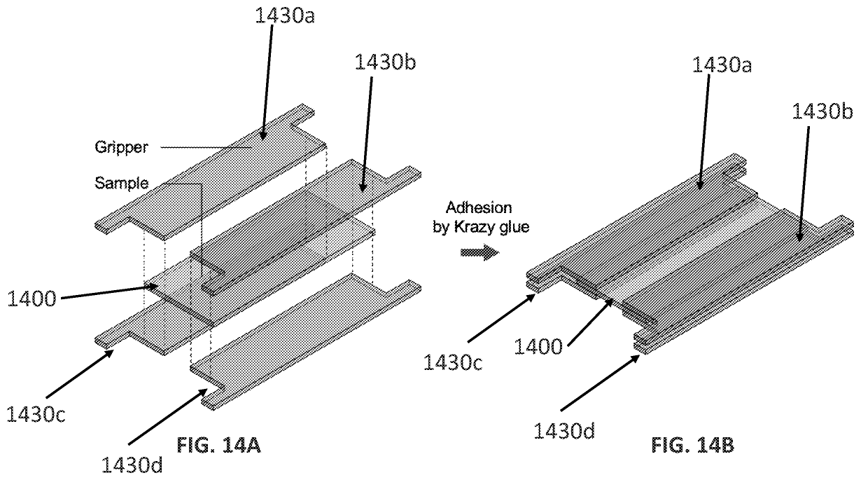

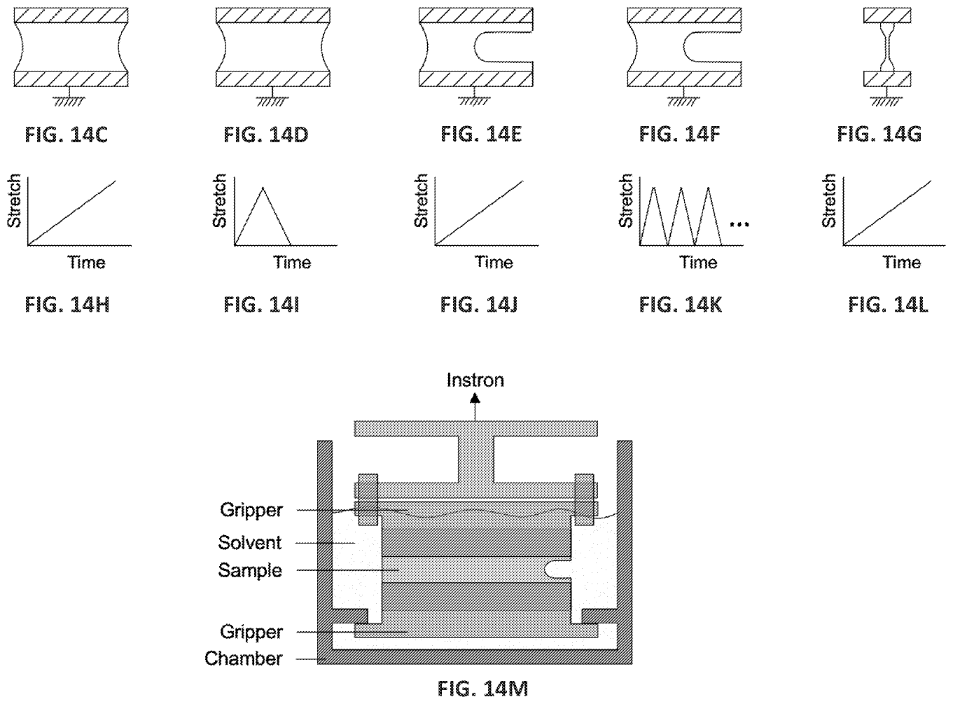

FIG. 14A-14M show schematics of setups for mechanical testing. FIG. 14A shows grippers 1430a, 1430b, 1430c, 1430d aligned with a hydrogel sample 1400. The grippers for mechanical testing of hydrogels were made of acrylic sheets (8560K172). A sample of hydrogel 1400 was cut into a rectangular shape with 8.9 cm×1.27 cm, glued with the grippers 1430a, 1430b, 1430c, 1430d using Krazy glue (FIG. 14B), and loaded to the Instron 5966. To get the elastic energy density function w(λ), the intact sample was monotonically stretched, and the stretch and stress were recorded. FIG. 14C shows a sample for monotonic stretching, while FIG. 14H shows a loading curve for monotonic stretching. Hysteresis was measured using a sample as shown in FIG. 14D and stretching and releasing shown in FIG. 14I. Then, a notch was made at the edge of the sample, as shown in FIG. 14E, and it was monotonically stretched, as shown in FIG. 14J, to measure the maximum stretch λₘₐₓ. The toughness was calculated by w(λₘₐₓ)H, where H is the height of the sample. The stiffness was measured from the initial slope of the stress-stretch curve (E=3/4×ds/dλ). The loading rate was 0.0016 s⁻¹ when stiffness, hysteresis, and toughness were measured. For the fatigue test, the fully swollen highly entangled hydrogel (W=2.0 and C=1.0×10⁻⁵) was put into a water chamber. The water chamber, shown in FIG. 14M, was made of acrylic sheets (8560K257) and then assembled using chloroform. After measuring w(λ), a cut was introduced using a blade to create a notched sample, as shown in FIG. 14F. Cyclic stretch of fixed amplitude was then applied, as shown in FIG. 14K. The amplitude of the stretch corresponds to an amplitude of the energy release rate. ˜300 cycles were applied ahead of the measurement to form a consistent crack tip. The crack advance was measured by an optical microscope after additional 10,000 cycles, and divided by the number of cycles to get the crack advance per cycle dc/dN, assuming that c linearly increases in N. The loading rate was ˜0.5 Hz. The strength was measured under uniaxial tension. The fully swollen hydrogel was cut into a dumbbell shape (ISO 37-3), shown in FIG. 14G, and two points of the linear region were marked by a pen. The time and force were measured by the Instron during the monotonic stretch, as shown in FIG. 14L, and the displacement of each mark was tracked simultaneously by recording a movie, to get the stretch of the linear region. The loading rate was ˜0.025 s⁻¹. FIGS. 2A-2H show the mechanical properties of acrylamide hydrogels.

FIG. 2A shows the equilibrium value of the polymer-to-hydrogel mass ratio, φ, as a function of C and W. For a hydrogel made of precursor of W=2.0, in the absence of crosslinks, C=0, chains dissolve in water, so that φ is vanishingly small. If C is nonzero but low, the hydrogel does not dissolve, but is inelastic and squishy. At a critical value C˜1.0×10⁻⁵, φ rises steeply. Aided by the dense entanglements, the critical C is low compared to values commonly used in making hydrogels. As C increases beyond the critical value, φ plateaus and is maintained by entanglements. The plateau lasts until C˜10⁻³, beyond which p increases gradually with C, indicating that crosslinks are dense enough to prevail over entanglements. The plateau narrows as W increases and disappears when W exceeds about 5. For the same value of C, a precursor of a smaller W leads to a hydrogel of higher φ. The lower value of W, the denser entanglements, and the lower critical C.

FIG. 2B shows a similar plateau also observed in stiffness. Such a plateau signifies the existence of entanglements and is used to estimate the density of entanglements. The stiffness of the hydrogel of C=1.0×10⁻⁵ is similar to that of C=1.0×10⁻³. Assuming that all crosslinkers in a precursor are incorporated into the polymer, each crosslinker is an end of four chains, and each chain has two ends, the average number of monomers per chain is (2C)⁻¹. For the hydrogel of C=1.0×10⁻⁵, on average each chain has 1/(2C)=10⁵/2 monomers, but the measured stiffness indicates that the entanglements effectively shorten each chain to 10³/2 monomers. That is, each chain has entanglements equivalent to 10² crosslinks.

FIG. 2C shows that, under cyclic stretch to various amplitudes and a fixed rate, the hysteresis is negligible. The ratio of the dissipated energy (i.e., area between the load and unload curves) to the applied work (i.e., the area under the load curve) is less than 1%. Furthermore, as shown in FIG. 2D the stress-stretch curves are insensitive to the stretch rate over two orders of magnitude (from 0.8 s⁻¹ to 0.008 s⁻¹), indicating that elastic response is insensitive to stretch rate.

As shown in FIG. 2E, highly entangled hydrogels exhibit high toughness. For hydrogels made from precursors of low C and W, crosslinks are sparse, and entanglements are dense, and toughness scales as Γ˜C^{-1/2}, consistent with the prediction of the Lake-Thomas model. The highly entangled hydrogels exhibited a toughness of 1,460 J/m². At small values of W, φ ranges from 8% to 16%. This modest change in φ is consistent with the observed weak dependence of toughness on W. For hydrogels made from precursors of high C and W, however, the crosslinks are dense, and the entanglements are sparse, and toughness falls substantially below the relation Γ˜C^{-1/2}. The toughness observed here, 1-10 J/m², is consistent with values reported in the literature for polyacrylamide hydrogels.

As shown in FIG. 2F, the entangled hydrogels do not suffer from the stiffness-toughness conflict. In the highly entangled hydrogels (W=2.0), the entanglements stiffen polymers and do not embrittle them. In contrast, crosslink-dominant hydrogels have either high stiffness or high toughness but not both.

Entanglements also markedly strengthen polymers, as illustrated in FIG. 2G by comparing a highly entangled hydrogel with two types of crosslink-dominant hydrogels. The strength is 390 kPa for a highly entangled hydrogel (W=2.0 and C=1.0×10⁻⁵), 23 kPa for a hard crosslink-dominant hydrogel (W=25 and C=1.0×10⁻²), and 31 kPa for a soft crosslink-dominant hydrogel (W=25 and C=3.2×10⁻⁴). The highly entangled hydrogel ruptures at a larger stretch than the hard crosslink-dominant hydrogel because the latter has short chains. The highly entangled hydrogel ruptures at a smaller stretch than the soft crosslink-dominant hydrogel because the latter has less entanglement density. The area under each stress-stretch curve defines the work of fracture, giving 611 KJ/m3, 6.3 KJ/m3, and 82 KJ/m3 for the highly entangled hydrogel, hard crosslink-dominant hydrogel, and soft crosslink-dominant hydrogel, respectively. For a given material, the ratio of the toughness over the work of fracture defines the fractocohesive length. The three hydrogels have fractocohesive lengths of about a few millimeters, large compared to flaws, so that the tensile strengths are flaw-insensitive.

FIG. 2H shows the crack extension per cycle in a highly entangled hydrogel at various amplitudes of energy release rate. A linear regression of data estimates the fatigue threshold ˜200 J/m². This value is about four times that of natural rubber and about 20 times that of a crosslink-dominant hydrogel.

### C. Friction Coefficient and Wear Rate Measurement of Entangled Hydrogels

The friction coefficient was measured by a rheometer (ARES-G2, TA Instrument), shown in the inset of FIG. 4A. The diameter of the top stage D was 25 mm. The samples (entangled hydrogel, crosslink-dominant hydrogel, and Teflon) were cut into 4 cm×4 cm and glued to the bottom stage. An axial force P of ˜10 N was applied, and the torque T was measured over time under 1 rad/s. The friction coefficient was calculated by 8T/3DP. The samples were submerged in water during the experiment. As shown in FIG. 4A, the friction coefficient of the highly entangled acrylamide hydrogel is 0.0067, about three times lower than that of the crosslink-dominant hydrogel and six times lower than that of Teflon. The crosslink-dominant hydrogel ruptures after three hours of slide in a rheometer (FIG. 4B), but the highly entangled hydrogel remains intact after six hours of sliding (FIG. 4C).

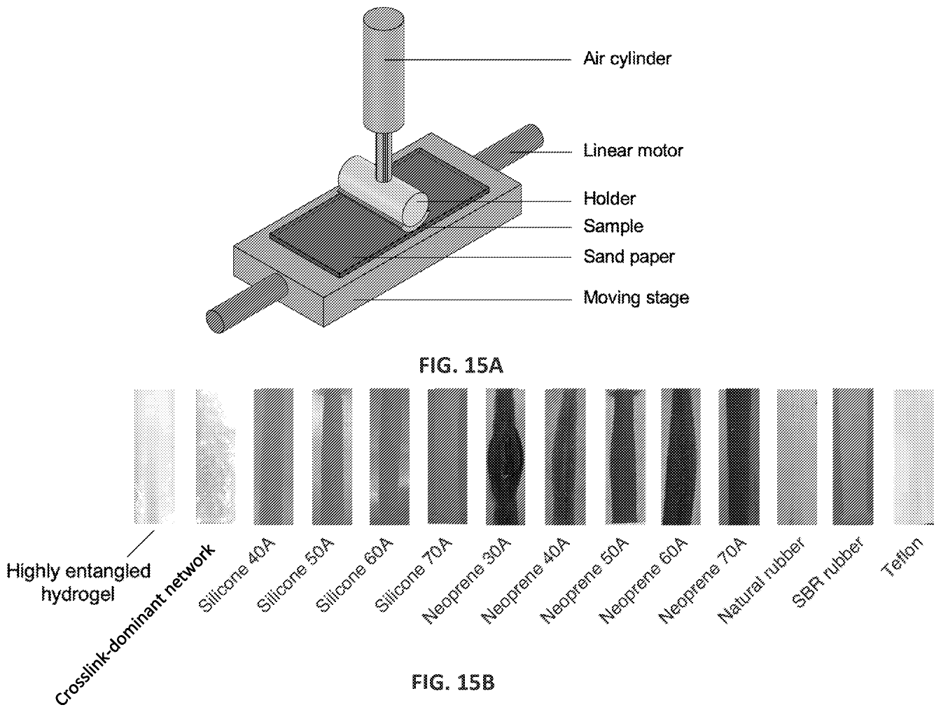

The wear rate was measured by a homemade setup, shown in the inset of FIG. 4D. Detailed setups are illustrated in FIG. 15A. Each 4-cm-wide sample was wrapped and fixed on the holder with screws. The holder was a 19-mm-diameter rod (85485K45). The holder was installed on the air cylinder (6498K143) to press the material to the sanding paper of 80 grit (4673A73). The air pressure of 20 psi was applied, which consistently applies 36 N to the material. The sample was worn by moving the sanding paper back and forth with a velocity of 5 mm/s. The material was weighed every 10 cycles and repeated 10 times. The sandpaper was replaced for each sample. All rubbers and the Teflon were purchased from McMaster-Carr (1460N12, 1370N13, 8716K151, 9454K42, 8633K52, 8569K27, 5787T31). The following samples were tested for wear rate: entangled hydrogel, crosslink-dominant hydrogel, silicone 40A, silicone 50A, silicone 60A, silicone 70A, neoprene 30A, neoprene 40A, neoprene 50A, neoprene 60A, neoprene 70A, natural rubber, styrene butadiene rubber, and Teflon. As shown in FIG. 4D, the highly entangled hydrogel has a lower wear rate than Teflon and most polymers tested. FIG. 15B shows the surfaces of each material after 100 cycles.

D. Synthesis of Highly Entangled Hydrogels at W Values Lower than 2

The value W=2.0 is the lowest allowed by the solubility of acrylamide in water of 30° C. The melting temperature of pure acrylamide is 84° C., and the glass transition temperature of dry polyacrylamide is 165° C. The extreme condition of W=0 was attempted by putting pure acrylamide into a tube and placing it in thermal contact with boiling water (100° C.). The acrylamide polymerizes without an initiator, and the product is glassy and inhomogeneous. Precursors of W=1.15 and various values of C were also attempted. After synthesis and swell in water to equilibrium, the hydrogels are squishy and translucent. At C=1×10⁻⁵, φ is about four times lower than that of W=2.0. The glassy phase during synthesis may have retarded polymerization.

### E. Properties of Entangled Hydrogels as a Function of Synthesis Parameters

Let W, C, and I be the molar ratios of solvent, crosslinker, and initiator to monomer. After synthesis, each polyacrylamide hydrogel was submerged in water to swell to equilibrium and then characterized by various tests. FIGS. 5A-5C show φ, E, and Γ as functions of W. I is fixed at 8.0×10⁻⁶ and C is fixed at 1.0×10⁻⁵, 1.0×10⁻⁴, and 1.0×10⁻³, which gives I/C=0.8, 0.08, and 0.008. When I/C is too high (I/C=0.8), too many polymer chains are initiated, which forms a hydrogel of many dangling chains, and causes low values of φ, E, and Γ with enormous swelling. Hydrogels made with precursors of the low values of I/C of 0.08 and 0.008 show almost the same trends as those made with precursors of I/C=0.4. FIGS. 5D-5F show φ, E, and Γ as functions of C with different values of I at W=2.0. At any I, φ and E drop when I/C is higher than ˜0.5, leading to inelastic solids with enormous swelling. Toughness is less sensitive to I, but high I/C lowers the minimum C required to obtain a well-formed network, suggesting that the toughness is limited by I. For example, the maximum toughness is ˜2,000 J/m² at I=4.0×10⁻⁶ but is ˜800 J/m² at I=8.0×10⁻⁵.

### F. Swelling of Entangled Hydrogels

Swelling of an entangled acrylamide hydrogel was observed over time. After synthesis, the hydrogel was submerged in water and weighed at various times. The swelling ratio over time is shown in FIG. 6. After 20 hours, the entangled hydrogel was swollen to equilibrium. The observed time to equilibrium is understood in terms of diffusion of the water in a polymer of a given thickness. Estimate the time to equilibrium by τ˜L²/D, where L is the thickness (1.3 mm) and D is the diffusivity of water (10⁻⁹ m² s), giving τ˜0.5 hours.

The effect of crosslink fraction on swelling ratio was investigated. Each hydrogel was synthesized using a precursor of specific values of W and C. The as-synthesized polyacrylamide hydrogel was submerged in water to swell to equilibrium. The swelling ratio was measured as the ratio of the mass of the fully swollen hydrogel to that of the as-synthesized hydrogel. FIG. 7 shows the swelling ratio as a function of crosslink fraction C at different water fractions W. At W=2.0, the hydrogel is not well-formed and swells enormously when C=3.2×10⁻⁶. The swelling ratio reduces greatly at a critical value C=1.0×10⁻⁵. When C exceeds this critical value, the swelling ratio plateaus. The swelling ratio reduces further when C>1.0×10⁻³. As W increases, the plateau narrows and disappears when W˜5. The plateau reflects the effect of entanglements. At the plateau, the swelling ratio is insensitive to both C and W. At a high value of C, e.g., C=1.0×10⁻², the effect of entanglements on swelling is negligible, so that the swelling ratio increases as W decreases.

G. Hysteresis of as-Prepared Entangled Hydrogels

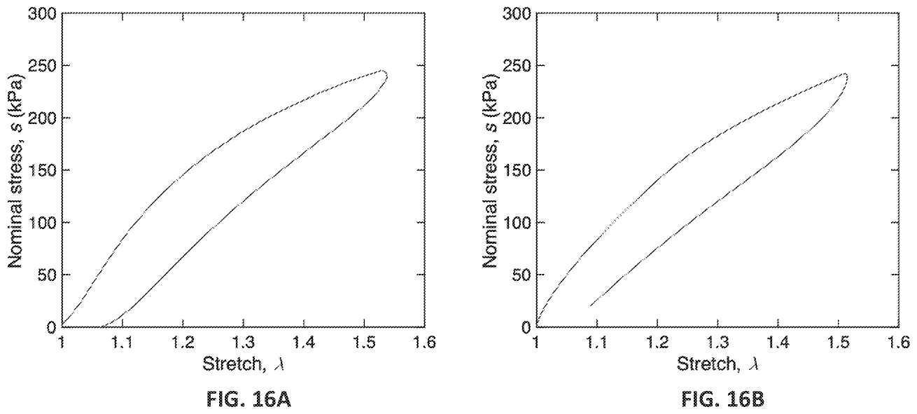

FIGS. 16A-16B show as-prepared entangled acrylamide hydrogels with hysteresis, before swelling with solvent. FIG. 16A shows the stress-stretch curve of as-prepared hydrogels of W=2.0 and C=0. FIG. 16B shows the stress-stretch curve of as-prepared hydrogels of W=2.0 and C=1×10⁻⁵. The stretch rate is 0.25 s⁻¹ in both cases. When the as-prepared hydrogels are submerged in water, the hydrogel of C=0 (FIG. 16A) swells excessively and eventually dissolves in water, whereas the hydrogel of C=1×10⁻⁵ (FIG. 16B) swells to equilibrium and has near-zero hysteresis, as shown in FIG. 2C, showing that swelling with a solvent reduces hysteresis.

### H. Rheological Properties of Entangled Hydrogels

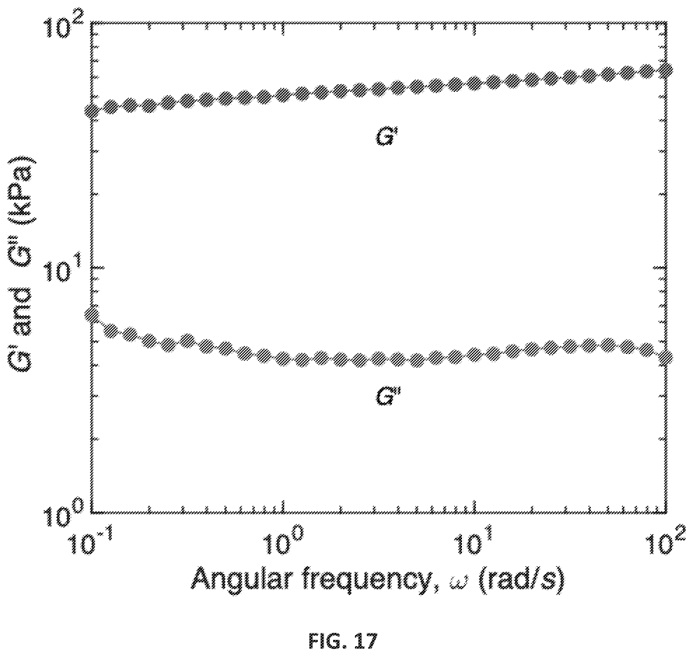

The storage and loss modulus of entangled polyacrylamide hydrogels were measured by a rheometer (ARES-G2, TA Instrument). The diameter of the top stage was 25 mm. The thickness of the fully swollen highly entangled hydrogel was 1.3 mm. The hydrogel was cut into a circle with the diameter of 25 mm. The bottom surface was glued onto the rheometer, and the top surface was not. An axial force of ˜1 N was applied, and the storage and loss modulus were measured as a function of frequency. The materials were submerged in water during the experiment. FIG. 17 shows the storage modulus (G′) and loss modulus (G″) of a highly entangled hydrogel (W=2.0 and C=1.0×10⁻⁵) as functions of frequency. The fact that G″ is lower than G′ corroborates that the hydrogel is elastic. In addition, this elastic behavior does not change over a wide range of frequency. These results are consistent with the rate-independent stress-stretch curves and negligible hysteresis.

### A. Comparison Between an Entangled Hydrogel and a Double-Network Hydrogel

A highly entangled hydrogel made of polyacrylamide and a double-network hydrogel made of polyacrylamide and alginate were prepared. The highly entangled hydrogel was prepared as described above. The double-network hydrogel was made of acrylamide and alginate (FMC Corporation). The water content was 86% by weight and the weight ratio between acrylamide and alginate was 3:1. The amount of the covalent crosslinker, N,N′-Methylenebisacrylamide (MBAA), was 0.003% of acrylamide (AAm) by weight, and the amount of the physical crosslinker, CaSO₄ (Sigma-Aldrich, C3771), was 0.13% of alginate by weight. 1.5 μL of the 0.1 M initiator solution was added per 1 mL of the precursor. After mixing, the precursor was cured with the same procedure used for highly entangled hydrogels. The double-network hydrogel was used without swelling.

In the double-network hydrogel, one network has pre-stretched short chains, and the other has stretchable long chains. When such a double-network is subjected to a small stretch, both networks do not break, and the short-chain network stiffens the material. With increasing stretch, the short-chain network will break at isolated spots (e.g., sacrificial bonds), while the long-chain network transmits stress and elicits many other short chains to break. The distributed scission toughens the material, but, as discussed below, also causes pronounced hysteresis and inelasticity.

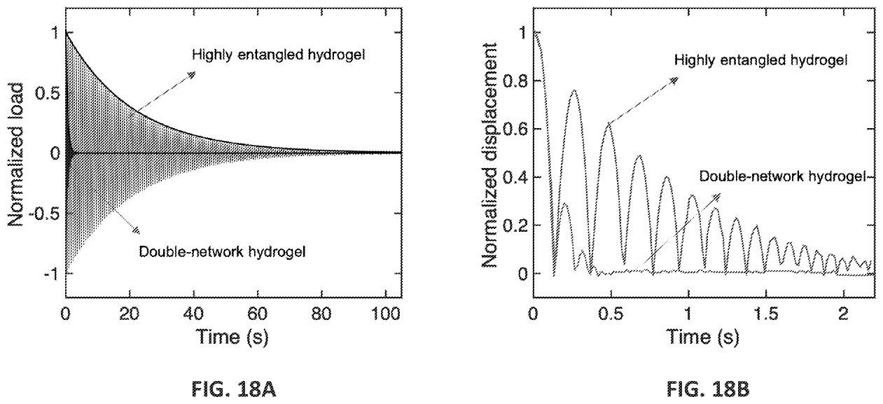

The highly entangled hydrogel and the double-network hydrogel of the similar polymer content of ˜15% were loaded with a weight of 5 N and then plucked. The dimension of each hydrogel before loading is 53 mm×35 mm×1.3 mm. The load cell connected to the hydrogel measures the load in time. FIG. 18A shows the normalized load of the entangled hydrogel and the double-network hydrogel over time. The load F is normalized by (F-F₀)/ΔF, where F₀ is the load before plucking and ΔF is the load of plucking. The damping ratios ζ are measured by fitting the peaks with exp(−ζωt). The highly entangled hydrogel vibrates for ˜100 s with the natural frequency of 1.54 Hz and ζ of 0.0049, but the double-network hydrogel damps to rest immediately with the natural frequency of 6.13 Hz and ζ of 0.0473. ζ of the double-network hydrogel is one order of magnitude higher than ζ of the highly entangled hydrogel.

A metal ball was dropped onto the ˜4 mm-thick highly entangled hydrogel and the double-network hydrogel. FIG. 18B shows the displacement of the entangled hydrogel and the double-network hydrogel over time after the metal ball was dropped. The displacement of the metal ball was normalized by the initial displacement. The highly entangled hydrogel bounced the metal ball more than 17 times, while the double-network hydrogel bounced only 3 times.

### I. Effect of W and C on Stiffness-Toughness Plane of Hydrogels

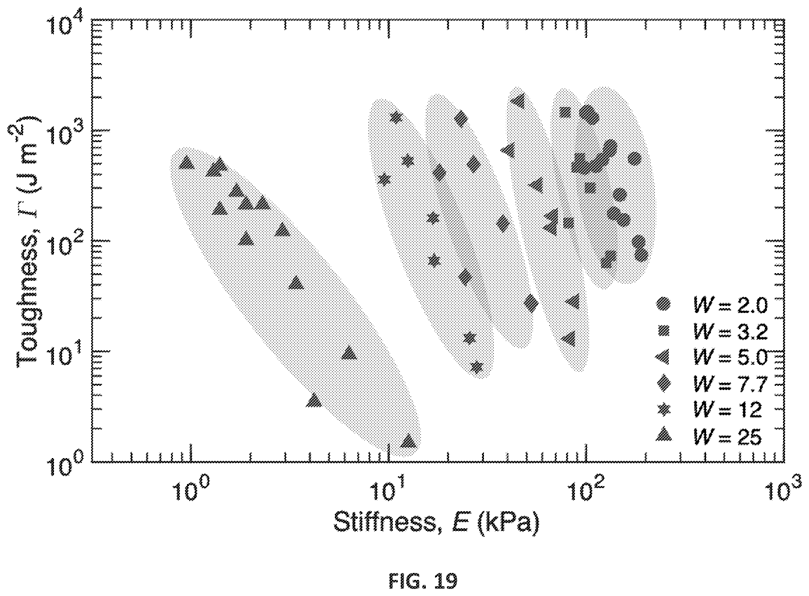

FIG. 19 shows the stiffness-toughness plane for polyacrylamide hydrogels prepared with precursors having various amounts of water (W) and crosslinker (C). For each value of W (2.0, 3.2, 5.0, 7.7. 12, and 25), several values of C are used, ranging from 1.0×10⁻⁵ to 3.2×10⁻². A W of 25 is similar to that used for crosslink-dominant hydrogels. After synthesis, the samples are submerged in water to swell to equilibrium, followed by the measurements of stiffness and toughness. As W becomes lower, the stiffness becomes higher and less sensitive to C. High stiffness and high toughness are simultaneously achieved when precursors have low values of W and C.

### J. Highly Entangled Polyacrylic Acid Hydrogel

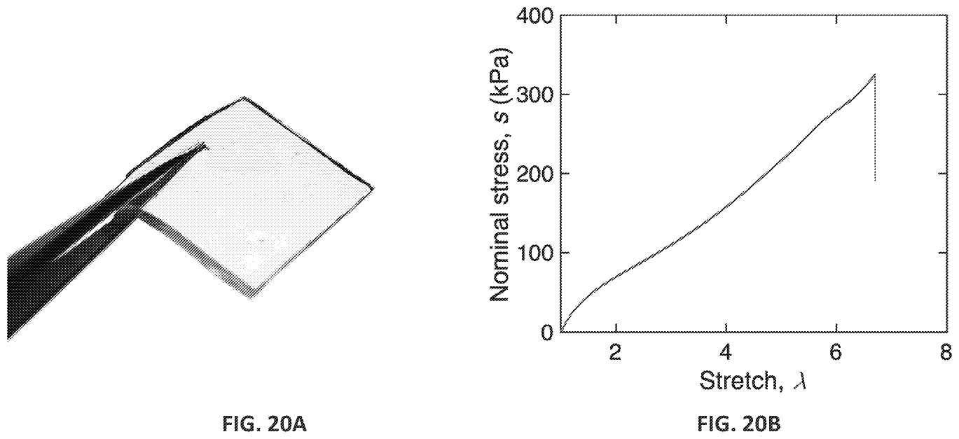

A polyacrylic acid hydrogel was synthesized with a precursor of W=2.0, C=1×10⁻⁵, and I/C=0.4, and submerged in pure water to swell to equilibrium. FIG. 20A shows the fully swollen hydrogel is homogeneous and transparent in pH 7. FIG. 20B shows the stress-stretch curve under uniaxial tension. The polymer content is 14%, stiffness is 130 kPa, stretchability is 6.7, strength is 325 kPa, and toughness is 790 J/m², which are comparable to those of the highly entangled polyacrylamide hydrogel. The swelling is suppressed by the dense entanglements, even though the polyacrylic acid hydrogel is a polyelectrolyte, and polyacrylic acid hydrogels without entanglements swell excessively.

### II. Entangled Elastomers

### A. Synthesis of Entangled Elastomers

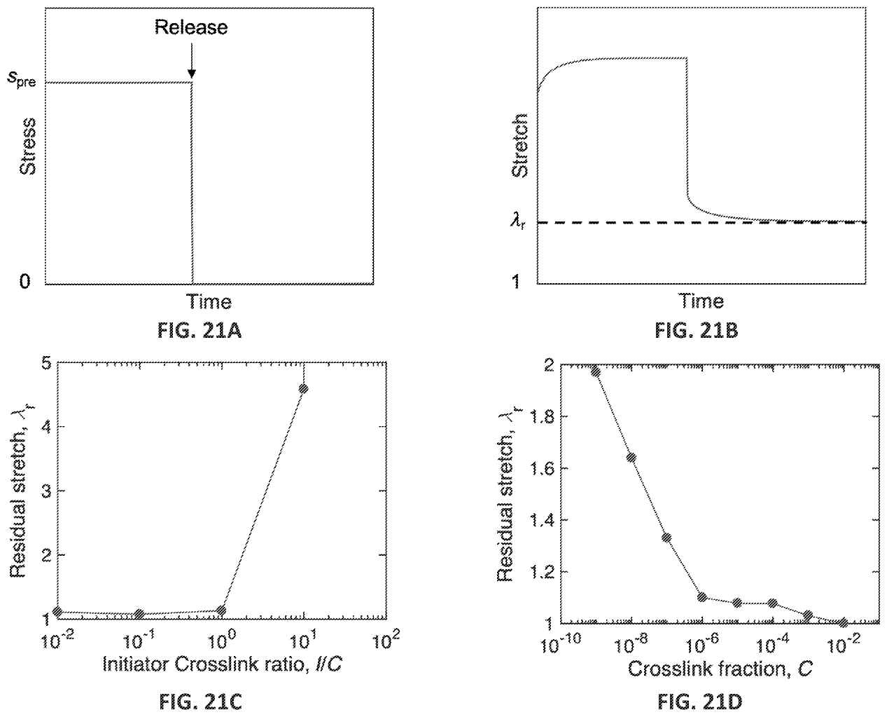

Ethyl acrylate (EA, E9706), Tricyclo[5.2.1.0^{2,6}]decanedimethanol diacrylate (TDDA, 496669), 2-Hydroxy-2-methylpropiophenone (Irgacure 1173, 405655), and N,N-Dimethylformamide (DMF, 227056) were used as a monomer, crosslinker, photo-initiator, and solvent. These materials were purchased from Sigma Aldrich and used as received. Photo-initiator (PI) and TDDA in were dissolved in DMF respectively, and made into solutions of 1% in weight for the convenience of further use. The highly entangled elastomers were synthesized by photopolymerization. The monomer, crosslinker solution, and initiator solution were mixed in a conical tube to make a precursor of specific values of W, C, and I. I/C was set to 0.1 for the experiments shown in FIGS. 3A-3F, and the results for other values of I/C in are presented in FIGS. 21A-21D. The mold was made of a silicone sheet (1460N11) as a spacer, and a glass plate (8476K15) as a substrate, respectively. The precursor was then poured onto the mold and sealed with another glass plate. The mold and the glass plate were fixed by binder clips. The mold was placed in a polyethylene press-to-close bag (Minigrip Redline, VWR) filled with nitrogen gas, and placed under an UV lamp (15 W 365 nm; UVP XX-15L, 7 cm distance between glass surface and lamp) for at least 12 hours. The obtained samples were placed in a hood for 24 hours to evaporate unreacted monomers and DMF before testing.

### B. Mechanical Testing of Entangled Elastomers

The grippers for mechanical testing of entangled elastomers were made of acrylic sheets (8560K172). A sample of elastomer was cut into a rectangular shape with 70 mm×40 mm. An adhesion promoter (Loctite 7701™) was first sprayed on both sides of the sample, and the solvent of the promoter was allowed to evaporate for three minutes. Then, the sample was glued with the grippers using an adhesive (Loctite 406™) and loaded to the Instron 5966. In the undeformed state, the stretchable part of each sample was 70 mm×10 mm. The thickness of the sample was 0.67 mm. In measuring stiffness, hysteresis, and toughness, the loading rate was ˜0.1 s⁻¹. In measuring the strength, the elastomer was cut into a dumbbell shape (ISO 37-2), and the loading rate was ˜0.1 s⁻¹. In measuring the fatigue threshold, the crack advance was measured after 20,000 cycles. FIGS. 3A-3F show the mechanical results of mechanical testing of an entangled poly(ethyl acrylate) elastomer.

FIG. 3A shows the stiffness of the entangled elastomer as a function of crosslink fraction C. As C increases beyond the critical value, stiffness first plateaus and then increases again after C˜10⁻³. The plateau confirms that these elastomers are highly entangled.

FIG. 3B shows the toughness of the entangled elastomer as a function of crosslink fraction C. The toughness reaches 2,200 J/m² at C=10⁻⁶. The high toughness is achieved even though the hysteresis is low, as shown in FIG. 3C.

FIG. 3D shows the stress-stretch of an entangled elastomer loaded in tension to failure. The highly entangled elastomer has a nominal strength of 3.2 MPa. This value corresponds to a true strength of 35 MPa, which is one order of magnitude higher than those of unfilled acrylic elastomers.

FIG. 3E shows the fatigue crack extension per cycle for entangled elastomers measured at various amplitudes of energy release rate. The highly entangled elastomer has a fatigue threshold of ˜240 J/m². As shown in FIG. 3F, this fatigue threshold is higher than that of other elastomers at the similar stiffness, including neoprene, polydimethylsiloxane (PDMS), phosphonitrilic fluoroelastomer (PNF), and polyurethane (PU).

### C. The Stress Relaxation and Recovery of a Highly Entangled Elastomer

FIGS. 21A-21D show the stress relation and recovery of an entangled poly(ethyl acrylate) elastomer. FIG. 21A shows a dead load of 360 kPa is applied for 48 hours and relaxed for 24 hours. FIG. 21B shows the schematic of the stretch as a function time. The residual stretch λᵣ was measured after the relaxation of 24 hours. The residual stretch was used as a measure of invariance of polymer topology after relaxation. FIG. 21C shows the residual stretch at different I/C values at C=10⁻⁵. When I/C exceeds 101, the sample creeps. When I/C is below 100, the residual stretch is small. FIG. 21D shows the residual stretch at various C at I/C=0.1. The residual stretch is low at high C and rapidly increases below C=10⁻⁶.

### D. Hysteresis of Highly Entangled Elastomers and Highly Entangled Organogels

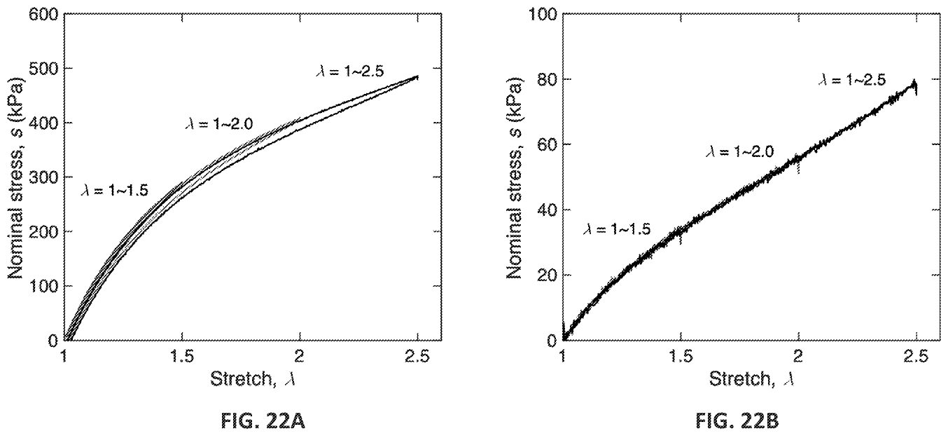

FIGS. 22A-22B show the stress-stretch curves of the highly entangled poly(ethyl acrylate) elastomer and highly entangled poly(ethyl acrylate) organogel under cyclic uniaxial tension with various stretches at the stretch rate of 0.025 s⁻¹. FIG. 22A shows the stress-stretch curve of the highly entangled elastomer, which has low hysteresis, about 5%. The low hysteresis can be further reduced by swelling the elastomer with an organic solvent. The entangled elastomer was submerged in an organic solvent, dimethylformamide (DMF), and swollen to equilibrium to form an organogel. The viscosity of DMF is 0.92 mPa s, which is slightly lower than that of water. Such an organogel has a polymer content of 9.8%. FIG. 22B shows the stress-stretch curve for the fully swollen organogel. The fully swollen organogel has lower hysteresis, less than 1%, than the highly entangled elastomer. These observations confirm that the interchain friction results in hysteresis and can be reduced with a solvent.

### E. Fatigue Resistance of a Highly Entangled Elastomer

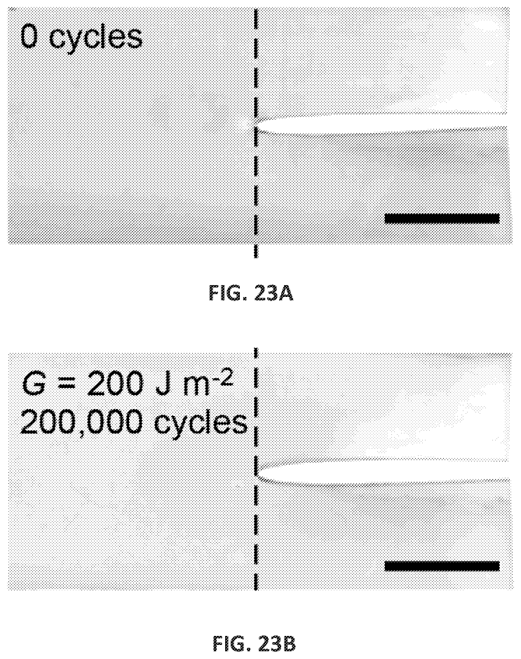

FIGS. 23A-23B show photographs of a highly entangled poly(ethyl acrylate) elastomer before (FIG. 23A) and after (FIG. 23B) 200,000 cycles at energy release rate G=200 J/m². The scale bar is 5 mm. The crack advance is not observed. The highly entangled elastomer is transparent and is painted blue to show the crack clearly.

### III. Entangled Hydrogels Formed from Dough

A. Synthesis of Entangled Hydrogels from Dough of Long-Chain PEG Polymers

Polyethylene glycol (PEG) was used as a model polymer. A dough was made by mixing long-chain PEG with a small amount of water and benzophenone. In the dough, the long polymers are crowded but mobile, so that the long polymers densely entangle. UV light is applied, and benzophenone functions as a photoinitiator to create free radicals on the PEG chains, so that the polymers sparsely crosslink. The dough was submerged in water to swell to equilibrium. PEG hydrogels were formed using PEG polymers of with the following molecular weights: 200,000, 600,000, 2,000,000, and 8,000,000.

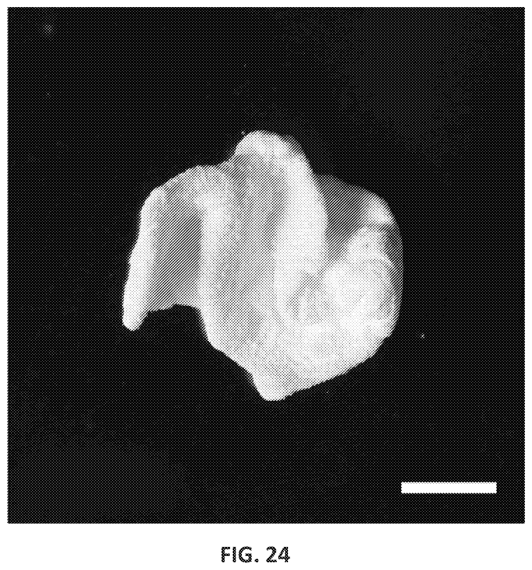

The highly entangled PEG hydrogels were prepared in following steps: mix, knead, anneal, crosslink, and swell. As the amount of benzophenone was small, it was first dissolved in 1.2 g of isopropyl alcohol, and then 2.5 g of PEG powder was mixed with the benzophenone solution by stirring for 2 min. The mixture was left in an oven at 65° C. for 15 min to evaporate the isopropyl alcohol. Then the powders of PEG and benzophenone were roughly mixed with water to form a dough. The dough was initially inhomogeneous and opaque, as shown in FIG. 24, a photograph of a dough formed after roughly mixing PEG powder of ultra-high molecular weight of 8×10⁶ g/mol with a small amount of water (25% by weight) at room temperature (scale bar is 1 cm).

To homogenize the dough, it was kneaded at an elevated temperature. The dough was put between a pair of aluminum plates (McMaster-Carr 1655T8) with a 0.5 mm-thick polyethylene spacer. The plates were compressed by using eight C-shaped clamps (McMaster-Carr 5133A13) in 2 min, and held for 9 min, all at 80° C. in the oven. The dough slowly became a thin film with the thickness of the spacer. Then, the dough was folded twice, once horizontally and once vertically, as shown in FIG. 10. Folding twice and compressing it in the oven constitute a cycle of kneading. FIGS. 11A-11F shows the dough after 1, 2, 3, 4, 5, and 7 cycles of kneading. As the dough was kneaded, it became increasingly homogeneous and transparent. After seven cycles of kneading, the dough became homogeneous. The dough was then annealed in the oven for 12 h at 65° C. The homogenized dough was almost transparent at 65° C., but gradually became translucent when cooled at room temperature.

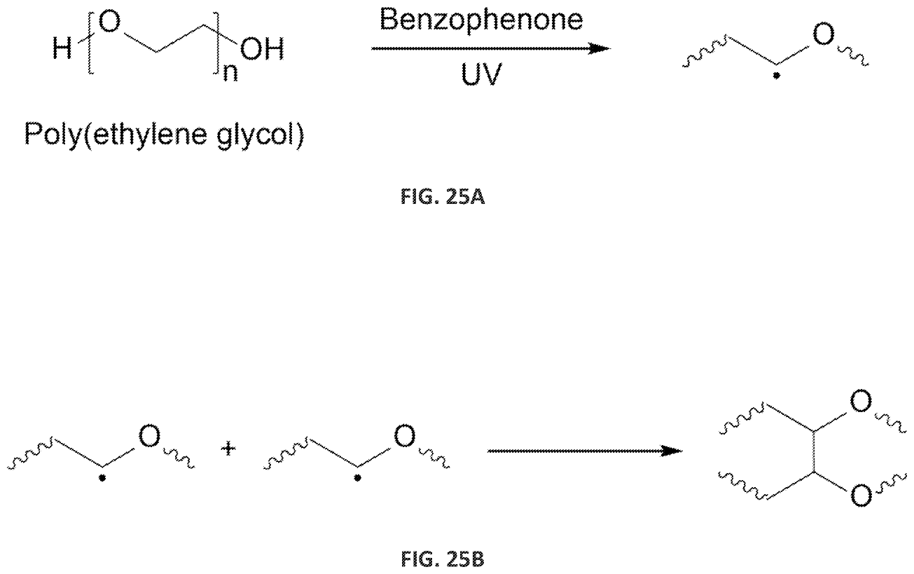

The homogenized dough was crosslinked for 1.3 h under UV irradiation (˜15 mW/cm², 365 nm, 15W, UVP XX-15L) in a nitrogen environment. FIGS. 25A-25B show schematics of the chemical reaction of crosslinking of PEG using benzophenone. As shown in FIG. 25A, when UV light is irradiated to a homogenized PEG dough, the benzophenone molecules are activated, abstract hydrogen atoms from PEG chains, and create radicals along the chains. As shown in FIG. 25B, when two radicals encounter each other, they form a crosslink. FIG. 11G shows the crosslinked dough.

During knead, anneal, and crosslink steps, the dough was kept in a plastic bag (reclosable zip bag) to prevent drying. The crosslinked dough was swollen in water for one day to reach equilibrium. FIG. 11H shows the swollen crosslinked hydrogel. As shown in FIG. 11I, the resulting hydrogel is transparent and highly stretchable.

The highly entangled PEG hydrogel used in FIGS. 11A-11I, FIGS. 27A-27K, and FIGS. 28A-28B, 28D, and 29 was synthesized from a dough with initial polymer fraction φᵢ=75%, molecular weight Mᵥ=8×10⁶, and benzophenone fraction B=3.2×10⁻⁴.

B. Synthesis of Crosslink-Dominant Hydrogels from Short-Chain PEG Polymers

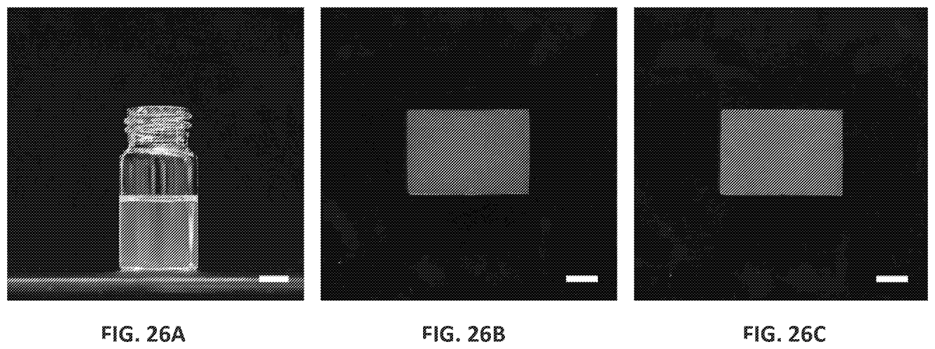

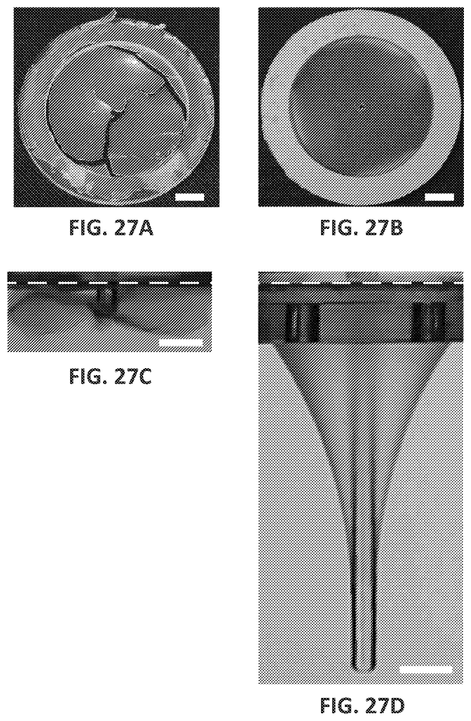

A short-chain hydrogel with net-like topology was synthesized to contrast with the fabric-like topology of the entangled hydrogel formed from a dough of long-chain polymers. The short-chain hydrogel was synthesized from poly(ethylene glycol) diacrylate (PEGDA) of low molecular weight of 7×10² g/mol. A precursor consisting of 20 wt % of PEGDA, 0.02 wt % of Irgacure 2959, and 80 wt % water was prepared. As shown in FIG. 26A, the resulting mixture was a homogeneous and transparent solution. The precursor solution was then poured into a glass mold and crosslinked for 6 hours under UV irradiation. FIG. 26B shows the crosslink-dominant short-chain hydrogel. The short-chain hydrogel was submerged in water to swell to equilibrium. FIG. 26C shows the swollen short-chain hydrogel. The short-chain hydrogel swelled less than 5% by weight.

### C. Mechanical Testing of Entangled PEG Hydrogels and Short-Chain PEG Hydrogels

The short-chain PEG hydrogel and entangled PEG hydrogel were compared using various mechanical tests.

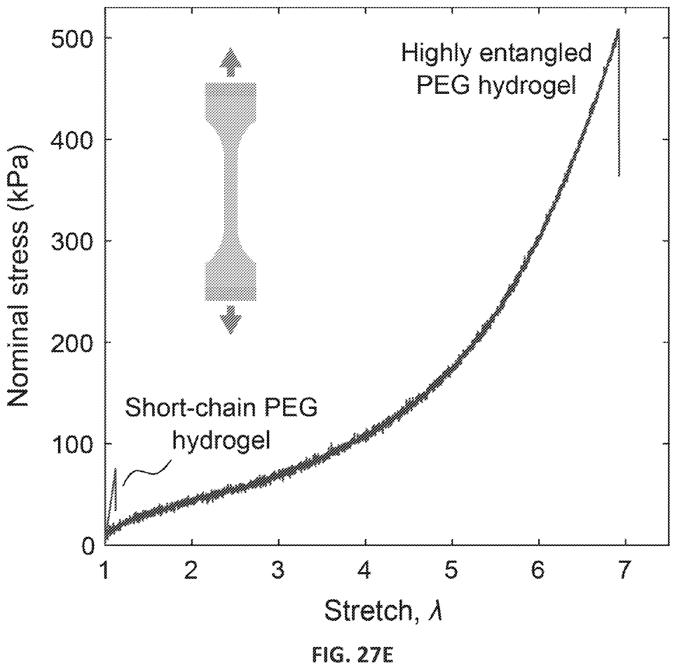

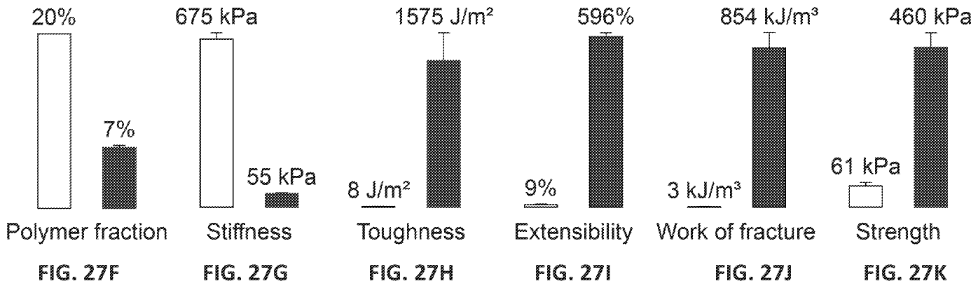

As shown in FIGS. 27A-27D, the two hydrogels were glued to acrylic rings and punctured using a glass rod. For puncture testing, a ˜1 mm-thick hydrogel sheet was cut into a circular sample of a diameter of 60 mm. The hydrogel was glued onto a rigid acrylic ring with an inner diameter of 50 mm, by using the Krazy glue. The ring was fixed to a supporter. A glass rod with a diameter of 4.7 mm was clamped by the gripper of the mechanical tester. The glass rod was placed above the middle of the hydrogel, and then moved at a constant speed of 0.2 mm/s to puncture the hydrogel. FIGS. 27A-27B show a top view of the hydrogel after the puncture test. FIGS. 27C-27D show a side view to indicate the displacement of the glass rod, with a dotted white line indicating position of the undeformed hydrogel. Scale bars are 1 cm. As shown in FIGS. 27A and 27C, the short-chain hydrogel punctured at a small displacement, and cracks emanate from the punctured hole. As shown in FIGS. 27B and 27D, the highly entangled hydrogel, by contrast, punctures at a large displacement (9.4 times greater than that of the short-chain hydrogel), and no cracks emanate from the punctured hole.

FIGS. 27E-27G, 28A-28D, FIG. 29, and FIG. 30 show additional mechanical properties measured according to the following methods. The final polymer fraction of is the ratio of the weight of the polymer powder to the weight of the equilibrium hydrogel. The elastic modulus E, toughness I, hysteresis, and rate-sensitivity were measured using pure-shear tests. Additional tests were performed using a mechanical tester (Instron 5966). The dimensions of each sample were 89 mm×12.7 mm×˜1 mm (width×height×thickness). The samples were glued to grippers made of acrylic sheet by using a Krazy glue. The elastic modulus was calculated from an initial slope of a stress-stretch curve, by 0.75ds/dλ, where s is the nominal stress and 2 is the stretch. To measure the toughness, an unnotched sample was stretched to obtain the elastic energy per unit volume, W (2), and a notched sample (the length of the precrack is 20 mm) was stretched until fracture to get the critical stretch λ_{c}, and the toughness was calculated by Γ=HW(λ_{c}), where H is the height of the undeformed sample. Hysteresis was measured by a cyclic loading. The area below the loading curve A_{loading} and the area below the unloading curve A_{unloading} were calculated. The hysteresis is calculated as 1-A_{unloading}/A_{loading}. For the rate-sensitivity, cyclic stretch was applied with a stretch of 2 at various loading rates, and stress-stretch curves were measured. The stretch rate was 0.016 s⁻¹ in the above measurements, except for the rate-sensitivity. The stress-stretch curve, extensibility, work of fracture, and strength were measured through uniaxial tension tests. A˜1 mm-thick hydrogel sheet was cut into dog bone-shaped samples. The gauge section of each sample had dimensions of 4 mm×20 mm (width×height). A video was taken during the test to obtain the real extension of the gauge section of each sample. The work of fracture was the area under the stress-stretch curve. The stretch rate was ˜0.04 s⁻¹. To measure the compressive strength, a ˜1 mm-thick hydrogel sheet was cut into coin-shaped samples. The strain rate was ˜4.2×10⁻³ s⁻¹.

FIG. 27E shows the stress-stretch curves of short-chain hydrogels and entangled hydrogels under tension. As shown in the inset, the two samples were cut into dogbane shaped samples and stretched using a tensile tester. The two hydrogels have remarkably different stress-stretch curves. Although the short-chain hydrogel initially has a greater stiffness than the entangled hydrogel, the entangled hydrogel has a much greater stretch before fracture and a much greater strength.

As shown in FIGS. 27F-27K, the highly entangled hydrogel (black columns) had a lower final polymer fraction (FIG. 27F) and stiffness (FIG. 27G) than the short-chain hydrogel (white columns), but had higher toughness (FIG. 27H), extensibility (FIG. 27I), work of fracture (FIG. 27 J), and tensile strength (FIG. 27K) than the short-chain hydrogel.

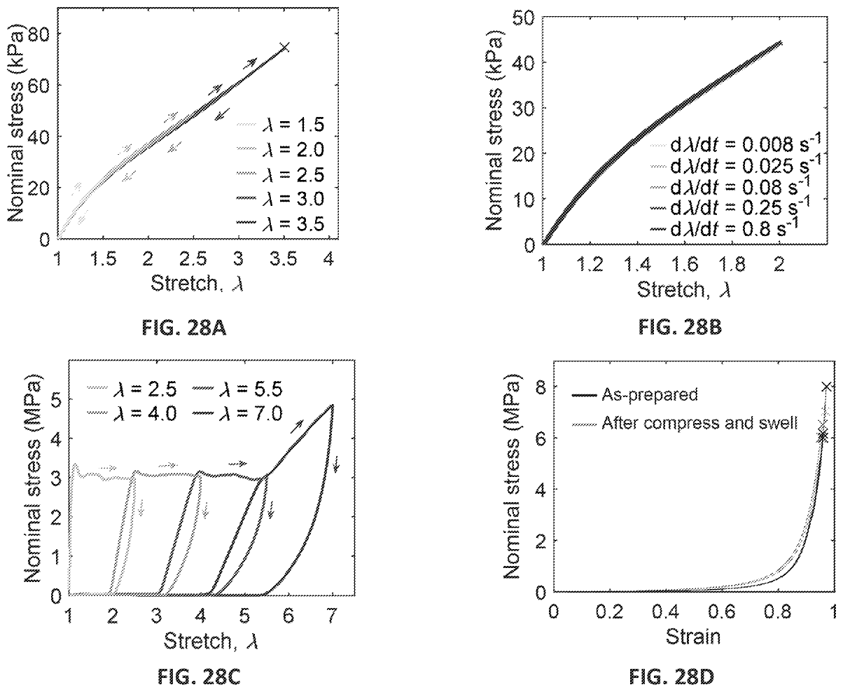

As shown in the stress-stretch curves in FIG. 28A and FIG. 28B, the highly entangled hydrogel exhibits near-perfect elasticity. As seen in FIG. 28A, after multiple loading cycles, the stress-stretch curves had negligible hysteresis. FIG. 28B shows the stress-stretch curves at different stretch rates and shows that the stress-stretch curves are insensitive to the rate of stretch. The near-perfect elasticity results from at least two facts. First, the highly entangled hydrogels have no sacrificial bonds. By comparison, when a double network (DN) hydrogel is stretched, a short-chain network breaks while a long-chain network is intact, leading to high hysteresis. Sacrificial bonds and high hysteresis are common in many hydrogels, including alginate-polyacrylamide (PAAm) hydrogel and PVA hydrogel. Second, the large amount of water in the swollen hydrogel reduces interchain friction. By comparison, as shown in FIG. 28C, the crosslinked dough before swelling, exhibited pronounced hysteresis.

FIG. 28C shows the stretch-stress curve of a dough before swelling with water. The dough is stretched at 2.5, 5.5, 4.0, and 7.0. The dough, after homogenization and crosslinking, is viscoplastic. The dough yields at a stress of about 3 MPa upon load, has a residual stretch upon unload, and yields again upon reload. After the stretch exceeds about 5, the stress can exceed the initial yield strength. The initial yield strength and residual stretch are likely caused by interactions between crowded chains in the dough. The increased stress at a large stretch is likely caused by the crosslinks. The dough contains 75% PEG polymers by weight (Mᵥ=8×10⁶) and is tested at a constant rate of stretch of 0.016.

FIG. 28D shows the impact of repeated loading on the nominal strength of an entangled hydrogel. FIG. 28D shows the stress-strain curve of an entangled PEG hydrogel compressed to rupture. The figure shows the entangled PEG hydrogel in two different scenarios. First, a sample was compressed to rupture (as-prepared). Second, a sample was compressed ten times to pressure of 4 MPa, swollen in water overnight, and then compressed to rupture (after compress and swell). Each experiment was performed on three samples. While the strength varies from sample to sample, the average strengths measured in the two types of experiments were the same, 6.5 MPa. Also, the stress-strain curves of the two types of experiments only differ slightly, shown in FIG. 28D. These findings confirm that the mechanical properties of highly entangled hydrogel degrade negligibly under repeated load.

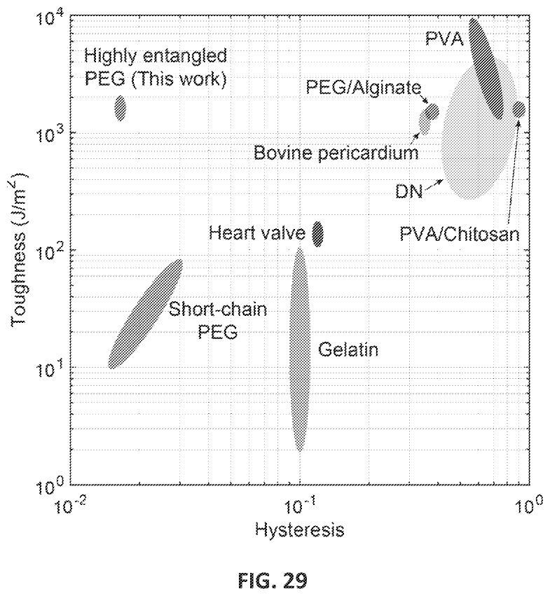

FIG. 29 shows the toughness-hysteresis plane of entangled PEG hydrogels and other hydrogels. In most hydrogels, hysteresis and toughness are positively correlated. For example, the double-network hydrogel, alginate-PAAm hydrogel, bovine pericardium, PVA hydrogel, and PVA/chitosan hydrogel all have both high hysteresis and high toughness, whereas the short-chain PEG hydrogel has low hysteresis and low toughness. In contrast, the highly entangled hydrogel is exceptional in that it breaks the hysteresis-toughness correlation and simultaneously achieves low hysteresis and high toughness. The highly entangled hydrogel achieves high toughness not by sacrificial bonds, but by having all chains long.

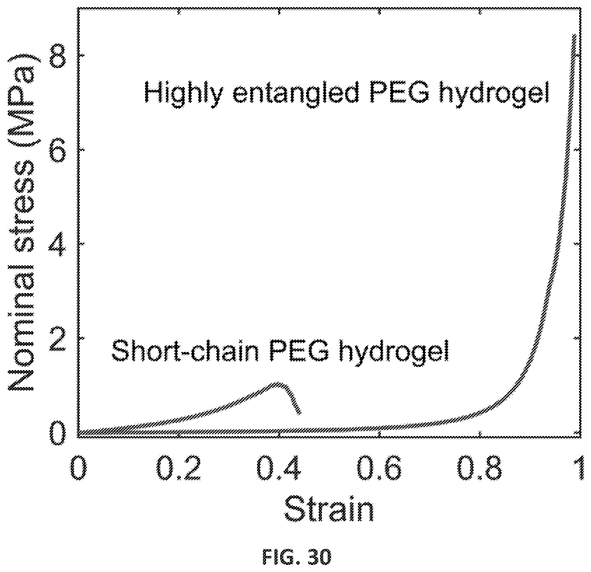

FIG. 30 shows the compressive stress-strain curves of a highly entangled PEG hydrogel and the short-chain PEG hydrogel. The two hydrogels were cut into disks, and the compressive strengths were measured. The highly entangled hydrogel has about 5.2 times higher compressive strength than the short-chain hydrogel. The highly entangled hydrogel bears higher pressure and deformation than the short-chain hydrogel.

### D. Properties of Entangled PEG Hydrogels as a Function of Synthesis Parameters

The properties of entangled PEG hydrogels made from doughs depend on various synthesis parameters, including the initial polymer fraction φᵢ (the mass ratio of polymer to the dough), the benzophenone fraction B (the molar ratio of benzophenone to monomer unit of the polymer), and molecular weight of the polymer Mᵥ. Each dough was homogenized and crosslinked, and then submerged in water to form an equilibrium hydrogel. When B, φᵢ and Mᵥ are low, the dough dissolves in water. When B, φᵢ and Mᵥ exceed critical conditions, the dough gels and swells to equilibrium. In either case, let of be the final mass fraction of polymer in the equilibrated sample. FIGS. 12A-12F show the properties of entangled PEG polymers made with various synthesis parameters. FIG. 12A shows the final polymer fraction of for samples made of PEG of molecular weight Mᵥ=8×10⁶ and various values of B and φᵢ. At fixed values of φᵢ and Mᵥ, a critical value of B exists, below which the dough dissolves, so that φ_{f} is low, set by the mass ratio of the polymers and water in the container. The critical B decreases as φᵢ increases. Above the critical value of B, the dough swells to an equilibrium hydrogel. At any B, the higher polymer fraction in the dough, φᵢ, the higher polymer fraction in the equilibrium hydrogel, φ_{f}. These observations support the molecular interpretation that the entanglements and the crosslinks together maintain the topology of the polymers in a hydrogel. The higher the initial polymer fraction φᵢ, the more crowded the polymers in a dough, and the denser the entanglements.

As shown in FIG. 12B, this molecular interpretation is corroborated by elastic modulus E of the equilibrium hydrogels plotted as a function of B and φᵢ at Mᵥ=8×10⁶. At B=1×10⁻³, the hydrogel made of a dough of φᵢ=75% has a modulus E about 31 times higher than the hydrogel made of a dough of φᵢ=45%, and the hydrogel made of a dough of φᵢ=30% has negligible modulus. FIG. 12C shows the toughness Γ of equilibrium hydrogel as a function of B and φᵢ at Mᵥ=8×10⁶. As B decreases, the crosslink density decreases, and the toughness increases. This trend is consistent with the prediction of the Lake-Thomas model. When φᵢ=60%, the critical value of B is 3.2×10⁻⁴, and a low crosslink density gives a high toughness of 2,200 J/m². When φᵢ=30%, the critical value of Bis 1×10⁻², and a high crosslink density gives a toughness of only 250 J/m².

FIGS. 12D-12F show the properties of equilibrium hydrogels made from doughs of PEG chains of various molecular weights, crosslinked using various amounts of benzophenone. All of these doughs were prepared at the same initial polymer fraction in the dough, φᵢ=65%. As shown in FIG. 12D, at fixed values of φᵢ and Mᵥ a critical value of B exists, below which the dough dissolves in water, so that of is low. The critical B decreases as Mᵥ increases. Also, at any B, a higher Mᵥ gives a higher of. These observations indicate that a dough made of polymers of a higher molecular weight has denser entanglements. This molecular interpretation is corroborated in elastic modulus, shown in FIG. 12E. For example, at B=3.2×10⁻⁴, the moduli of the hydrogels made from polymers of Mᵥ>6×10⁵ are on the order of 10 kPa, whereas the moduli of the hydrogels made from polymers of Mᵥ<2×105 are vanishingly low. FIG. 12F shows the toughness of equilibrium hydrogels. The toughness is not sensitive to Mᵥ, but the high value of Mᵥ enables polymers to have low values of B and high toughness. This observation is consistent with the Lake-Thomas prediction that the toughness depends on the polymer chain length between crosslinks.

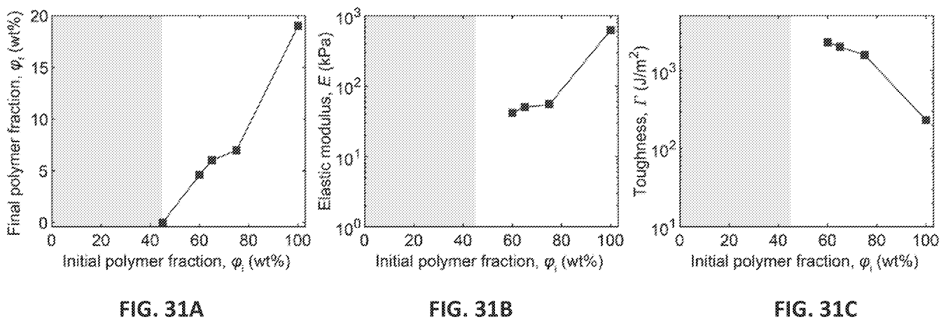

FIGS. 31A-31C show the effect of initial polymer fraction φᵢ on the properties of entangled PEG hydrogels made from doughs. FIG. 31A shows the final polymer fraction, φ_{f}, as a function of the initial polymer fraction, φᵢ. FIG. 31B shows the elastic modulus, E, as a function of φᵢ. FIG. 31C shows the toughness, Γ, as a function of φᵢ. The molecular weight of PEG and the benzophenone fraction were fixed (Mᵥ=8×10⁶ and B=3.2×10⁻⁴) and φᵢ (the mass ratio of PEG to the dough) was varied. When water fraction is much higher φᵢ<45%, the shaded regions), the dough dissolves in water. When water fraction is less, the dough swells to an equilibrium hydrogel. φ_{f}, E, and Γ of the hydrogel vary slightly when there is a small amount of water in the dough (φᵢ=60-75%). However, without water in the dough (φᵢ=100%), φ_{f} and E of the hydrogel become quite high, while Γ drops a lot. When φᵢ=100%, the resulting hydrogel becomes brittle, showing a much lower toughness, Γ˜200 J/m², than those with φᵢ=60-75%, Γ˜2,000 J/m². Without water, the long-chain polymers have high viscosity even at elevated temperatures, so that kneading cannot homogenize the dough, but will break the chains.

### E. Kneading and Annealing Entangled PEG Polymers Formed by Dough

The conditions of mixing, kneading, and annealing are determined based on the physics and chemistry of PEG. Dry long-chain PEG is semicrystalline, which melts at ˜65° C., dissolves in a large amount of water, and degrades over time at elevated temperature.

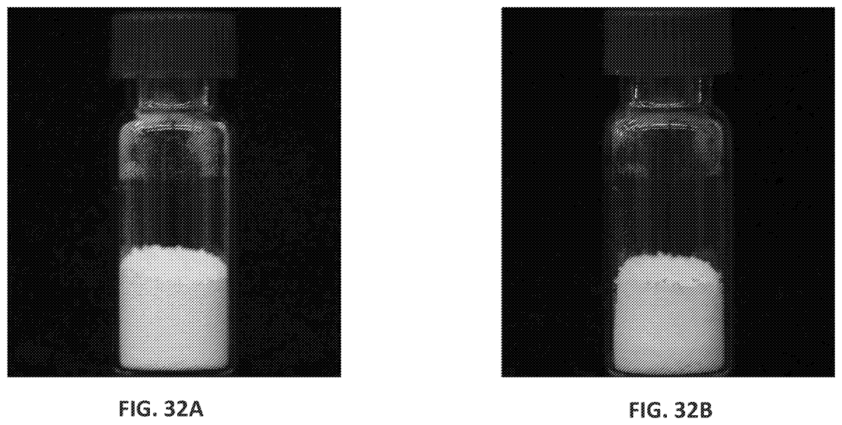

The dry powder remains powdery after being kept at elevated temperature overnight. FIGS. 32A-32B show PEG powder of ultra-high molecular weight (8×10⁶ g/mol) before (FIG. 32A) and after (FIG. 32B) storing the powder at 80° C. for 12 hours. The PEG is still powdery afterwards, as shown in FIG. 32B.

PEG degrades substantially when kept at elevated temperature for too long. The PEG with a small amount of water remains powdery after kneading at room temperature. The PEG turns into a translucent dough with kneading at elevated temperature. To homogenize a dough without degradation and scission, kneading must operate in a window of temperature, time, and rate of deformation, and annealing must operate in a window of temperature and time. Mixing the powder with a small amount of water lowers viscosity and eases homogenization.

FIGS. 13A-13C show three different methods of mixing long-chain PEG powder with water and heating at 65° C. First, FIG. 13A shows 2.5 g of PEG powder (Mᵥ=8×10⁶) (left panel) and dropping 1.4 g of water (36% of the mixture in weight) onto the powder using a pipette (middle panel), resulting in an inhomogeneous mixture after heating at 65° C. (right panel). Second, as shown in FIG. 13B, to dispense water more evenly, moisture was applied using a humidifier to apply a mixture of small droplet of water (liquid state of water) and humid air (gas state of water) until the mixture reaches the same weight as in the first methods (left panel), resulting in the top of the powder getting wet relatively evenly (middle panel) and an inhomogeneous mixture after heating at 65° C. (right panel). Third, shown in FIG. 13C, water is dispensed as in the first method (left panel), the mixture is kneaded by hand for half an hour to form an inhomogeneous dough (middle panel), resulting in an inhomogeneous mixture after heating at 65° C. (right panel).

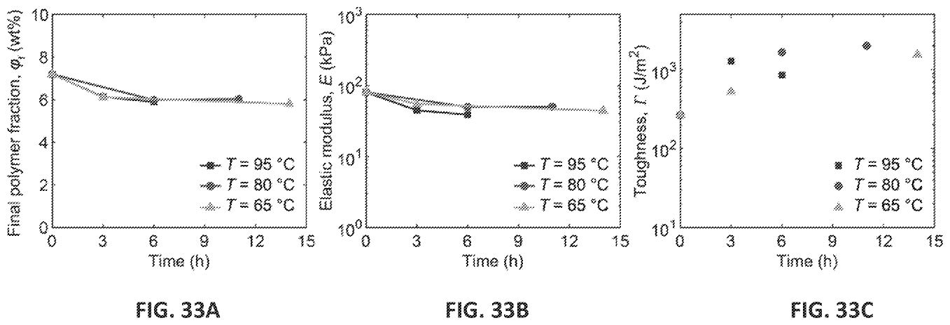

FIGS. 33A-33C show the effect of annealing time and temperature on the properties of entangled hydrogels formed from doughs. The highly entangled PEG hydrogels (φᵢ=65%, B=3.2×10⁻⁴, and Mᵥ=8×10⁶) were prepared with different annealing temperatures (7) and times. FIG. 33A shows the final polymer fraction, of, as a function of T and time. FIG. 33B shows the elastic modulus, E, as a function of T and time. FIG. 33C shows the toughness, I, as a function of T and time. The minimum annealing time depends on temperature. For, example, at 65° C., the minimum annealing time is 6 hours. The time and temperature of annealing be limited to avoid degradation of the polymer. For example, PEG degrades under a high temperature, such as 100 degree C. after 12 hours.

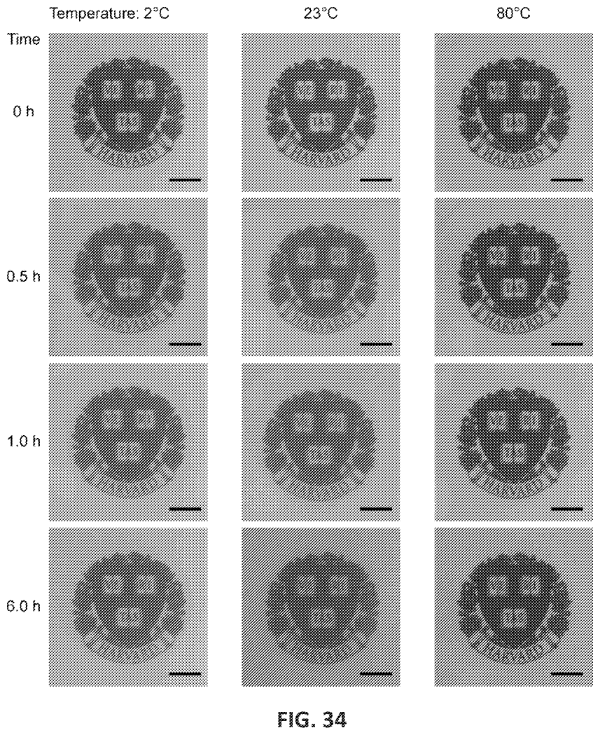

FIG. 34 shows photographs of the homogenized dough being cooled or heated at 2° C., 23° C., and 80° C. The dough contains 75% PEG by weight (Mᵥ=8×10⁶), and was homogenized by 7 cycles of kneading at 80° C. and overnight annealing at 65° C. Initially the dough is at 65° C. when time is 0, and then it was cooled or heated at different temperatures (2 −80° C.). The photograph was taken in front of a 0.5 mm-thick dough that covered the background images. Scale bars were 1 cm. The homogenized dough was almost transparent at 65° C., but gradually became translucent when cooled at room temperature. The homogeneous dough was most transparent after heated at 80° C.

### F. Friction Coefficient of Entangled PEG Hydrogel and Short-Chain PEG Hydrogel

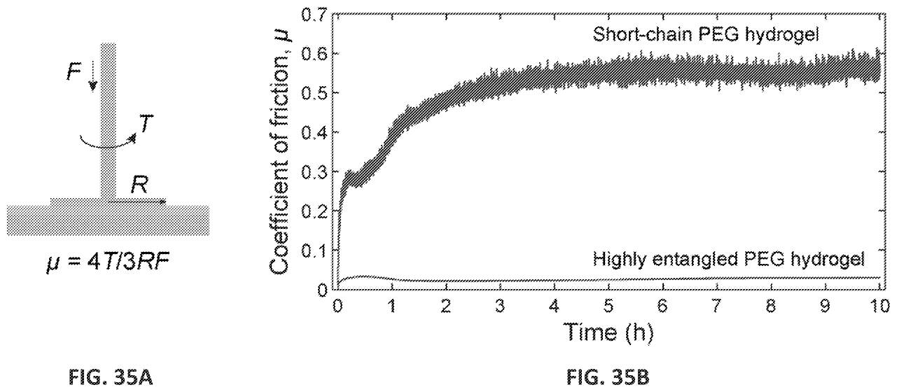

FIG. 35A-35B show testing of the coefficient of friction of entangled PEG hydrogels and short-chain PEG hydrogels. The friction coefficient was measured by using a rheometer. As shown in FIG. 35A, the hydrogel was glued on the bottom surface, immersed in a water bath, and compressed with the normal force of F by a flat stainless-steel plate of radius R. The bottom substrate was rotated with the angular velocity of 1 rad/s, and the torque T for 10 hours. The torque increases and plateaus in several hours. From the value of the plateau, the friction coefficient is calculated according to the following equation: μ=4T/3RF. As shown in FIG. 35B, the highly entangled PEG hydrogel shows a much lower coefficient of friction (μ˜0.028) than the short-chain PEG hydrogel (μ˜0.55). The marked difference is understood as follows. On the surface of the hydrogels, hydrophilic polymer chains stabilize a layer of water, which lubricates the surface. The friction decreases as the thickness of the layer increases, and the thickness increases as the length of polymer chains increases. The long length of polymer chains of the highly entangled hydrogel gives low friction coefficient.

### G. Synthesis of Entangled Cellulose Hydrogels

Highly entangled hydrogels were prepared using long-chain 2-hydroxyethyl cellulose. The 2-hydroxyethyl cellulose is modified from naturally existing cellulose, forms fewer hydrogen bonds than native cellulose, and dissolves in water. A dough was prepared from long-chain 2-hydroxyethyl cellulose (Mᵥ˜1.3×10⁶), homogenized by kneading at 80° C., crosslinked using glycidyl methacrylate (GMA)⁴⁷ and Irgacure 2959, and swollen in water to form an equilibrium hydrogel. To prepare entangled cellulose hydrogels, a HCl solution with a pH value of 3.5 was prepared. 0.1 mL of glycidyl methacrylate (GMA) and 20 mg of Irgacure 2959 were dissolved in 3 mL of the HCl solution. This solution was mixed with 2 g of 2-hydroxyethyl cellulose and rested it at 25° C. for 1 hour to obtain a cellulose dough. The dough was compressed by using a pair of aluminum plates, a 0.5 mm-thick polyethylene spacer, and eight C-shaped clamps, and store it in an oven at 80° C. for 15 min. The dough was annealed at 50° C. for 24 h. After annealing, the dough was cured for 20 min under UV irradiation. During all processes, the dough was kept in a plastic bag to prevent drying. Before any measurement, the hydrogels were swollen in water for one day to reach equilibrium.

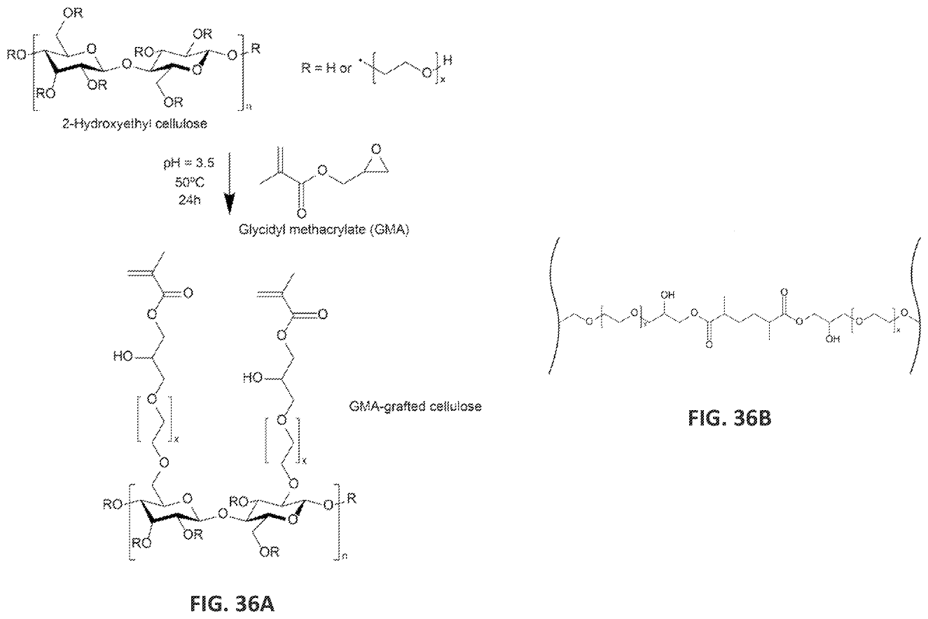

FIGS. 36A-36B show the chemical reaction for chemical crosslinking of cellulose. FIG. 36A shows grafting glycidyl methacrylate (GMA) on 2-hydroxyethyl cellulose to obtain photocrosslinkable cellulose. GMA can react with hydroxyl groups on the 2-hydroxyethyl cellulose through an epoxide ring-opening mechanism. FIG. 36B shows applying UV light to crosslink the GMA-grafted cellulose macromolecules the presence of photoinitiators, e.g., Irgacure 2959.

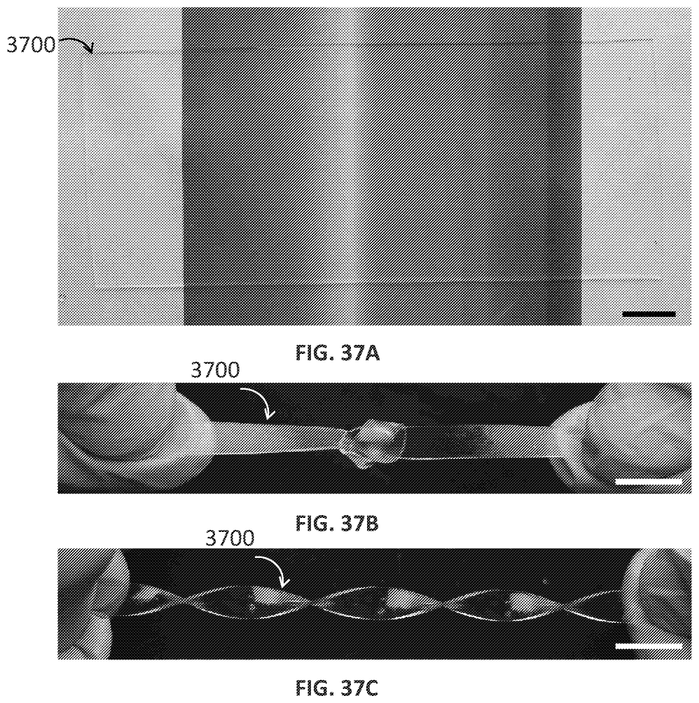

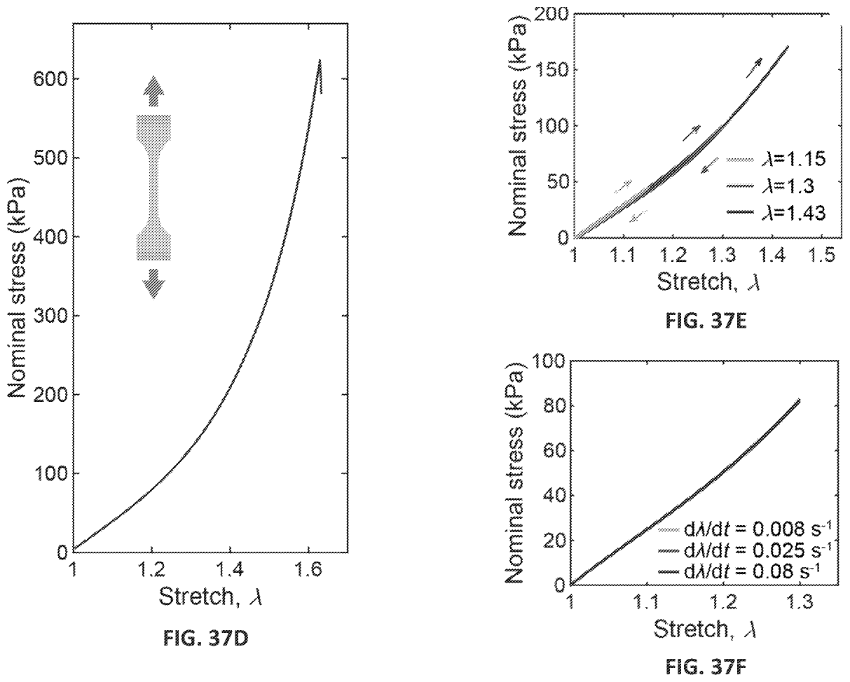

The resulting entangled cellulose hydrogel had a final polymer fraction of of 20%. As shown in FIG. 37A, the entangled cellulose hydrogel 3700 is transparent, and an image is visible through the sheet of the entangled cellulose hydrogel. As shown in FIGS. 37B-37C, the entangled cellulose hydrogel 3700 is flexible and can be knotted (FIG. 37B) and twisted (FIG. 37C).

### H. Mechanical Testing of Entangled Cellulose Hydrogels

The mechanical properties of entangled cellulose hydrogels were measured as described above for PEG hydrogels and are shown in FIGS. 37D-37F. FIG. 37D shows the stress-stretch curves for the entangled cellulose hydrogel to fracture. The modulus is 100 kPa, the strength is 642 kPa, and the toughness is 200 J/m². As shown in FIG. 37E, the highly entangled cellulose hydrogel also exhibited near-perfect elasticity with negligible hysteresis. FIG. 37E shows the stress-stretch curves at multiple stretch rates. As shown in FIG. 37F, the stress-stretch curves were insensitive to the stretch rate.

It will be appreciated that while one or more particular materials or steps have been shown and described for purposes of explanation, the materials or steps may be varied in certain respects, or materials or steps may be combined, while still obtaining the desired outcome. Additionally, modifications to the disclosed embodiment and the invention as claimed are possible and within the scope of this disclosed invention.

1. An entangled polymer composition comprising:
an entangled polymer network comprising a plurality of entangled polymers; and a plurality of crosslinks crosslinking the polymers at a density of no more than one crosslink per 1,000 monomer units of the polymer;
wherein the polymer composition has a toughness of at least about 100 Jm′² and a stiffness of at least about 50 kPa.

2. The polymer composition of claim 1, wherein the density of the crosslinks crosslinking the polymers is no more than one crosslink per 3,000, 4,000, 5,000 or 8,000 monomer units of the polymer.

3. The polymer composition of claim 1, wherein the density of the crosslinks crosslinking the polymers is no more than one crosslink per 10,000 monomer units of the polymer.

4. The polymer composition of claim 1, wherein the polymer composition comprises about 50, 100, 150, 200, 300, 400, or 500 entanglements per crosslink.

5. The polymer composition of claim 1, wherein the polymer composition is an elastomer, and the elastomer has a toughness of at least about 500 Jm′² and a stiffness of at least about 400 kPa.

6. The polymer composition of claim 1, wherein the polymer composition has a stiffness of at least about 100 kPa.

7. The polymer composition of claim 1, wherein the product of the stiffness and the toughness is at least about 10⁴ kPa m′².

8. The polymer composition of claim 1, wherein the polymer composition further comprises a solvent and the entangled polymer network is swollen with the solvent.

9. The polymer composition of claim 8, wherein the solvent is water and the polymer composition is a hydrogel, and the hydrogel has a toughness of at least about 100 Jm′² and a stiffness of at least about 50 kPa.

10. The polymer composition of claim 8, wherein the solvent is an organic solvent, and the polymer composition is an organogel.

11. The polymer composition of claim 1, wherein the polymer composition has a ratio of dissipated energy to applied work that is less than about 10%.

12. The polymer composition of claim 1, wherein the polymer composition has a ratio of dissipated energy to applied work that is less than about 5%.

13. The polymer composition of claim 1, wherein the polymer composition has a nominal tensile strength of at least about 100, 200, 300, or 500 kPa.

14. The polymer composition of claim 1, wherein the polymer composition has a strength of at least about 2.5, 2.75, 3.0, 3.25, or 3.5 MPa.

15. The polymer composition of claim 1, wherein the polymer composition has a coefficient of friction of less than about 0.05, 0.04, 0.03, 0.02, 0.01, 0.005, or 0.001.

16. The polymer composition of claim 1, wherein the polymer composition has a fatigue threshold of at least about 150, 160, 170, 180, 190, 200, 210, 220, 230, 240, 250, 300, or 350 Jm′².

17. The polymer composition of claim 1, wherein the polymer composition has a wear rate of less than about 1, 0.5, 0.3, 0.25, 0.2, or 0.15, 0.1 mg/cycle.

18. The polymer composition of claim 1, wherein the polymer comprises poly(ethyl acrylate), polyacrylic acid, poly(acrylamide), polyethylene glycol, polyvinylpyrrolidone, polyvinyl alcohol, poly(2-hydroxyethyl methacrylate), poly(methacrylic acid), poly(N-isopropyl acrylamide), polyacrylic acid, poly(methyl methacrylate), polymethacrylate, poly(ethyl methacrylate), poly(propyl acrylate), poly(propyl methacrylate), poly(butyl acrylate), poly(acrylic acid), poly(N-isopropyl acrylamide), poly(butyl methacrylate), polyethylene, polypropylene, poly(vinyl acetate), polyacrylonitrile, polybutadiene, polyisobutylene, polyisoprene, polychloroprene, polynorbomene, polytetrafluoroethylene, ethylene acrylate copolymers, poly(ethylene-co-acrylic acid), poly(ethylene-co-ethyl acrylate), poly(ethylene-co-methacrylic acid), poly(ethylene-co-vinyl acetate), poly(acrylonitrile-co-butadiene), poly(isobutylene-co-isoprene), poly(perfluoromethylvinylether), poly(styrene-co-butadiene), polyurethane, polysulfide, polysiloxane, natural rubbers, silicone rubbers, nitrile rubbers, cellulose, alginate, chitosan, hyaluronic acid, collagen, gelatin, or a combination thereof.

19. The polymer composition of claim 1, wherein the crosslinks are formed using a crosslinker selected from a group consisting of N,N′-methylenebisacrylamide, Tricyclo[5.2.1.0^{2,6}]decanedimethanol diacrylate, benzophenone, glycidyl methacrylate, poly(ethylene glycol) diacrylate, Ethylene glycol diacrylate, 1,4-Butanediol diacrylate, Polypropylene glycol) diacrylate, Di(ethylene glycol) diacrylate, Bisphenol A ethoxylate diacrylate, 1,3-Butanediol diacrylate, 1,6-Hexanediol diacrylate, Tri (ethyleneglycol) diacrylate, Neopentyl glycol diacrylate, Tetra(ethylene glycol) diacrylate, benzophenone, glycidyl methacrylate, adipic acid dihydrazide, butanediol-diglycidyl ether, citric acid, glutaraldehyde, divinyl sulfone, sulfur, and a combination thereof.

20. A method of forming an entangled polymer composition comprising:
a) providing a mixture comprising
a plurality of monomers;
a plurality of crosslinkers, wherein there are no more than one crosslinker per 1,000 monomers; and
a solvent, wherein the molar ratio of solvent to monomer is less than 12; b) polymerizing the monomers to form polymers and entangling the polymers to form an entangled polymer network; and
c) forming crosslinks by crosslinking the polymers.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A method of forming an entangled polymer composition comprising:
a) providing a mixture comprising
a plurality of polymer chains;
a plurality of crosslinkers, wherein there are no more than one crosslinker per 1,000 monomers in the polymer chains; and
a solvent;
b) kneading the mixture of precursors at a temperature of at least about 40° C. to form an entangled polymer network; and
c) crosslinking the polymer chains to form crosslinks.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
